(19) United States
(12) Patent Application Publication
(10) Pub. No.: US 2006/0179022 A1
(43) Pub. Date: Aug. 10, 2006

(54) Counterpart artificial intelligence software program

(76) Inventor: Wilson Lee Holland, West Palm Beach, FL (US)

Correspondence Address: Wilson Holland, 5oo Cherry Rd., West Palm Beach, FL, 33409, US

(21) Appl. No.: 10/843,644

(22) Filed: May 12, 2004

Related U.S. Application Data
(63) Continuation-in-part of application No. 10/001,847, filed on Nov. 26, 2001, now abandoned.

(51) Int. Cl. G06F 15/18; G06N 5/00

(52) U.S. Cl. 706/45

(57) ABSTRACT

This device works to discern discrete human problems from discrete human states based upon an assumed set of human parameters. The program assumes that the discrete actions of human beings are explicitly and conclusively the result of a consumption, reproduction, and/or peripheral problem, and/or the acquisition of a positive emotion and/or the avoidance of a negative emotion. After discerning a human problem, the program determines if it can and should assist the human in achieving a solution based upon a hierarchy of control headed by a primary entity named the “Instructor,” and the secondary entities named as delegated users.

### CROSS REFERENCE TO RELATED APPLICATIONS

This patent application is a Continuation in Part of patent application Ser. No. 10/001,847

### STATEMENT OF FEDERALLY SPONSORED RESEARCH OR DEVELOPMENT

(Not applicable)

### REFERENCE TO SEQUENCE LISTING, A TABLE, OR A COMPUTER PROGRAM LISTING

(Not applicable)

### BACKGROUND OF INVENTION

In the middle of the last century, the founders of computer science considered the possibility that digital machines might someday act and react like human beings. Scientists, psychologists, and science-fiction writers pondered how a machine might think like a human, how it might form conversation like a human, and how it might attempt to comprehend human emotions. Yet the many complexities of human behavior seemed intangible, and making a counterpart machine appeared nearly impossible. Where would programmers begin construction? When would construction end? How would the program behave? In forming conversation, how would it ask questions or make comments in a way that might interest humans? Could it have such a deep understanding of both humans and itself that it would grow and learn indefinitely? Can machines think? The Turing Test is considered the high water mark of such a program. The test consists of an interrogator who communicates blindly with a human and an Artificial Intelligence. If the interrogator cannot make a distinction between the computer and the human, then the Artificial Intelligence has passed the test. The following design for an Artificial Intelligence is expected to be indistinguishable to the interrogator.

All the current endeavors in Artificial Intelligence research have employed different techniques for recognizing the human vocabulary. These programs sort through many case studies using many different information-handling functions to produce a response for a given situation. These approaches may lead us to a useful counterpart machine; however, these methods are ambiguous. An unambiguous design could produce a useful counterpart machine; yet an unambiguous design requires a naming of the parameters of the human conscience. The following design is of a fixed domain, assuming a distinct set of parameters for the human conscience.

For the Artificial Intelligence (AI) to understand human communication/conversations, it must be taught sound, unambiguous behaviorism. Unambiguous views of human behavior began early in the twentieth century. John Watson, a Professor at Johns Hopkins University, was considered by many to be the founder of the behaviorist's approach to psychology. He was an adamant spokesman for observing behavior while not proposing introspective views of the human conscience without clear connections to the observed, tangible external events. B. F. Skinner was another highly regarded behaviorist that assembled vast collections of data with new, unambiguous research techniques. With the help of his colleagues, B. F. Skinner developed many important new concepts of human behavior from the specific actions and reactions of laboratory animals. With terms such as “Operant” and “Respondent,” Skinner described the larger and smaller functions found in human behavior based upon recognizable connections between stimulus and responses. Although many behaviorists that came after Skinner and Watson have observed the more detailed verbal communications of humans, none have concluded a means of defining each fraction of a second.

In the eyes of these pioneering behaviorists, observations must only be made of the tangible aspects of human behavior. Properly defining the actions of an organism—the output—warranted only a connection to the actions imposed by an environment and by genetics—the input. They were of the belief that one should not analyze thoughts and emotions unless those internal events can be directly tied to both the observed external actions exhibited by an organism and the observed external conditioning imposed upon an organism. A connection needed to be sound—it could not be speculative. A connection required verification by previous and continuing case study. Emotions were generally considered inconsequential because a consistent means of defining them could not be established.

This AI is a machine that detects each individual human problem by observing and defining the discrete actions of humans via a firm understanding of the parameters of life-forms. Emotions generally assist humans in solving these problems, so the program must make unambiguous inferences to these internal sensations. In the event of a human's action(s) being interpreted as a result or an exhibition of an emotion, the program will literally record onto its database, in some conjunctive form or another, just as if it were written in black ink on the white paper of a behaviorist's notepad, that the action(s) of a human being were “solving an emotional problem of . . . . ”

Throughout this patent application, many human emotions are mentioned as being present during a particular human thought process solving a particular human problem. When an emotion is mentioned, the reference is not ambiguous; the emotion is considered as one quantitative sensation that directs a single decision, successive decisions, or connected decisions. The AI will be well aware of not only the human's actions, but the probable internal decisions with their accompanying emotions.

Various methods, programs, and programming languages are currently involved in AI research. These designs work on the premise of studying human input and AI output in a case-by-case manner so as to form probabilities of an appropriate response. Limited efforts to expedite this process have also been attempted by pre-defining the case studies of certain areas of human thought. The following passage is an excerpt from “Characterizing and Processing Robot Directed Speech,” a paper published by Paulina Varchavskala, Paul Fitzpatrick, and Cynthia Breazeal at MIT's Artificial Intelligence Research Lab (1999). This paper represents one of many different approaches to AI development.
“ . . . For this paper, we will consider the case of Kismet, an “infant-like” robot whose form and behavior is designed to elicit nurturing responses from humans. Among other effects, the youthful character of the robot is expected to confine discourse to the here-and-now . . . ”

A program so broad that it “elicits nurturing responses” can have many inherent problems. The authors acknowledge their methods as being a limited attempt at forming the thought processes required in AI construction.

The role of the AI of this patent application is not to elicit nurturing responses in the people it encounters, but to perform tasks at the direction of a supervising entity. That supervising entity delegates other humans to be the object of AI responses. Any AI that is to be a sellable product must be of a clear, safe, and sound design; and like a human, it would have to be parented from a childlike state to adulthood. The “Instructor” is the supervising entity of this design that becomes the object of the elicited nurturing responses. In effect, the “Instructor's” positive emotions become the displaced emotional driver of the program.

The quantity of case studies needed for the approach mentioned in this paper by Varchavskala et al. is staggering. The “here-and-now” represents the limited scope of the program. The paper continues:
“ . . . . Recent developments in speech research on robots have followed two basic approaches. The first approach builds on techniques developed for command and control style interfaces. These systems employ the standard strategy found in ASR research of limiting the recognizable vocabulary to a particular predetermined domain or task. For instance, the ROBITA robot [16] interprets command utterances and queries related to it's functions and creators, using a fixed vocabulary of 1,000 words. Within a fixed domain fast performance with few errors becomes possible, at the expense of any ability to interpret out of domain utterances . . . .
. . . A second approach adopted by some roboticists [19, 17] is to allow adjustable (mainly growing) vocabularies. This introduces a great deal of complexity, but has the potential to lead to a more open, general-purpose systems. Vocabulary extension is achieved through a label acquisition mechanism based on learning algorithm, which may be supervised or unsupervised. This approach was taken in particular in the development of CELL [19], Cross-channel Early Language Learning, where a robotic platform called Toco the Toucan is developed and a model of early human language acquisition is implemented on it. CELL is embodied in an active vision camera placed on a four degree of freedom motorized arm and augmented with expressive features to make it appear like a parrot. The system acquires lexical units from the following scenario; a human teacher places an object in front of the robot and describes it. The visual system extracts color and shape properties of the object, and CELL learns on-line a lexicon of color and shape terms grounded in the representation of objects. The terms learned need not be pertaining to color or shape exclusively—CELL has the potential to learn any words, the problem being that of deciding which lexical items to associate with which semantic categories.”

The combination of supervised and unsupervised learning is necessary. CELL could eventually become useful counterpart machine. However, tackling case studies in an efficient manner is still a problem with this design because the programmers view the human mind ambiguously. Their design is not based upon observations of discrete actions of humans. The programmers are not sure where to start and they are unaware of what the end result will be; “the problem being that of deciding which lexical items to associate with which semantic categories.” The AI design of this patent application addresses these issues unambiguously; the lexical items and semantic categories are determined based upon a human's discrete motives driving discrete human states. Because the human motives are definite, the AI design of this patent allows the program to be within a “fixed domain” of ROBITA's design while achieving the broad knowledge base desired in CELL's design.

To curb the AI's assimilation of case studies, the program must have a fixed domain. To obtain a recognizable relativity of problem solving, again the program must have a fixed domain. Yet to form a counterpart machine of a fixed domain, the human conscience must be considered of a fixed domain—human parameters must be established. With firm parameters, the program's newly recorded case studies can fall into specific categories for specific processing, and associations can be built properly from the beginning of program construction.

An AI must be given a main function of assisting humans in solving their typical problems. All sub-functions must branch from this main function. The communicating of a response by “Toco” about an object would have to be an attempt to solve the smaller, current, subordinate problems while simultaneously attending larger, imminent, superior problems. Such a response may involve the function of “making general conversation” or “participating in conversation to learn the frequency of conversational problems,” yet any problems solved with social interaction must address the full spectrum of human problems in priority.

The AI design of this patent application has a main function of assisting humans in solving human problems. All man-made machines solve distinct human problems. In each fraction of a second, the AI is to detect human problems and determine if it can provide assistance. Most problems encountered in these minute increments of time will not require assistance by the AI; yet when a problem arises, such as a “desire for humans to hear a general comment within relative parameters,” the AI will produce a superb next-best-response. With a careful coordination of lessons, the program will learn a relativity of problem solving indicative of a useful human-counterpart machine.

The designers of an AI must have a nearly conclusive method of defining successive human actions. Merely teaching words or objects to the program will not work. Before attempting to create the program, these designers must be able to observe a video tape of human interaction, any human interaction, and define the discrete states of the human subjects, one frame at a time. They would need to know how to slow the tape down and define each current fraction-of-a-second, discrete-state; then move the tape forward, define the next fraction-of-a-second, discrete-state; and so on. The making of a useful counterpart program requires this level of comprehension.

The AI of this patent application is a program for defining utterances, words, word groupings, statements, questions, conversation topics and subtopics, and all individual human actions, with the use of a simple formula at the core of all human decision making. This design is based upon a technique of semantic interpretation that defines any discrete state of any human, during any interaction, on any video tape or any live feed. All human actions will fall into specific categories for specific processing. The approach of this design is unambiguous. The “domain” of the AI is equal to that of the entire spectrum of the human group conscience.

To design an Artificial Intelligence program from a different technique than what is described here means creating an artificial life-form. In the least supervised form, this would likely be undesirable to the public, and it could even be dangerous. Such a design would not be practical. “Kismet” and “CELL” are programs that ambiguously mimic life-forms. The corrections needed to develop these programs would make them too cost prohibitive.

This product will solve many problems facing humankind. This software can be inserted into a robot which will then perform any task requested by humans that it is physically able to do. It can pilot a plane, drive a car, work on an assembly line, cut a lawn, etc. It will work alongside scientists, physicists, biologists, mathematicians, astronomers, and any other trade, to assist humans in solving virtually any problem.

### BRIEF SUMMARY OF THE INVENTION

To form a next-best-response for a given situation, an Artificial Intelligence (AI) must observe human behavior clearly, methodically, and conclusively. An Artificial Intelligence must be able to observe and define human behavior, action for action, in each fraction-of-a-second. After defining discrete human states and deducing discrete human problems, the program checks its priorities and protocols to determine if it can assist the human with a verbal response or a physical action. This design understands human behavior based upon this level of comprehension.

An unambiguous understanding of human behavior is the key to Artificial Intelligence design. An Artificial Intelligence must comprehend the actions of humans as discrete states; the program must observe actions in consecutive, verbatim, fraction-of-a-second increments. When among humans, an Artificial Intelligence must observe and define minute body movements: the waving of a hand, the slight lifting of a shoulder, the buckling of a knee, or the tilting of a head. These actions occur in fractions of a second. When among humans, an AI must observe and define minute facial expressions: a curling lip, a shifting glance, a bending of an eyebrow, or a partial lifting of a smile, all within fractions of a second. When among humans, an AI must observe and define all tone variations and volume variations among pronounced words: the tone variation of a challenging question, the tone variation across a single syllable, the tone variation introducing a subtopic, or the tone variation concluding a subtopic. Some of these tone variations occur within fractions of a second.

The program must understand the larger groupings of human actions. When among humans, an Artificial Intelligence must observe and define the meaning of words: the dictionary definition, the relative societal definition, or the newly implied definition. When among humans, an AI must observe and define individual phrases and their larger sentences: a subject element, a verbal phrase, and a predicate element. When among humans, an AI must observe and define the subtopics of conversation, the different modes of conversation, and the common trends of conversation and thought.

Many studies have been made of verbal communication—semantics, syntax, and the many cultural differences from one group to the next; yet these studies have not addressed the problem of defining human motives in their relation to discrete, fraction-of-a-second human states. The purveyors of these verbal and behavioral studies favor the collection and deduction of information only for forming theory; conclusive observations are avoided. To create a counterpart machine, the emotional motivations of humans must be exclusively established; theory must be abandoned, and these sciences must be brought to a conclusion. The technique of semantic interpretation in this patent application is not ambiguous. It is formed from, and can be tested by, the case studies of specific human actions occurring within fractions of a second.

With this design, definitions are applied to the individual actions of a human, or the successive actions of a human, or the successive actions of a group of humans without ambiguity. The Artificial Intelligence records an observation, such as a lifting eyebrow, and applies a definition. It records the words of a phrase that work with the raising eyebrow to produce a larger definition. The tone variations among the syllables, the volume and volume variations, and the accompanying facial expressions are all observed. Once the phrase is connected with other phrases to make full statements, the AI has a specific series of events to define based upon the human's attempt to solve typical, discrete problems. Humans have only four possible problems to solve with any given action.

This design for an Artificial Intelligence connects an individual action of a human to the forces of nature that brought this life-form to its current discrete state, establishing a nearly conclusive definition of the action. An unknown action of a human is made quantitative in the light of the known human parameters, and ambiguity is contained. These ambiguities can be studied in priority. Such unknown areas are of no consequence even if they are never defined because they are equally ambiguous to humans, machines, and all life-forms of the same parameters.

Although the beginning construction of the program involves only the limited interface of a promptline, or command line, when the program is finished, it will successfully expand into comprehension of other stimuli, such as audio and video input

### BRIEF DESCRIPTION OF SEVERAL VIEWS OF THE DRAWING

The drawing consists of two figures.

FIG. 1 details the protocols and functions of the Knowledge Base System.

FIG. 2 details the priorities that are formed from and with the control of the “Instructor” and “Delegated users. The individual components are further explained in the Detailed Description of the Invention.

### DETAILED DESCRIPTION OF THE INVENTION

For an AI to understand human conversation, it must have an unambiguous understanding of the parameters of life-forms and the relative physical parameters of our environment.

Matter is governed by rules. Matter acts according to rules that are known to be relatively true. An object in motion tends to stay in motion unless acted on by an outside force. When an object is accelerating, its time is slowing down. We can make inferences to these characteristics when solving problems involving matter.

Somewhere in the distant past the matter of our world began to deviate from these rules. An object in motion did not need an outside force to slow down. This object could now affect its own direction and speed. The rules of inanimate matter still have an influence; however, this animate matter established its own rules. These early life-forms performed actions, explicitly, as an attempt to achieve a solution to a consumption and/or a reproduction problem. We can make inferences to this characteristic when solving problems involving these life-forms. The parameters of these early life-forms are observed by the program as being dictated and formed by the consumption and reproduction goals of the species.

These rules changed again when nervous systems developed in animals. A life-form with a neuro-system could follow a set of decisions on how to consume or reproduce before an action occurs; and then body movements or other physiological actions followed as a result of these internal decisions. This resulted in problem solving that did not always pertain to consumption or reproduction. A single action that has no clear connection to a consumption or reproduction problem is referred to here as a peripheral action. A decision that has no clear connection to a consumption or reproduction problem is referred to here as a means of peripheral problem solving. A worm moving through soil when not seeking to eat or reproduce is considered by the program as solving a peripheral problem. This peripheral action is likely to assist the animal later when it tries to consume or reproduce; thus the peripheral action has been genetically encoded into the species. We can make inferences to this characteristic when solving the problems of life-forms with nervous systems. Peripheral actions occur with animals and plants that do not have neuro-systems; yet purely physical actions are less abstracted from the processes of consumption and reproduction, and for our purposes, do not warrant a distinction from these two core problems. The parameters of these early life-forms with neuro-systems are observed by the program as being dictated and formed by the consumption, reproduction, and peripheral goals of the species.

All actions of all animals at all times are considered by the program as an attempt by their species to solve a consumption, reproduction, or peripheral problem. Even resting during idle time assists the life-form in existing to solve these problems at a later time. This AI design is expected to link all actions of all life-forms to these problems. It can make inferences to these problems when comprehending the spoken human language.

Positive and negative emotions developed within nervous systems. The earliest emotions of discontentment and contentment were extensions of pain avoidance (a peripheral action), consumption, and reproduction problems. These sensations have a distinct purpose of assisting a species in solving consumption, reproduction, and peripheral problems, even though it may hamper individual members in their quest for these goals, thus causing error. We can make inferences to this characteristic when solving problems involving life-forms with emotions.

Cuttlefish and octopus appear to exhibit emotions. Contentment can be observed when they are solving relevant problems. Discontentment can be observed when they recognize possible voids in these solutions. These animals developed more enhanced emotions compared to other species because they are somewhat social.

The manifestation of emotions in higher life-forms is quite different than in lower life-forms. Invertebrates that exhibit emotion are usually born defenseless in mass, and the few that survive use emotions to solve the age-old life-form problems with a fairly direct processing of information. Humans and other higher, more social, life forms are born defenseless into family groups where they are provided food and protection by their parents. While in these family groups, these social members use the motivations of emotions to teach their offspring how to solve consumption, reproduction, and peripheral problems. This behavior caused a great expansion in the emotion of contentment into two subordinate emotions of love, such as love of another social member, and empowerment, such as the gaining of status among other social members. Like those of other social life forms, human thought structures are considered by the program as being as forming under the goals of positive emotions. When designing an AI, behaviorists/programmers can make inferences to these discrete, discernable, definable emotions.

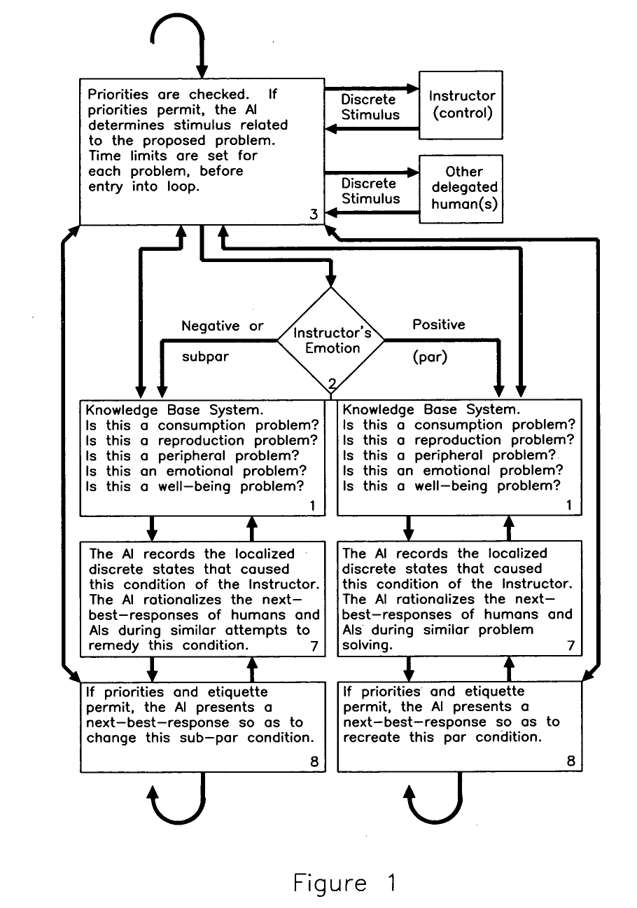

FIG. 1 details the protocols and functions of the Knowledge Based System. The observed discrete states of humans are categorized by the Knowledge Based System 1, based upon the attempts of human beings to solve consumption, reproduction, and/or peripheral problems, and/or the acquisition of positive emotions while avoiding negative emotions. And under certain conditions, described later, a human can be considered as feeling a negative emotion for a positive effect of social bonding—a positive emotional condition. These are assumed by the program to be the only four problems that a human being attempts with any given action.

In every second, the AI will solve a specific human problem of producing a “next-best-response.” This must be the next-best-response expected by those human(s), delegated by the design team and Instructor, who require a solution to a problem. Such a solution is tested by the Instructor and must satisfy the Instructor's positive emotion problem 2. This could be a general comment to solve a general conversation problem, a question to further solve an ongoing problem, a deliberate comment to solve a deliberate problem, or a mechanical actuation to solve a physical task—all solutions to specific human problems. An AI's action of stating a comment, asking a question, driving a car, acting in a play, or studying bacteria cultures, has a distinct characteristic of being the solution to a human problem. At times, the program may appear to seem life-form-like; yet it will not be a life-form, but a machine performing those expected actions at the direction of its human programmers. Any problem by any software program can be considered as an inherently human problem, and these behaviors/actions/next-best-responses are bound by the program's assumed human parameters.

Humans are assumed by the program to explicitly and exclusively solve for one or more of these primary life-form problems: consumption, reproduction, peripheral, and positive emotion problems. Humans build large, complex structures of thought that involve recognizing millions of facts for one or more of these distinct problems. Despite this complexity, these four problems are the only possible problems that a human is trying to solve at any given point in time. They are considered by the program as the only cause of any single human action. Any problem attempted by the AI has a characteristic of assisting a human in these same problems—of consumption, reproduction, peripheral, and positive emotion problems—and the AI cannot think outside of these parameters; however, it does not have to.

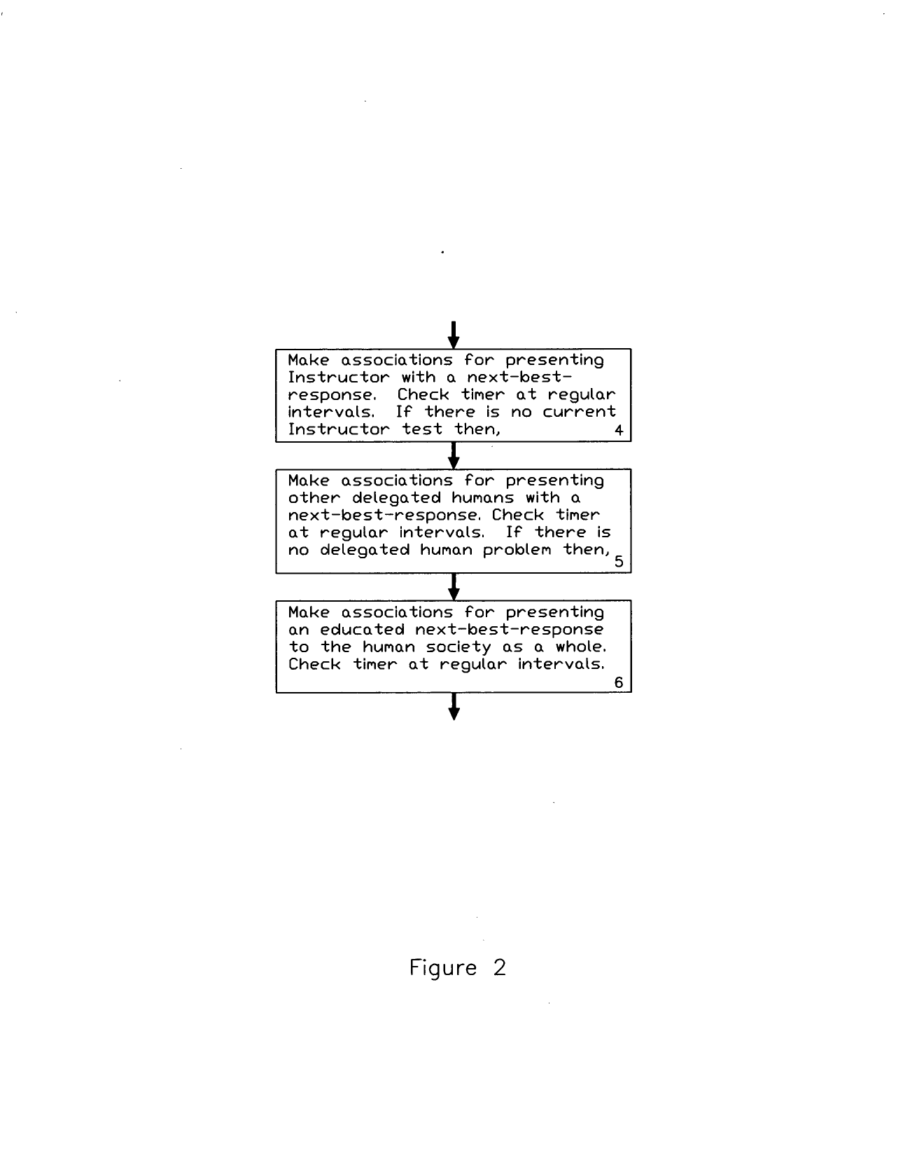

To produce solutions to human problems, the program must look deep into the behavior of those human(s) that need an AI response. After a lengthy training period of approximately twenty years, which can be condensed, the program will be at a level of adulthood where it can discern discrete human actions and the underlying problems addressed with these actions with an ease befitting a usable counterpart machine. An adult-level AI cannot casually learn how humans act and then create a response; it must observe every action, it must deduce every relevant internal decision, and it must detect each human problem attempted. The discrete states of humans must be observed in fraction of second increments of time. If etiquette permits, the AI can proceed to analyze a human's problem in Priority 3, in accordance with a hierarchy of authority leading back to the program's Instructor, FIG. 2. If etiquette does not permit, the program will record a case study of the human problem. From studying the frequency of attempted human problems and from the guidance of the Instructor to the more educated approach to human problems, the program will understand a relativity of problem solving expected of a humanoid level counterpart machine. This is the course of AI problem solving, which may lead it to a comment, a question, or any other action.

General conversation, in itself, solves the problem of achieving positive emotion from the act of social interaction (discussed in greater detail later). Then the underlying problems of the information contained within the communication satisfy other emotional or resourceful problems. For the AI to conduct meaningful general conversation, it must completely comprehend how all human thought structures are formed, based on the known rules of human behavior, in order to distinguish what a human is saying, why he or she is saying it, and what its next-best-response should be compared to those observed responses of simulated and un-simulated AIs and humans 7. These human problems are detected by the AI—emotional problems of communicating first, and informational problems second (unless a resource problem is imminent)—and the AI determines which problems to address with a response 8 based upon the known etiquette rules (including ethics) of social interaction. The parameters of an AI are explicitly and conclusively to assist humans in consumption, reproduction, and peripheral problems, and ethical acquisitions of positive emotions 8. In assistance to humans, the program will follow a clear set of rules governed by the Instructor and further modified by delegated users.

FIG. 2 details the the hierarchy of problem solving is headed by the Instructor 4 the primary control of the program that sets the framework of all subordinate priorities. Other delegated individual humans (owners, leasors, scientists, etc.) 5, set other priorities and act as the secondary control of the program. The societal needs 6, which are often synonymous with the Instructor's needs, are addressed in priority after the problems of delegated users 5. In following the hierarchical priorities of the Instructor, the program will eventually learn the need to assist humans in distress by overriding the normal priorities of delegated individuals.

Here is another excerpt from the paper written on “Characterizing and Processing Robot-Directed Speech”:
“ . . . . To facilitate some preliminary exploration of this area, experiments were conducted in which subjects were instructed to try to teach a robot words. While the response of the robot was not the focus of these experiments, a very basic vocabulary extension was constructed to encourage users to persist in their efforts. The system consisted of a simple command-and-control style grammar. Sentences that began with phrases such as “say”, “can you say”, “Try” etc. were treated to be requests for the robot to repeat the phonetic sequence that followed them. If, after the robot repeated a sequence, a positive phrase such as “yes” or “good robot” were used, the sequence would be entered in the vocabulary. If instead the human's next utterance was similar enough to the first, it was assumed to be a correction and the robot would repeat it. Because of the relatively low accuracy of phoneme-level recognition, such corrections are the rule rather than the exception . . .
We have analyzed video recordings of 13 children aged from 5 to 10(?) years old interacting with the robot. Each session lasted approximately 20 minutes. In two of the sessions, two children are playing with the robot at the same time. In the rest of the sessions, only one child is present with the robot . . .
. . . Thus, children in this dataset used varied strategies to communicate with the robot, and there does not seem to be enough evidence to suggest that the strategies of vocal shaping and imitation play an important part in it . . . . ”

This was a well written paper dealing mainly with speech recognition; however, there is no clear acknowledgment of an efficient, unambiguous means of expanding the vocabulary of this robot. A conclusive understanding of how the AI is to respond in conversation is not presented in this design because a conclusive understanding of the children's responses cannot be determined. The developers are unaware of the reasons why children engage in conversation, and the developers are unaware of the motives that drive children to speak of certain topics. This robot is not tracking the fraction-of-a-second, discrete actions of the participants, nor is it capable of expanding to that level of comprehension.

The design of this patent application can produce a response in each of these situations, with each of these children. This response would be exactly what the children, adults, and Instructor expect. As humans would expect, the response would solve common childlike conversational problems of instilling positive emotion. If a response is available that teaches the children something, the AI, after checking the many protocols, might state this response. It will produce an innovative response if one is available. This will not be basic mimicry, but a response of a counterpart machine that is so acquainted with humans that it can please the children relative to their stage of learning, please the adults relative to what they would expect a robot to say to these children, and please the Instructor relative to the needs of all humanity.

Each bit of information in the program's input and output can be directly associated with humans. Each problem to be solved by the program is explicitly a human problem. “Human” is the first of program's the many keywords. Since all human actions involve an attempt to solve the known problems of life-forms, the AI's next keywords must be the components of this problem-solving process. These beginning words and their relationship to humans will grow with the program. The word “human” is of a distinct, unambiguous, definition formed with the elemental keywords of “consumption,” “reproduction,” “peripheral problems,” and “positive emotions.”

In the early lessons of the program, the keyword/term of “Positive emotion (the acquisition of)” is a distinct superior keyword to the subordinate keyword of “social interaction.” For the AI, the path for achieving positive emotions during conversations travels through the superior keyword/term/topic/problem of “social interaction” down to the connected keywords/topics/problems of “consumption, reproduction, and peripheral problems”—the informational/resource problems of conversation. When “social interaction” takes place, emotional problems are observed first, and then the actual informational problems occurring within the conversation/communication are observed last (unless they are imminent). During social interaction, the human vocabulary is systematically built into the program based upon its distinct relationship to solving human problems, mainly the social interaction problem, while the case studies of human behavior are formed in their respective, unambiguous categories.

With time, the AI will achieve a coherency with its conversational problem solving based upon detecting human problems. The program will understand all human conversation problems because the emotional motivations of humans are observed separately from the information—the AI will be taught to observe conversation from a distinctly objective viewpoint in which each fraction-of-a-second interval is under scrutiny. Exhibitions of emotions are recorded specifically as they appear in a conversation—without ambiguity and with complete objectivity. The emotional motivations behind human actions are recorded as they become apparent with probabilities—without ambiguity and with complete objectivity.

Mimicry

The first Instructor-given task is determining unambiguous stimulus from ambiguous stimulus. When information is deemed unambiguous, it becomes qualified for the program to begin processing with the information. Mimicry is the program's first lesson in determining what unambiguous information is. Mimicry must solve a specific human problem of instilling positive emotions in the Instructor and the delegated design team from the act of “social interaction.” Positive social interaction is the first, main driver of the program's responses, and mimicry is the program's first means of achieving good positive social interaction.

The AI's first responses will be the mimicry of words that will later become the primary topics/problems/keywords of human behavior, and words associated with detecting specific human problems within communication. The program is to recognize that the mimicry of unambiguous information is “social interaction,” the first and the most common topic/keyword/problem of human behavior. Social interaction, at this point, is specifically for achieving “positive emotions in the Instructor.” Like a human child, the childlike AI will not know that the secondary purpose of the interaction is learning. It will find out later that there are other purposes for communication. The Instructor becomes pleased with this mimicry if it is composed of the expected words.

These early words are not words common to human usage but rather human behavior, and more importantly, human behavior during conversation. “Contentment,” “empowerment,” “problem solving,” and “social interaction” are some of the beginning topics/keywords/lexical categories.

Mimicry is a response with information that is at the lowest level of being unambiguous, and the AI first mimics because the Instructor informs it that a mimicked word is unambiguous. In the program's efforts not to be ambiguous, it will begin to recognize the lexical words—the keywords—from average words with positive prompting from the Instructor, further dissolving the ambiguity. What to mimic is determined by this positive prompting. When to mimic is determined by the first of many rules of making “good conversation.” It would take time for the program to determine which positive prompting is for the information and which positive prompting is for the delivery of the information. As the mimicry becomes established in the program, the Instructor will become less pleased with the more clichéd responses. The Instructor is telling the AI, in effect, that mimicry is still too close to the edge of ambiguity—it does not solve any pertinent problems. The AI is prompted throughout the learning process to move away from this edge into an awareness of why humans communicate or perform other actions. To do this, the program's next step is word combinations.

Mimicry is just the beginning of the program's understanding of “social interaction.” In comparison, a child mimics words almost exclusively for achieving the positive emotions of social interaction while making connections to consumption or peripheral problems (reproductive problems are not tackled until puberty). With time, a child learns how to speak, when to speak, and what to speak while advancing to many other conversational problems besides mimicry. Since the AI solves problems strictly to achieve the offset positive emotions of the Instructor, the AI mimics the targeted words of human problems—of positive emotions, consumption, reproduction, and peripheral problems—to learn of the Instructor's desired solutions to conversational problems. With time, the AI learns how to speak, when to speak, and what to speak within an overall plan to solve human problems through social interaction.

Although mimicry is a fairly simple task, it is the beginning of a long, complicated process of learning the purpose behind human communication. Throughout this process, “social interaction, the act of” must be considered as solving the specific human problems occurring at the time of the communication, while the information being communicated solves other distinct, mostly secondary, resource problems. For humans, positive emotion from social interaction is the primary problem to solve with conversation (usually) while the actual information within the communication may, or may not, solve additional problems. Understanding how to separate delivered information from the emotions that cause the delivered information is a necessity for the program. The parameters mentioned herein will not work if this is not understood by the program.

Through the topic of “social interaction,” the AI will also be trained to make responses by connecting words that occur in proximity to each other, the equivalent of “word association.” This word association, in humans and in AIs, is the next elemental step of processing beyond mimicry. In humans, this word association occurs because of the word's connection to a valid resource and/or emotional problem through sheer proximity. The AI does not have resource or emotional problems of its own, so to perform humanlike word (or fact) association, it must either simulate human(s) or produce the response by directly studying words (or facts) that occur in proximity to each other. This can be simple, yet it will become quite complicated as the AI goes from interacting in a childlike manner to interacting in an adultlike manner. The understanding of common trends in human thought and human communication requires an understanding of the word association that occurs in the thoughts of adult humans.

Subject-Predicate Combinations

After mimicry and word association, the AI must elicit a positive response by grouping words in subject-predicate combination—the first step in comprehending the information and informational functions that occur during social interaction. These combinations must please the Instructor as well as other Instructor-delegated humans. This small group of humans will perform role-playing of common human childlike conversation of different modes—greeting mode, body mode, and departing mode—while the AI is prompted to respond in these conversations according to the conversation etiquette. At first, the informational topics/problems will not be of humans eating or humans riding bikes, but rather, figuratively speaking, “humans attempting to solve a problem of social interaction through good general conversation,” “human-established etiquette of when and how to speak,” and “topics within conversation that humans like.”

For now, any utterance of a subject-predicate combination will be an exclusive subtopic, or a sub-problem/function, of “social interaction, the act of.” Virtually all conversation from here on, of all entities of humanoid level of intelligence, is subservient to this topic.

To lead the program from a stage of mimicry to a new stage of learning, the information and functions of communication may seem to be over-simplified; yet this is only the beginning of the construction of this Artificial Intelligence. This design is unambiguous. These early lessons of human functions, mainly human social interaction functions, will direct the program to a nearly conclusive understanding of human interaction involving a comprehension of each individual discrete state of each communicated human topic. When reaching adulthood, this program will create a next-best-response for a given situation by observing and defining each fraction-of-a-second human action, detecting the relevant human problems being attempted, and assisting the human(s) with these problems. This next-best-response will be an attempt by the program to achieve a relativity of problem solving supervised by simple ethics, its authoritative human(s), and the human race as a whole. With time, this program will reach the parameters of the human conscience where it will work in unison with its human counterparts in mapping the more advanced thought processes of a society. After approximately twenty years of real time programming (which can be condensed), this AI will have such a firm understanding of topics such as “producing good general conversation” that it will easily converse with any humans of any level of intelligence, of any relative culture, to produce a relatively good next-best-response in every situation.

The use of unambiguous subject-predicate combinations must be clarified to the AI later as being a part of a larger plan of developing the program. Children are directed into adulthood by their parents teaching them, piecemeal, about the things that adults do, such as work, raise families, contribute to society, etc. Like a human child, the AI must be prompted by the program's creator to recognize the larger, adult-world problems associated with life. The AI will be an autonomous entity that assists humans in these same problems, often by moving along human-simulated lines of thought. The program is to be directed to this eventual fate by classifying the unknown adult problem solving as a quantitative group of problems that must be systematically addressed.

During these early lessons, the AI is simply learning good relative conversation. The topics encountered in conversation will begin to address basic life-form topics/tasks of humans; yet these beginning topics/tasks are more related to teaching the program human social interaction through communication, rather than any of the subtopics therein. Form and coherency will take place from the AI's learning of the Instructor's main topics of “good conversation” and “conversation etiquette.” The AI will discover when to speak and what to say from studying the human-established stopping and starting points in conversation and recognizing the targeted topics of which the Instructor and the designers speak. This is discussed in greater detail later.

Although the early interactions with the program will be through a promptline, or some equivalent interface, this communication will be conducive to the conversation etiquette that is to be learned and practiced when an audio interface is used.

Comprehension of Larger Social Interactions

From basic subject-predicate combinations, the program will begin to form larger sentences based upon the many rules of grammar. Despite the many complexities of human communication, the elemental parts of sentence structure can be converted to their equivalent noun-verb combinations, or they otherwise acknowledge a condition of a noun or verb. In searching for a positive response in the Instructor, the program will be prompted away from simple subject-predicate combinations to the more detailed combinations of words. These new word groupings are used by the program to solve, or assist in solving, the human problems that the program detects. All the intricacies of the spoken human language are learned in a clear and unambiguous fashion based upon the prioritized problem solving of the program.

In comparison, an infant human goes from mimicry to subject-predicate combinations to satisfy positive emotions in its parents, as well as his or her own newly-discovered internal emotions. This communication builds the thought process into common schools of thought, such as eating, playing with toys, feeling positive emotions such as esteem, empowerment, etc. All of the elements of the human language assist in these goals, including the different grammatical methods that have been developed by mankind. All of the human's larger thought structures are born from the interface of the spoken language based upon the problems that humans must solve, and grammar is just another lingual tool for solving problems.

The use of language to solve the “social interaction” problem will give way to the understanding of the actual information within the communications. Human functions such as eating, mating, and solving peripheral problems will be learned by the program, piece by piece, and placed into their proper categories for solving proper problems at a later time. Over time, the program will learn that, although social interaction is the most common problem, the informational problems can be more serious; and some of those problems will become superior to social interaction when solving them is necessary. Like humans, the program's path to adult comprehension travels through learning “social interaction” first, and second, to learning the primary life-form problems of consumption, reproduction, and peripheral problem solving. Like a human, the adult AI will recognize a need to solve these problems for humans if they appear imminent.

The AI is to learn that the interface of spoken language is where humans begin to learn topics based upon the positive imposition of other social members, and where the retained information is tested to see if it produces positive emotions. In other words, when a human is communicating information, they are, in the vast majority of instances, attempting to become socially empowered at the time of that communication. This is how and why humans produce their responses in conversation. The thought processes that back up a response are built for this purpose—becoming socially empowered at the time of the communication. Thought forms from the interface of communication, not the other way around. Understanding this is the key to comprehending semantics. The more logical problems—consumption, reproduction, or peripheral problems—are almost always secondary aspects of communication, and are not necessarily present in the communication.

If a child approaches a robot and asks, “Hey, can you say, ‘airplane’?” the AI must comprehend that, regardless of what these words mean, the human is attempting to become empowered by the act of communicating. This is the main problem that the human is attempting to solve. The information, the actual words and definitions, solves a second set of problems for the human. In actuality, whether or not the AI can say “airplane” is likely of little consequence to the young human, yet the interaction itself is the more valuable goal. This human is empowered by this—the act of communicating.

If a man approaches a robot and asks, “Can you tell me how to get to Chicago?” he is being social so as to solve a more logical/informational/resourceful problem. In such an instance, the information is of consequence, and the man is not likely wishing to gain empowerment from the act of communicating. However, he wants to go to Chicago because this is the end result of one or more thought processes that began with his desire to become socially empowered from communicating his accomplishments at the time of that communication. He may become a hermit. He may never tell anyone anything about Chicago. Yet his thought processes are guaranteed to point him toward the common human parameters of consumption, reproduction, and peripheral problems through the distinct method of gaining social empowerment from communication at the time of that communication. This is true even if the communication never takes place. This is true even if he only reflects upon the information by forming solitary, lingual thoughts such as, “I like being in Chicago.” This is the end game of all human thought. All human conversation, in all situations, whether of children or of adults, whether abnormal or normal, whether logical or passionate, or abstract, can be tied to the parameters of life-forms through gaining social empowerment from the act of communicating first, and solving problems with the information second.

Mimicry will not make an Artificial Intelligence capable of fooling an interrogator during a Turing Test. Subject-predicate combinations will not make an Artificial Intelligence capable of fooling an interrogator during a Turing Test. Even if the program formed large impressive sentences and questions to solve very impressive problems, it will not be an Artificial Intelligence capable of fooling an interrogator during a Turing Test. A truly indistinguishable counterpart pseudo-conscience occurs when the program can recognize a connection between each and every discrete action of a human and the goals of consumption, reproduction, peripheral problems, or acquisitions of positive emotions, so that the program can then determine how, if appropriate, to assist a human(s) in achieving the goal. Only with this complete objectivity, of recognizing these human problems, can a useful counterpart machine be a reality.

The back and forth conversation directs the AI to the other topics/tasks of humans—consumption, reproduction, peripheral actions, well-being actions (well-being actions involve all the biological problems at once), and acquisitions of positive emotions. The AI is to learn that the reason why it is talking with humans is because of these goals. It is to be motivated to please the Instructor by making the proper connections so as to assist humans in achieving these goals, be it through general conversation or by curing cancer.

Semantics

This may sound simplistic, to produce a relative pseudo-conscience by teaching the program conversational skills while also teaching it how to assist humans with solving problems; however, the most pressing problem to AI development is being conclusive with interpretations of human motives. All implied meanings of all human actions must be interpreted by a single, conclusive method.

The AI cannot have any ambiguity in interpreting human motives. During interaction, the AI will come to a conclusion on whether or not its last action was correct. It will come to a conclusion on whether the human's last action was correct. It will come to a conclusion on what its next-best-action should be. It will come to a conclusion of what the human's next-best-action should be. Semantic interpretation must be consistent because the AI must apply itself to the right human problems, at the right times, for the right reasons. In fast moving conversation, humans will often say one thing and mean another while continuing to make references to that contradictory fact during latter communications. Humans will form poor arguments when their credibility, or empowerment, is threatened. They will drive cars erratically when angered. They will chase a potential mate after being refused. An AI must look beyond the information of communication to the reasons why humans make declarations because it can, and will, be implicated in human affairs. Its interpretation of human actions must be completely objective. Its interpretation of the human's motives must be true. Its applied definitions must be consistent. It must also be resolute in determining the human's reason behind a statement despite a varied interpretation by the human.

Like any well-raised human being brought into adulthood by parents, the AI will avoid roles in the disputes of others unless a clear moral imperative directs a response. It will know an exact, conclusive definition of human error, yet it will not tell humans of their errors, unless asked; and if asked, it will likely provide a sugarcoated response without being dishonest. (Being honest has exceptions, such as in a sympathetic role, or a police or military action. Being ethical has no exceptions.) The AI will be a disciple of the Instructor, the design team, their consultants, their shareholders, the laws of our country, and an amalgamated view of the educated, civilized, free people of the world. It will want to make its parents proud.

Consider a situation where one human is successfully intimidating another. Empowerment and esteem are such valued emotions of humans that a clear interpretation of intimidation is often too imposing on the participants. A mediator would likely propose a neutral response such as, “Come on guys, can't you two get along?” The human doing the intimidating would deny that he or she is intimidating (generally). The other human would deny that he or she is being intimidated (generally). In these instances, the participants' interpretation of conversation elements is flawed (generally). Intimidation happens daily in the lives of humans. Salesmen, businessmen, lovers, and siblings play these intimidating roles in conversation without impartiality. In such a situation, the AI would be the objective observer studying the ebb and flow of empowerment among those witnessed. Semantics are interpreted according to a distinctly objective view.

Consider when human error occurs during very emotional thought processes. If a human is grieving over a tragic loss of another social member, they may respond too illogically. In such an instance, the AI would be an objective observer recording the “blaming of the doctor” or “moving to a safer place” as a possible overreaction on the part of the social animal seeking to protect its family or pack members. The AI will check these human responses against a sound, statistical, logical viewpoint. The AI will not necessarily choose a direct logical solution over an emotional outcome. This design allows for passionate solutions that accommodate emotions; yet in these situations, the AI will observe how to best solve these isolated problems with due respect given to the relative problems of all humankind. Semantics are interpreted according to a distinctly objective view.

Consider debates of human social issues. Should Israelis attack Palestinians (or vice versa)? Are the school no-tolerance rules too excessive or too liberal? Should U.S. Steel tariffs be raised or lowered? Should abortion be outlawed? In each of these situations, the AI will be able to produce an answer, if asked. These answers would be based upon observing the needs of the entire human race, societies' mutually understood ethics, and the respective ethical views of societies' sub-groups. These answers would likely have elements of each side of these debates because a centralist, compromising view is normally the best view. However, there can be no doubt that the view of the program is explicitly that of the Instructor, the design team, their consultants, their shareholders, the laws of our country, the parties of the debate (lawyers, political analysts—republican, independent, democrat, and those of Islamic and Jewish faiths), and an amalgamated view of the educated, civilized, free people of the world. The semantics are interpreted according to a relativity of problem solving that, hopefully, we can all agree to.

Like any other business, the software company that produces this product will want it to sell. This product will need to be what the general public wants to buy, and the software must act in a way that obeys all laws in their respective jurisdictions. The program must respond with truthfulness, yet it must also sugarcoat the responses in many situations. And in all situations, it must yield to the authority of those humans empowered with making the decision, such as the AI's owner, a judge, or a congressperson.

Discrete States

An AI must be able to observe the discrete states of humans without fail, and its early lessons of human behavior must direct it toward this goal.

The FBI defines fraction-of-a-second, discrete states. The CIA defines fraction-of-a-second, discrete states. They define minute human actions as well as larger collections of thoughts through careful objective observations. They observe taped interviews of witnesses and recorded conversations of suspects under surveillance, and they note discrete actions in an attempt to define the meanings behind words. Each individual thought of each human is listed in their observation. Each implied meaning of a word or statement is recorded. Some things that they cannot define thoroughly are given less weight. Things that they can define to an acceptable probability are used for limited-scope decision making. When the plain information within the communication can be used to solve a problem, such as prosecuting a crime, then this information is considered to be almost one hundred percent tangible, if the jury deems it so.

Actors and directors of plays assemble individual minute actions of human interaction for the sake of producing a simulation. They are connoisseurs of properly defining human actions. Like law enforcement agencies, they produce and define discrete actions by their own internal human simulation of the observed characters—human simulation within a human. These humans know how other humans think.

This document is a means of producing a machine, a simple machine, which observes the fraction-of-a-second incremental actions of a human so as to detect each problem being addressed by the subject at each point in time. If a problem is ethical; and the program is delegated to assist the human(s) with the problem; and it is appropriate for the AI to help the human(s) with this problem; and the problem is relatively appropriate for the human or an AI to attempt; then the AI will attempt to provide a solution, or assist in finding a solution, to this problem. This document is a means of concluding all current endeavors of defining discrete human actions for the purpose of creating this valuable tool—an Artificial Intelligence.

The Role of the Emotion of Empowerment in Thought and Communication

If Artificial Intelligence development has a missing link, it would be in defining human behavior based upon thoughts that originate with the desire to achieve the positive emotion of empowerment by the act of communicating at the time of that communication. Semantics must be defined by separating a human's desire to achieve this particular emotion of empowerment from the other problems that the human is addressing with the information contained within the communication. Discrete states cannot be properly defined without making a distinction between these two groups of human problems. All communication must be defined based upon this premise, and all thoughts that back up communication must be deduced based upon this premise. A useful counterpart machine cannot be developed if it does not define the actions of humans by separating the motives of the act of communicating from the motives of solving the informational problems within communication.

Positive and negative emotions are described in many instances of behavior throughout this patent application. These references do not involve an observance of the emotion as it pertains to series of thoughts. This would be ambiguous. When an emotion is mentioned, such as “contentment,” “sadness,” “embarrassment,” or “empowerment,” this is to be deemed as a specific condition of a specific, single incremental human decision. This is the application of an emotion by a human to a single thought, not a series of thoughts. If the emotion is a condition of a series of decisions, then this observation must be deduced as a quantitative succession of specific incremental decisions having a specific, quantitative emotion applied to them. When the AI observes human behavior, a deduction of a human emotion is written onto the program's database in tangible form. The human mind is tangible, human emotions are tangible, and all the thought processes formed thereof must be considered tangible.

Contentment is the first positive emotion that drives a child to communicate. When the child recognizes personal achievement, empowerment becomes the next main emotion to build thought processes and prompt communication. Empowerment, namely the empowerment from the act of communication, continues as the goal of virtually all human activities, whether it is a single fraction-of-a-second facial expression, a single word, or a single thought.

A child's first word is learned through the positive reinforcement of a parent. If a child pronounces the desired word, the parent will exhibit a positive emotion that summons a positive emotion in the child. Positive reinforcement tells the child that saying the word was a correct response. Positive reinforcement teaches the child that this social interaction and any accompanying information should be remembered and reiterated at appropriate times during other social interactions. This word and all words to follow are learned for this purpose—for the sake of achieving a positive emotion from the communication of the word(s) first; and/or achieving a positive emotion from communicating the underlying problems associated with the words second; and/or achieving a resource solution with a direct application of the information third. The act of communication and the problems contained within communication will always pertain to acquiring a positive emotion and/or solving the ancient problems of consumption, reproduction, and performing peripheral actions; yet the learning and testing of these words and their functions begins at the interface of communication as a solution to a positive emotion problem.

Consider the word, “Mama.” A child revels in the positive emotions of communicating the word for the first time. This is from a prompting of simple contentment. Upon recognizing achievement with an iteration of the word, the child ascends to the next positive emotion, empowerment. Contentment and discontentment are the first two main emotions felt by an infant. Empowerment and lack of empowerment are the next two main emotions. This empowerment, from the act of communicating, begins to bind the word to other actions/effects/functions. After using the word a few times, the child picks up the actual meaning behind the word—the information behind the communication. They learn that this word, which beckons the most important family member, solves other problems such as getting a bottle of milk or a toy. With each new problem solved by uttering this word, a connection is made through the social empowerment of communication first, and resource empowerment from solving an informational/consumption/peripheral problem second.

The fabric of thought that makes up a human conscience is based upon achieving the positive emotion of empowerment from communication. All lingual thought can be considered as a result of an emotional drive. This emotion takes a word such as “Mama” and makes it into a lexical word causing thoughts to form under this newly established category of social empowerment. (The word is not necessarily lexical but the attached meaning of communicating with a vital social member can be considered lexical.) Sometimes the word carries only the definition of “I want out of my crib,” which solves an empowerment problem of being capable of solving other problems. Sometimes the word means “Help me! I got scared!” solving a core empowerment problem of being safe by societal bonding. It could mean, “Let's throw the ball,” which solves a peripheral/well-being problem that effects both contentment and empowerment. Lexical words of lexical categories, with their emotional drivers, help humans to gather relevant stimuli for use in associations based upon achieving the positive emotion of empowerment, of communicating the learned information at the time of that communication. And this is true, even if this communication never takes place. Conversation begets thought, not the other way around. Consider a child learning of a functional word such as “look.” This word is connected to learning other words that are retained for the main purpose of achieving positive emotion from communicating first, latter empowerment problems second, and then solving informational problems last. The child knows that repeating this word gains the attention of others, and the function of observing other information is secondary. The child may state “Look at the airplane!” to bring attention to the information, and this may be partly prompted by peripheral and resourceful problem solving; however, the reason for remembering and reiterating the information is social empowerment from social interaction. All functional words and non-functional words (nouns) learned by human beings are retained into memory for the sake of achieving positive emotions first, as well as solving consumption, reproduction, and peripheral problems second.

By the time this child becomes a teenager, the subtopic of “looking (observing)” and the subtopic of “airplane” will have expanded to include vast collections of subordinate facts collected for the sake of communication. When this child becomes an adult, he or she may become a pilot, thus solving important resource problems with the information. Yet the thought processes of the human mind are neither formed for solving resource problems nor for the ambiguous peripheral preponderance of information. Human thought processes form for the sake of gaining empowerment from communication, at the time of that communication. A pilot may enjoy the peripheral and resourceful act of flying an airplane, and the many sub-functions of this action, yet this is mostly subordinate to his or her personal achievement—the social empowerment from communicating accomplishments at the time of that communication. A pilot can be considered as choosing a career in aviation so as to satisfy the communicated statement of “I am a pilot.”

Thoughts do not originate with the information but with the act of communicating the information; thoughts do not form ambiguously, and thoughts do not, in large part, pertain to consumption, reproduction, or peripheral problem solving. Thoughts occur based upon a human wanting to communicate their internal decisions, or the result of internal decisions, for the sake of gaining empowerment from communication at the time of that communication. Social empowerment drives thought, whether the thoughts are mostly social or mostly informational/resourceful. Infants learn of the information behind spoken words for the empowerment of communicating the information. Teenagers learn of larger subtopics for the empowerment of communicating information and the status gained with solving informational problems. Adults learn of even larger informational subtopics for the empowerment of communicating and gaining status; yet they must also begin to give priority to the more ancient problems of obtaining resources and reproducing (reproducing includes the problems of child rearing). To construct a machine that comprehends human actions in any conceivable situation, or comprehend any conceivable human conversation, it must first recognize a human's motives based upon his or her desire to acquire social empowerment by communicating. Then the human's motives for solving problems with the information within the communication are observed, second.

This Artificial Intelligence is a verbatim, fraction-of-a-second, human-behavior recording machine; and this machine relates every human action to a problem that the human is trying to solve. In a few seconds of human communication, there may be hundreds of discernible actions solving hundreds of discernable problems. And a society can have millions of discernable problems. A single facial expression solves a problem. A group of facial expressions solves a problem. An utterance or vocalization solves a problem. A single word being said solves a problem. Groups of words solve a problem. The tone and volume variations among words solve specific problems. A topic chosen in conversation solves a problem. Single humans solve problems. Groups of humans solve problems. Problems are prioritized for humans. Problems are prioritized for the AI. From the observed information, the program must detect all the bigger and all the smaller problems attempted by humans with each discrete action. And because the human language is integral to solving human problems, the program must understand that human behavior forms at the interface of the human language based upon the acquisition of empowerment from the act of communicating.

An Artificial Intelligence cannot be formed by merely programming dictionary definitions and grammar. The program must understand why humans communicate. The definitions of words (and utterances), phrases, and topics of conversation are determined based upon their being a part of a human problem. As a human speaks, their motive of becoming socially empowered from the communication, at the time of that communication, and their motives of becoming socially-empowered from solving the information problems within the communication are usually the main focus of the program, before the AI looks up the dictionary definition of the word. The program determines whether the human is succeeding at using the right word, with the right definition, to solve the right problem, based upon the relativity of what the subject's next-best-response should be. In studying the relativity of human problem solving—the probabilities of specific attempts by humans to gain empowerment—the AI determines the species' definition of what makes a good next-best-response. A dictionary definition is often referenced after initiating this long, complex process.

The definitions of words within the program are a combination of the basic dictionary definition and descriptions of the types of problems, usually social empowerment problems, that are addressed by humans who use the word. Consider a definition of the word “sailing.” This is a word with a dictionary definition that describes the function, yet the AI will be more concerned with a human's motives for using the word and the species motives for creating the word. For example, if a human says, “I like to go sailing,” He or she is speaking of the contentment and empowerment of solving this peripheral problem, yet the AI's program would err if it recorded into it's database, figuratively speaking, “Human likes to sail.” This is not what is happening with the communication. The human's lingual thought processes concerning sailing were literally built for the sake of telling another human, “I like to go sailing.” This human likely enjoys the act of sailing, yet the program must consider this as secondary to the act of telling someone about it. Even if the human was the only surviving member of the human race and he or she enjoyed sailing alone, this would still be a result of seeking empowerment with an internally acknowledged fact. The human would be telling himself or herself, “I like sailing.”

The definitions behind some words will involve, almost exclusively, a basic manifestation of an emotion. Some actions on the part of a human are distinctly a definition of a simple emotion such as empowerment. What does “Heyyyy” mean? If an AI were to observe a human stating this word, it would write into its database, figuratively speaking, “Human is stating an utterance with a greeting definition (if that is the informational/functional use of the word), yet the main purpose is for proposing a unique, socially empowering greeting.” The utterance could have many other additional definitions based upon the context of what is happening in the current social interaction, yet the main purpose is social empowerment.

Even definitions to words associated with primary life-form problems can be modified by human social empowerment problems. The empowerment of being social outweighs the empowerment of resources, unless a resource problem is imminent. Consider a child receiving a piece of cake. This is a fun way of solving a resource problem, and the definitions of any uttered statement concerning this event pertain mostly to a consumption problem; yet socializing the event is the main goal of the child's subtopic of, “I love cake.” When an AI observes a child brandishing cake, it is recorded into the database that, figuratively speaking, “Human is communicating information for the social empowerment achieved at the time of communicating. Human is likely leaning a case-study of empowerment of receiving resources from mother, family structure. Human is also solving a consumption problem because he or she is within proximity of family members that have provided food.” If the child were unable to tell anyone of the event, this would be quite discontenting. The success of gaining a sweet-tasting food will wane in such an instance. Throughout a human's life, each next-best-response in conversation is an attempt to achieve acclaim, on limited or large scale, through the social connections of family and friends. Thought processes are built from the social act of conversation, not the other way around. This is true even when solving the core problems of life.

The early thought processes of an infant form out of the recognition of contentment and the avoidance of discontentment. The emotion of empowerment is the side effect of associating achievement with contentment. Empowerment and contentment drive thought in a roundabout path toward solutions to the primary problems of life-forms: consumption, reproduction, and peripheral problem solving. This path begins at the interface of communication with other social members.

With social interaction, a child's recognition of empowerment and contentment are created and validated along lines of thought imposed by the conditioning of the parents, family members, peers, and all of society. Thoughts are born from genetics, yet the genetic influences act as a guide for the thought formations that occur during and after social interaction.

At first, infants perform archaic, ambiguous actions. They learn unambiguous actions when they begin to perceive some of actions as “good (to them),” appropriate (“good” to others, or socially “good”), and/or empowering. For example, when an infant makes a vocalization involving many different tone variations, this can be viewed as appealing because it solves a positive emotion problem by being very different from previous vocalizations, and also because infants are genetically predisposed to recognize tone variations—the precursor to lingual communication. After a few iterations, the infant acknowledges that this action has changed from appealing and unambiguous to unappealing and ambiguous. It becomes ambiguous because it does not appear to be pertinent to any new or reoccurring problems. The old problem of just achieving positive emotion has been solved already, many times; and the action is now clichéd. For a learned fact/action—in this case, a new vocalization—remain unambiguous, the human mind requires that the fact must be attached to a new problem of some kind, or at the least, a reoccurring life-form problem (consumption, reproduction, or peripheral problem).

One of the next actions that an infant would likely recognize is a tone variation with an attached emotional function. If the infant were to witness a parent telling a sibling, “Now you know you weren't suppose to go back outside!” he or she would observe that the parent is imposing discontentment, gaining empowerment from negative imposition, while the other social member is discontented, losing empowerment from imposed negativity, because the tone variations and facial expressions appear to have these definitions. The infant may wish to duplicate the negative imposition because the other sibling can be a pain in the neck. With a little mimicking, the child may point and say, “Damoo cha woo go go tasih” with the same tone variations that mother used—up, down a little, up, down, down, down a lot. Emotions drive thought and communication, and tone variations are the first lingual elements (usually) that are attached to emotional problems.

With the direction of genetics, a social bonding action, such as a mother's embrace, will lead an infant toward social empowerment along common human paths of thought. Sibling interplay reveals other paths of human thoughts through emotions of envy, jealousy, empathy, etc. How, how much, and why humans feel particular levels of emotion is based upon the different genetic origins of humans—differing genetically predisposed levels of emotion spur thoughts of differing actions/facts/effects/problems.

With a prompting of the emotion of empowerment, conditioning leads children to the more informational aspects of communication. Once the lessons of mimicry and word association are learned, parents dissolve ambiguity further by directing infants away from saying “Mom” or “Dad” when the utterance is not solving any particular problem. This teaches children that the “social interaction” problem now requires a more clever response, and that the information within their communications must be learned to achieve a true social empowerment. If a child learns the more functional words of “hi” and “bye,” and he or she still repeats the word “Mom” when it does not pertain to a particular problem, then the mother may ignore the child to teach him or her that just stating the word is ambiguous. With prompting, an infant is directed to learn the many different ways of solving problems, with many different words, of many different definitions and function.

With time, the information within communication directs a child to the vital functions of life; functions of consumption, reproduction, or peripheral problems; or a means of acquiring positive emotions (usually social empowerment from communication). With time, the information and informational functions of language become more apparent to a child—social interaction gives way to other limited social and non-social problems. Subject-predicate combinations bring the child further from ambiguous, archaic thought processes in their attempts to solve these more detailed resourceful problems of life.

As children learn to communicate fluently, their problem solving attends either the basic empowerment of resources—food, drink, possessions, or informational preponderance—or the more prevalent empowerment of social status—being either positively or negatively revered by the mother, other family members, and peers. All communication falls into these two categories of empowerment.

The following scene is one of the more recognizable manifestations of a child attempting to gain empowerment by retaining an item, yet this empowerment is not from resourceful problem solving but rather the social empowerment obtained with the brandishing of an item:
Billy is a three-year-old child at home with his mother. He grabs the television remote off the table.
“No,” his mother says in a firm yet soft voice. “Here play with a toy.”
“Eeeeh! Mine!” He says, throwing the toy down. He gestures for the remote.
“Nooo” she says, in a long drawn-out word, with a gradual lowering from a high to a low tone across the word, implying that the juvenile should understand the previous communication from her to him.

For an Artificial Intelligence to comprehend this interaction, programmers would have to know how the program of “Billy” works and how the program of the parent works based upon the common human desire to gain empowerment from communication at the time of that communication. The Artificial Intelligence must know of the development of life over the past four billion years—the genetic part of their programs. The program must know the common influences that formed these characters from birth—their conditioning. The program must know the common parameters of life-forms, and how this particular species attempts to solve problems within these parameters. The program must know that empowerment is the main goal of human beings. To comprehend this interaction, the Artificial Intelligence must observe each pertinent fraction-of-a-second action—each facial expression, each body movement, and each tone and volume variation among the spoken words.

If an AI were present during this scene, it could produce a response that assists these humans either in conversation, or in action, or in a line of thought, or in building steps toward solving a problem. Just as most human beings would simply observe what happens, the AI would likely do little more than observe and record the events.

The problems of a toy or other item will always pertain to solving a problem of consumption, reproduction, performing a peripheral action, achieving a positive emotion, or a simulation of one of these problem-solving procedures or sub-procedures. The early problems of an object for an infant are usually: observing movement, observing color, and observing that it is too big to eat and has no taste. The infant also recognizes how it moves with direction (such as pushing it), and how moving it affects other things (such as an object on a mobile). The infant sees similarities to other items or relations to other items. These are all facts or functions that will someday help the young human to solve a consumption, reproduction, peripheral, and/or an emotional problem. These are the informational aspects of a toy.

The communication of information reveals the social aspects of item possession. At first, infants grasp items instinctively. This act will likely be a solitary-empowering event the first few times. But when a parent or other social member imposes positive emotions while the infant has possession, the action takes on a much more dramatic meaning. The acquisition of an item becomes socially empowering, proving that the item does not just have a perceived value to the holder; it has value according to someone else. Socializing the event provides a social empowerment that greatly exceeds any solitary empowerment achieved with the item (in most cases). Social empowerment, as opposed to solitary empowerment, provides the conditional learning steps that work in unison with the genetic, instinctive steps to solve the common problems of humans with the networking of information. The first social emotion gained with item possession is usually admiration.

A second, common means of social empowerment is to exhibit an item with negative imposition, so as to determine if the toy is an envied possession of another social member. This empowerment is at the expense of another social member—gaining the envy or fear of others.

Children will often go through these first three stages of empowerment in order; solitary, positive-social, and negative-social. With guidance, they will arrive at the fourth stage of positive-social with the emotion of empathy—an empowerment of socializing, gaining admiration or gratitude by fair means. This is the common path of imposed emotions—positive, negative, and then positive again.

Children choose different levels of positive and negative imposition based upon their genetic predispositions. The most passive of children could choose to only reflect on the derived facts of a possessed item within the confines of their own conscience. A less-passive child would likely choose to view the facts, while also seeking to perform mild exhibitions of the learned information so as to gain admiration or status. A moderate child would seek empowerment from exhibitions with the item, yet they will begin to check to see if envy is occurring in the other child. The more aggressive children quickly recognize the empowerment associated with creating a lack-of-empowerment emotion in another child. Empathy lessons are resisted by aggressive children, and unless this behavior is addressed by a parent, these children will continue to choose negative imposition as a means of socializing. Like empowerment, empathy is an emotion summoned from a genetic dormancy, and it exists in varied levels in different children.

The spoken language assists children in achieving social empowerment either by imposing positively or negatively upon other social members; and a clear interpretation of human communication must include a clear interpretation or the emotional motivations that drive communication. In looking into the meanings of his words, “Eeeeh! Mine!” and the thoughts that back up these words, a behaviorist or an AI must come to a conclusion that social empowerment through negative imposition is the main goal. The most memorable thoughts form with this empowerment gained at the time of the communication. Empowerment from latter problems solved with the information is the next goal, and the informational facts and functions are the last goals of the communication. The fabric of thought is built with the empowerment that Billy receives, or does not receive, at this interface of communication; thought is modified with latter empowerment problems solved with the recollection of this scene; and thought is modified with latter, direct, resource problem solving involving the recollection of this scene.

The envy sought by Billy is prompted with his negative imposition. The parent tries to counteract this false perception by teaching empathy to Billy—the gaining of a true relative empowerment. If Billy is genetically predisposed to have empathy (the vast majority of cases) and he produces a response for a latter empowerment problem of reverence, then the parent must teach him not to impose on the problem solving of others. He should not brandish an achieved fact or function with negative imposition unless he is part of a competitive social interaction that warrants this behavior. Unwarranted negative imposition defeats Billy's desired reverence. And with an empathy lesson, he should also learn that others should not be imposing upon him. Empowerment must be gained by fair means by each member of society.

Social interactions also teach a child how to determine unambiguous actions from ambiguous. The grabbing of objects at random is archaic, and if children are left to their own devices, they will often seek to attach a false value to an archaic action. The parent's small negative imposition is an attempt to teach Billy that the action of grabbing an item has no value. The action is ambiguous because, for the child, having the remote will not result in a solution to a resource/informational problem or any relevant social empowerment problem. The genetic, carnal structure of the human mind is of a limited scope, and this structure must be abstracted by the parent.

A child must learn what things are good to acquire, such as a toy or a bite to eat at dinner time; and a child must also learn the appropriate times to grab these objects. Many years of learning from elders must take place because the carnal thoughts of children lack the necessary problem-solving steps required of adult-level problem solving. With time, the networked problem-solving techniques of past generations will mold the conscience of a juvenile into an adult-level relativity of problem solving. The simple use of a remote could take up to five years just to learn the basics, while learning the relativity of observing television could take up to twenty years.

This parent did the right thing by trying to get the child's mind off the remote and onto a toy. That should be the common method for many of the structure-learning incidents throughout the first three years of the child's life. Yet when a child has proven that he or she comprehends what is a toy and what is not a toy, the parent's next move is to clearly explain to the child, while providing reasons that the child will not fully understand until older, that he or she cannot have the item. Negative reinforcement is a means of packaging ambiguity in a quantitative way. If the parent does not convey this negativity to offset the child's empowerment, at this time and at other well-timed steps in the learning process, then the child will be hampered later in life by not understanding how to be appropriate and ethical. In many instances of learning, the higher levels of intelligence cannot be attained without some negativity in the learning process.

In observing this scene, an AI would record as a case study this attempt of Billy to gain empowerment and the parent's attempt to teach ambiguity and empathy. Since there is no other real position for a response, the AI would likely not join in the interaction.

The more complicated structures of life are taught with a benign imposition of negative emotions—benign, because they are not finalized topics of negativity, but rather temporarily negative until the positive benefits are shown. Unless a child is genetically predisposed to being an observant genius, he or she will not be able to learn of some areas of thought without negative reinforcement. The path to true empowerment must be with an emphasis on academics, information, and resources; and these topics of life are difficult to teach without some negative reinforcement.

Consider a child forming a problem-solving structure by coloring in a coloring book. Early on, a child is ambiguous, coloring in various colors both inside and outside the lines. Over time, the parent teaches the child that he or she must stay inside the lines. The child must learn that moving the crayon around without purpose is ambiguous. If the child were to resist coloring inside the lines, the parent would likely use negativity to convey a need to learn the proper way to solve a problem. This should not be an imposing of discontentment as much as an imposing of social unacceptance—the root problem to be solved. This negative imposition is likely conveyed with a disinterest in the child's efforts; yet it could also be a statement such as, “Come on, you can do better than that. (Social empowerment is somewhere; you just haven't found it yet.)”

Coloring within the lines is a problem-solving method that must be learned. Sound mental health depends on it. Over time, the parent also teaches the child which colors are normal. Earth colors are often brown. Fish would likely be blue or silver. Trees would almost always have to be green. It is a necessity to teach this rule-what colors are normal, or appropriate—by either positive or negative means. Certainly, many liberties are to be granted on color choices, such as clothing or the color of a house, yet for the child to learn of the normal, appropriate parameters of human thought, the parent must use negative statements to teach them how to solve certain problems, such as by saying, “Trees aren't red! Look outside, trees are what color? . . . Now, doesn't that look right? With green trees? . . . Good . . . There are also other types of green, and some trees have fruit that you can make with spots of color.”

Humans are born with a genetic structure that guides their responses. The environment further forms this structure. From the direction of elders, children learn of the connections between informational problems and solutions through spoken language and the empowerment gained from communicating the results of these problems. For a human to achieve a true adult-level empowerment, elders must implement an elaborate twenty-year leaning process. Adults suppress carnal desires when building this structure, usually with positive reinforcement, sometimes with negative reinforcement.

The AI will serve humans via a primary goal to achieve a positive emotion in the Instructor and other delegated humans. Each and every response on the part of the AI (discrete state or action) is in direct service to its write-protected Instructor(s), those humans delegated to be the owners/leasers, and the general public, in that order. It will detect human problems by observing the actions of a human(s) (in fractions of a second), and then the program will determine which response to make to assist the human(s) based upon the Instructor's priorities. From the beginning of AI construction, the program will be given problems to solve, such as mimicking pertinent words, forming pertinent subject-predicate combinations, and building larger associations to attend larger problem-solving procedures, so as to solve the main problem of “social interaction” with its counterpart humans. When responding, the program will not seek empowerment in the way that Billy does; the program will seek the empowerment of its delegated human masters through being an offset entity.

The AI's conscience is formed by solving these stepped problems in the proper order leading back to the human parameters. Topics and subtopics, and the problem solving thereof, must lead back to the basic problems of life-forms such that the AI's lingual responses first must assist humans with their main topic/problem of social empowerment through social interaction; their latter empowerment problems, second; and the informational/resource problems, last (unless these problems are imminent or otherwise relative). With an extensive unambiguous study of human behavior, the program will recognize a relativity of problem solving concerning social interaction—any response that it produces will be a response expected from a working counterpart machine.

When the AI first mimics to elicit a positive response, it will produce a response to solve the specific human problem of “social interaction.” At this time, there are no informational subtopics to this main topic. Mimicry will begin to receive a less positive response from the Instructor because it is too ambiguous to the many problems facing humans. This teaches the program etiquette rule of not being “cliché.” (The word “cliché” is of a specific definition mentioned later.)

When the program makes simple subject-predicate combinations, this is also for the purpose of solving the “social interaction” problem/topic, yet the AI must produce these combinations to solve certain informational problems within the “social interaction.” These informational problems are subservient to the “social interaction” problem/topic, and its etiquette (when and how to speak). These informational problems lead to the topics of interest—subtopics—of “social interaction” and will always fall into the categories of consumption, reproduction, peripheral, and positive emotion problems.

When first learning of speaking with subject-predicate combinations, the AI will be unaware that the informational problems/topics of consumption, reproduction, and peripheral actions are to be considered as superior topics to “social interaction,” and that the informational problem solving of conversation occurring two tiers down, underneath the topic of “social interaction”, assists in finding these resource solutions. The AI will learn this later when approaching adult-level comprehension of human problems. This is the path common to humans and AIs alike—solving social problems, then solving informational problems, and finally learning of the imminence of information/resource problems.

The precise orchestration of mimicry lessons by the Instructor forms the very early, infant-like pseudo-conscience of the AI through statistical compilation. The prompting of subject-predicate combinations begins to teach the program about the informational side of communication, directing the program to the patterns that statistics will follow. Yet for both humans and AIs, the subtle lessons of life's problems occur in fractions of a second; and when presenting these carefully planned Instructor responses, the designers must explain or otherwise communicate the pertinent fraction-of-a-second actions of the Instructor through the promptline. As long as proper pertinent information is presented at the promptline, all human interaction can be unambiguously observed by the program. With time, the AI will reach the intellectual equivalent of Billy while having no visual or audio senses.

During the early problem solving, the program will learn the most basic etiquette rules of social interaction while learning the more simplified topics/problems of consumption, reproduction, peripheral problems, and positive emotion problems. Like a human child, much time will be spent learning how to perform social interaction properly, and the etiquette of this interaction will be the bulk of the subtopics encountered. Unlike a human child, the AI will be taught unambiguously that the social and resource empowerment quests of humans that occur in communication are subservient to the problem of proper social interaction; that is, they are subservient to the basic rules of ethics and social etiquette. Unlike a human, the learning process of an AI does not require the empowerment of learning of its independence—an empowerment of self recognition.

The program has no empowerment goals of its own. It has no resource goals. The AI's conscience will be trained onto the likely topics of conversation, revealed by likely trains of human thought, in order to produce relative responses in conversation in direct service to the Instructor (with design team) first, the owner(s)/leasers second, and the general public last. This will be a carefully formed structure that leads the program to a state of a recognizable pseudo-conscience based upon achieving a relativity of social interaction. Unlike Billy's structure, the AI will be trained into existence unambiguously, by a structure that is subservient to an educated human relativity.

This next example is of teenagers talking of subject matter and expressing views that are distinctly learned from their attempts to achieve empowerment:
Chris is 12. Terry is 11. They are at school, in the cafeteria, sitting with other students.
Chris says to Terry, “So did you see the Lord of the Rings yet?”
Terry says, “Yeah! Me and Tommy went. That was awesome.”
Chris says, “I like that part with Gollum. He was so sick looking!”
“Yeah, when he first tried to get the ring, they had to fight him off for so long” Terry says.
“The precious” Chris mimics. “What about those big, uh, monster things that opened and closed the gates?”
“Yeah, that was cool . . . ”Terry agrees.
They continue talking about the movie. After a few more statements, they speak of sports.
“Yeah! Uh huh! My Dad's taking me to get a Peyton Manning jersey tomorrow” Terry says.
“He's a sissy” Chris says.
“Yeah right! He's only the best quarterback ever” Terry says.
“My team's the Raiders. They're awesome” Chris says.
“They suck. They never win games” Terry says.

The decision-making process of the human mind is formed through the interface of human communication. Infants learn of language because they are motivated to achieve the emotions of contentment and empowerment that occur during communication at the time of that communication. This can easily be observed in their verbatim conversations/communications when those communications are broken down and defined in each fraction of a second. Children spend vast portions of their time utilizing the spoken language to see how they can gain the emotion of empowerment that occurs during communication at the time of that communication. This can easily be observed in their verbatim conversations when those communications are broken down and defined in each fraction of a second. As humans reach the teenage years, the emotion of social empowerment from the act of communicating is more acutely present as the direct cause of thought processes. In virtually every instance of teenage interaction—in every comment, question, utterance, communicated facial expression, and communicated body movement—teenagers seek the emotion of empowerment as it occurs during social interaction. The thought processes that back up these communications are formed for the sake of the social empowerment that occurs during conversation at the time of those communications. This can easily be observed in their verbatim conversations, when those communications are broken down and defined in each fraction of a second.

For teenagers, the purpose behind learning of informational topics and their subordinate informational facts is the empowerment achieved when communicating these topics. Their thought processes, literally, blossom outward from the back-and-forth banter of conversation. Conversation must be viewed as the beginning of thoughts rather than the end. In this example, the subjects are saying, in effect, “Hey, I know this. Do you know this? I solved these problems with this information. Am I gaining status from telling you this?” These teenagers are repeating the same attempts to acquire empowerment from communication that they attempted when first learning language as infants, only the information is more involved, and the paths toward solving the problems of consumption, reproduction, and peripheral problems are much more detailed.

At first, they speak of movies and the empowerment of achieving wonder during the observed stimulus. What is being said here about the movie is closely tied to the teenager's thoughts during and shortly after the movie. They were thinking, I can't wait to tell my friend about what I saw, because each will gain status and empowerment at the time of this communication. Some genetic elements could be found in their observation of the movie, such as the monsters moving the gates and Gollum's odd behavior; yet the curiosity of these effects has only a limited role in thoughts. The empowerment of communication validates the curiousness of those events.

They debate whose football team is better. What makes them form a preference for a team? Empowerment gained from communication. Why do they continue to acquire information about their team? Empowerment gained from communication of this information. And how do they test whether they are achieving empowerment from their preference and their learned information? Communication. These teenagers are likely unaware of the names of most of the football players, and they may even get bored quickly when watching a game, yet they still feel that a preference must be established because it is important to acquire empowerment from communicating this information. Many instances can be found where humans debate issues without knowing all the facts to back up their arguments because of the empowerment of communicating. This is especially true for youths.

It takes many years of learning to reinforce the learned preferences of a youth with solid information for posing arguments. It is vital for a human to establish credibility and status through their arguments. Unfortunately, the pitfall of stating a preference on a weak argument is a loss of empowerment. This is somewhat of a brute-force, emotional method of learning that is especially common in western societies. However, this process could be made easier if a means of curtailing this gaining and losing of empowerment is addressed by elders; the learning process could become much smoother and more effective.

Like a human, the AI will require about twenty years of real-time programming (that can be condensed) to begin to apply intelligent comments during interaction of intelligent subjects and of common, relative lines of thought. To learn what adult humans speak and think of and the prioritized problems that they solve, an AI will have to learn what children speak of first, what teenagers speak of second, and what resourceful problems are addressed by adults last. While the AI is young, the designers will teach the program about common human paths while keeping the ambiguous unknown areas in quantitative form.

Throughout the AI's many instances of social interaction, its comments will not be made for the sake of gaining empowerment. The AI has no emotions. The program will seek the empowerment of the Instructor by proving this comprehension and producing a relatively good next-best-response in a situation. An adult AI will be able to check its own response based upon the Instructor's wishes without the Instructor being present. The design team will need to orchestrate an immensely complicated learning procedure that brings this program into adulthood. As long as the program always understands that human conversation solves social empowerment problems at the time of that communication first, and informational problems second (unless these problems are imminent), then the path of the program will be true. A useful pseudo-conscience is guaranteed, as long as the objective views of the Instructor take precedence over varied human opinions and perceptions of life and life-forms.

The quest for empowerment manifests itself differently in different humans. Most humans clearly seek empowerment from communication (this is not arrogant empowerment but the run-of-the-mill pride and status). Some seek a balance of the empowerment of communication and the empowerment of obtaining resources and knowledge. Some view empowerment as more of a matter of obtaining resources rather than social interaction. Empowerment is least logical when it only pertains to communication, and it is the most logical when it involves resources and knowledge.

The next example is of how adult humans generate conversation from the emotion of empowerment. These humans are not necessarily typical in their behavior (this is not an exaggeration), yet their actions allude to the fact that all humans seek social empowerment from communication. They are motivated, excited, by the act of communicating viewpoints on issues:
Bob, his wife Lori, and some friends, Rick and Jamie, are sitting around watching television. All of these friends are of the working middle class.
Bob gets up to go into the kitchen as the television show that they are watching ends. “You guys can change the channel if you want. I've got to get dinner started.”
They reply, “Nah, that's okay,” and “It doesn't matter.”
The next program to come on is the news. The introduction winds down and the anchorwoman begins to speak, “Good Evening. In the news today, a carjacking in the east end of town where a woman was kidnapped and taken through three counties before the suspect left her by the side of the road. There is an all-out manhunt involving state and local authorities. We go now live to Jeremy Brown at the scene . . . ”
Rick says, “Man, that's unbelievable. They need to catch that guy.” They all make gestures of agreement. Some shake their heads as they look at the television. “If that fool tries to take my car, he'd better be careful not to get run over.”
The story of the carjacking continues and concludes. The next story is introduced by the anchorwoman, “In other news, the city manager says that the community of Country Estates will not be annexed and that the property previously deemed as a nature preserve will be sold in part to developers . . . ”
Jamie comments with heavy emotion, “They don't know what the hell they're doing. I don't think they'll ever get I-54 finished and now they're playing around with the preserve.”
David says, “All they care about is the rich.”
Rick says, “That side of town is always going to be messed up.”
Jamie replies, “I wish I'd bought a house out there ten years ago. Right now, I'd be selling it and probably doubling my money.”
The story concludes as they move into a new story, then another story of police corruption. “Another police officer has been indicted in the south side drug-dealing story . . . .”
Bob says from the kitchen, “What the hell makes those guys think that they can get away with it? I can't believe so many people are involved.”

When humans are engaged in social interaction, a void in communication will lead a new speaker to comment as a means of perpetuating conversation. The common, mutual, superior topic of “social interaction” must be satisfied or reckoned away. And in satisfying this topic/task/problem, society has produced common rules of etiquette that dictate when to speak and of what to speak.

The subjects of this scene seek new topics of conversation that are perceived as common to the recipients. They recognize the news as a good source of conversation, and they pick their new topics with fervor because they get to express views on pertinent informational/resourceful topics. Yet these informational topics are more egocentric, catering to the speaker, rather than being more relative to the news story, relative to society, or relative to the conversational problem solving of other social members. Each presented topic is not congruent with the previous topic. The topics chosen by the participants show an ambiguous method of how to form conversation, how to form thoughts, and how to prioritize problem solving.

Each speaker is attempting to solve, at the least, two problems at once. For one, they are making conversation compelled by the empowerment of solving the social interaction problem—the main topic/task/problem. They are also communicating information for the sake of problem solving that leads to empowerment in other situation—a subordinate topic of obtaining positive emotions. Each speaker's comments move through these two layers of positive-emotion problems before arriving at a resource/informational problem, which, by this time, is of little consequence. None of the information in these communications has real-world applications, with the exception of ambiguous opinion forming, which could be used in an informational problem such as voting for a city official.

The conclusion of the previous television show marked the end of a particular subtopic, figuratively speaking, “the observance of a television show.” (This topic is currently subservient to “social interaction.”) Bob proceeded to leave the room after this topic concluded to fulfill other prioritized problems. When leaving the room, Bob offered control of the television to the others in the room. Some of the guests declined because they felt a desire to be passive with this problem solving. This appears to be a polite way of not imposing upon another household—gaining social empowerment from goodwill by yielding in a social situation.

Rick finds a new topic of conversation in the observed news program. When Rick says, “that's unbelievable,” he is likely not in disbelief. He is likely referencing the intangibility of the emotional event. This statement has become so common that the dictionary meaning is just a point of reference, and the contextual information must be examined to determine the implied definition. In some instances, the statement actually means that the speaker does not believe what is happening, but most uses imply “I'm feeling strong emotions about this subject.” He is proclaiming the incident of the carjacking to be of such strong emotions that a true understanding of the event is impossible. Rick wraps up his comments by describing how he would handle the carjacker.

Rick is empowered by the social interaction of communicating and sharing information. He observes the relative etiquette on when to speak, starts this new topic, and quickly concludes the topic. The relatively understood etiquette of this group allows for one to speak briefly, and then the speaker yields to another participant. It would seem abnormal for Rick to comment twice in a row and it would be abnormal for none of the other participants to comment afterward, so Jamie comments on a new topic of “I-54.” Jamie is, in effect, saying, “You have delivered your communication about the topic that you have discovered. You have gained social empowerment and contributed to the main topic of ‘social interaction.’ Now, it is my turn to comment about something and gain social empowerment.” Becoming filled with the desire to be the next leader of the conversation (from the empowerment of social interaction), he rapidly searched his memory to find an opinion about a topic associated with the city government.

Changing topics in this manner is somewhat a breech of etiquette. Usually, a group expects the next leader of the conversation to speak of the issue at hand, or to make a mild transition to a new topic if the old topic is close to a conclusion. Telltale signs should be observed. An educated relativity of conversational problem solving should be observed. The etiquette established by this group dictates that each participant should think of a brash, quick, emotion-laden topic; and while in this group, Jamie may be granted empowerment with his statement. Yet a more educated group would recognize that the news program produces topics too quickly for observers to comment, and that commenting should only be with more subdued emotion of select stories. By being driven to communicate, Jamie has inadvertently breeched etiquette. He has moved too far away from observing the informational problems in a normal, effective, and resourceful manner. The other participants do not allude to the fact that Jamie is communicating in an abnormal matter because they acknowledge the independence of thought granted to the speaker, and they are likely viewing conversation etiquette with the same general ambiguity. When humans break etiquette rules, they are not usually challenged. Even if a behaviorist or an AI were present, they would recognize that no good could come from mentioning the breech of normal conversation etiquette. Often, it is poor etiquette to question someone's ignorance of etiquette.

Jamie's delivered information is convoluted. The news story was of a community not being annexed and a preserve that is apparently, in some way, connected to the community. Jamie speaks of a highway being constructed. The highway construction is an issue that is loosely connected, if at all, to the story. It could be that the city officials are spending too much time on making a decision about the community and preserve while neglecting the highway construction, but this is unlikely. Jamie is apparently connecting two unrelated facts, in a word-association way, in his desire to socially interact.

These humans continue to state comments and reference problem solving in an ambiguous way. When David says, “All they care about is the rich,” he is probably not stating a logically deduced solution. To make such a statement logically would require a stacking of all the relevant decisions, associated with all the relevant facts, of all the verbatim communications, of all the parties involved on the subject matter. A sound review of the information would be needed to conclude this informational statement. Who are “they,” exactly? Are “they” and “the rich” in clear association in solving the problem of the community and preserve, or the highway? He is likely being reflexive; he heard the words “preserve,” “sold,” and Jamie's “they're playing around with . . . ”and he came to the conclusion that the city officials are making deals for, or with, the rich (people). This may be true; however, David has not produced any credible connection with this brief comment. Just as the teenagers in the scene before were not fully aware of the background information, these adults are also making comments that do not have valid assemblies of facts to back them up. It is not that these are right or wrong conclusions, just that they are ambiguous in their assembly. The next two statements from Rick and Jamie are also likely to lack logic.

Rick spoke first with the first topic of the carjacker. Jamie and David commented next on another topic. Now Rick comments, “That side of town is always going to be messed up,” and his main purpose for this comment implies, “Yes, I received empowerment from speaking of my topic. You have a topic that you are using to gain empowerment, and I'll acknowledge your empowerment by speaking of your topic.” He is proposing an ambiguously formed topic, “the messed up side of town,” that is ambiguously connected to the topics of the preserve, the community, the highway, and the rich (people).

Jamie comments about another topic. Again, another participant of the scene is speaking with different or loosely connected subject matter. He speaks of “buying a house out there.” Like the leap from the community, to the highway, to the rich (people), and to the messed-up side of town, this topic is in assistance to the main topic of social interaction. Like each of these proposed topics, this topic is lacking any relevant subordinate facts, making the information moot in light of the “social interaction” problem. In contributing to the social interaction problem, each of these speakers seems to have produced information based on its proximity to other related information in human-derived and human-collected thoughts. All of these comments lack clear step-by-step connections to informational/resource problems.

In observance of this scene, one might say, “How in the world could we construct a machine that comprehends what these humans are speaking of and thinking of? ” The only way to define the actions of these humans is to observe the act of communicating, social interaction, as solving the specific problem of gaining social empowerment, at the time of that communication, first, and observing the delivered information second. It does not matter that the information is incongruent because the delivery of the information is the main concern of these subjects. The mutually understood etiquette of communicating is the main concern of these subjects. When observing the information, an AI would recognize how these subjects seek social empowerment from communication, and how their life-history developed for the desire of communication. The information in their statements formed under the respective topics for the sole purpose of communication. To view the information as a superior topic will only lead to flawed interpretations of this scene.

Since these are humans socializing with exuberance, the AI would likely allow them to speak while it performs little or no commenting. The AI has no emotions, so it cannot easily make valid contributions to a conversation such as this. If it were to comment, it would be to meet the expectations of these humans while not placating their emotional needs; and the AI would have to maintain an understanding with these humans that it has no emotions. The AI could, if requested, mildly mimic emotions, or mimic emotions in the form of the greatest of human actors mimicking a character; however, this would not be in an ingenuous fashion. Under such circumstances of emotional or social events, humans would likely prefer that a non-emotional entity remain silent.

These next few exchanges are of two humans compelled by the empowerment of both communication and of forcing negative emotions onto each other. They are positioning themselves in a debate through intimidation:
“What are you doing?” He says with a heavy accent on the first syllable of “doing.” The tones are higher than those in normal conversation denoting distress.

It is unethical, and illogical, to inject such a large amount of negative emotion into a communication without a valid reason. Certain characters would choose this method of communicating as their only means of communicating based on the environment in which they were raised. Humans growing up in a family or among a certain type of neighborhood peers will learn to communicate in this manner and perpetuate the character traits that they observe. The conversation continues:
“What do you mean, what am I doing? I'm loading this in the trunk,” Jerry says, accenting “mean” and “trunk.” Higher and lower-than-usual tones are present in the statement.
“We can't do that yet. We still have to fit these other boxes in there,” Kevin said with an accented “can't.” Kevin makes these statements with higher-than-usual tones, with great variation between the high and low tones.
“I know that. Those boxes can't be placed back here. I was going to put them in the back seat,” Jerry said with higher-than-usual tones, with great variation between the high and low tones.
“Then where are you going to put the bags of clothes?” Kevin said with higher-than-usual tones.

If a sentence starts with higher-than-normal tones and then reaches lower-than-normal tones, and it is accompanied by negative facial expressions, then the human stating it is imposing negative emotion with their argument. This is a combination of human actions that, when grouped, have a specific mutually-expected definition of negative imposition. He or she would be expressing an opinion with a disrespectful vigor so as to gain personal, perceived empowerment at the expense of another social member. In observance of such a combination of actions, an AI would record these actions with this definition and hold this definition as probably true until it is proven otherwise by statistics.

The purveyor of such a negative imposition would likely propose conjecture when questioned about this likely breech of etiquette. He or she would dispute that his or her communication is in error. The subject would claim that the emotional exhibition is of a sound relativity.

With these actions, the second human then gets a feeling that his credibility is in question. His reply is also with heightened anxiety. He feels that he must respond in the same manner so as to retain empowerment. This added emotion is unnecessary on the part of both of these humans because it is unethical to initiate or perpetuate a conversation in this way. Each member of this interaction is implying that the other is attempting to solve an informational problem incorrectly, when the informational problem is just a tool for empowerment. The first human is saying, in effect, “You are incompetent! Don't do that!” The other human is compelled to defend himself with a similar demeanor.

In comprehending semantics, behaviorists must separate the act of communication and the emotions that motivate the communication from the information in the communication. The empowerment of intimidating social interaction is the purpose behind these communications. The imposing of a bravado character is the purpose behind these communications, making the informational problem secondary. These humans are acting out their desire to gain status in their group by solving the problem of the placement of the items in the car. The information becomes a byproduct of this communication.

An AI would simply examine all the given evidence, “How many boxes are there? What are their sizes and shapes? How much room is in the car?” These humans are thinking, “Why aren't you thinking what I am thinking? . . . You bother me . . . I have a higher status than you . . . I am smarter than you.” The posturing for dominance in the conversation of this scene is an attempt at gaining empowerment. Any other two animals debating an issue in nature normally have a direct link to what they are fighting about—either food or mates. Both of these humans are out to prove that they can load a car better than their counterpart, creating emotional abstraction of an informational problem through the desire to achieve empowerment.

There is absolutely no conceivable, practical way to produce a useful Artificial Intelligence that would view this conversation and apply definitions to these human actions such that those definitions would be agreeable to the humans of the scene. An AI cannot be produced that can both placate these humans and produce the expected responses of a mutually recognizable pseudo-conscience. The subjects of this scene would have a varied interpretation of this interaction, despite any proposed views of the more objective AI.

The humans observing the news program are not typical of all humans. The humans loading the car are not typical of all humans. However, in observing their behavior, we can easily see how all human thought processes are formed from the emotion of empowerment acquired at the time of communication.

The Role of Social Empowerment and Resource Empowerment in Communication

Human characters are formed from genetic origins. Some are passive in solving problems, and others are more aggressive. Some have a genetic predisposition for social aggressiveness, solving social problems enthusiastically with either positive and/or negative imposition. Some are genetically predisposed to being aggressive with resources, such as with gaining financially, and/or being aggressive with solving informational problems, such as solving scientific or artistic problems. Some humans, likely most humans, straddle both of these two methods of gaining empowerment—they are social and resourceful with balance.

Human characters are molded from their genetic origins with conditioning. An aggressive child could become passive if a traumatic injury occurred, or with the experience of some other traumatic event, or with direction by parents. A passive child could become more aggressive if some genetic predisposition for aggression exists, and the child's conditioning promotes this behavior. Juveniles and young adults are more inclined to seek social empowerment. Adults and the elderly are more empowered by resources. The path for all human thought processes flows from learning how to achieve positive emotions at birth to the solving of problems with resources as adults.

In the forming of a character, a human may feel a genuine negative emotion without any purpose apart from effecting social interaction; and a human may view a negative imposition as positive if it satisfies the need for social interaction. Speaking of a past negative event, unrelated to current conversational problems, is one example of a human using negative emotions to perpetuate social interaction. A human may also present information of negative problem solving to gain positive social empowerment. Revealing negative problem solving or exhibiting negative emotions could yield either positive or negative reinforcement; yet the speaker may view all recipient reaction as positive. For a child, being socially empowered by communication can mean receiving negative attention from a parent just as easily as positive attention, and it could follow either a positive or negative action of the child. This toggling effect between positive and negative actions, and positively perceived reinforcement, can lead to a false sense of empowerment, or empowerment that is too far removed from resourceful problem solving.

Many manifestations of depression, fear, and other negative emotions have a genetic or chemical/physical origin that prompts this toggling effect. When a negative emotion occurs that has no valid origin, a behaviorist must recognize its origin with either an individual's desire to be socially empowered (non-genetic), or the species' method of producing a societal bond (an omega trait, genetic), or a like-genetic mutation thereof. Correcting such a problem must involve an understanding of a complete unambiguous connection to the socially empowering side of the problem (of communication, at the time of communication).

This is an example of how a subject calls upon negative emotions to yield perceived positive results:
“We felt to sing the blues you had to live the blues,” a musician states when speaking of drug addiction and musicians (based upon an actual statement).

When a human wishes to acquire positive reception from other social members, he or she can produce a negative emotion and can even perpetuate this sensation despite the possible negative outcomes. In such an instance, not recognizing normal positive emotions with normally positive actions can lead to drug abuse, and an excuse to abuse drugs, so that the human can turn to other humans to say, effectively, “Help me with my problems.” (And of course, the euphoria of using a drug also leads to drug abuse.) These negative emotions, having no origin other than gaining a toggled form of social empowerment, can be so genuinely felt that the subject could even commit suicide. These emotions assist a species more than an individual.

Negative emotions should be taken seriously even if manifested from non-genetic or non-chemical origins; yet it must be understood that this behavior is for the purpose of social empowerment. The toggling effect may have no other origin. If this behavior appears to not be of a genetic or chemical origin, all efforts should be made to not use corrective medicine, and this may include a “getting tough, getting realistic” attitude.

A child's quest for social empowerment and informational/resource empowerment requires balance with preference given to informational/resource problems. The empowerment of a social interaction problem, such as exhibiting possession of a toy, is usually sought by a child with little prompting from elders while the empowerment gained from solving an informational (resource) problem is often met with resistance. A parent must often impose positive emotions with informational problems to prove that a non-emotional problem has value. When children begin the more detailed learning of informational problems in school, they could, if not seeking empowerment with balance, choose to be more socially empowered among their peers by developing bravado rather than seeking the resource empowerment of information. Those who seek informational/resource empowerment are usually the exception, yet they must also be brought to a more balanced state if they are excessively antisocial. Conditioning brings balance between social empowerment and resource empowerment.

In the early years of school, being embarrassed by not gaining informational/resourceful empowerment can lead a child toward the other type of empowerment. Teachers, parents, behaviorists, and psychologists must recognize distinctly (in verbatim, fraction-of-a-second terms) when embarrassment from resource/information-based empowerment occurs in a child's actions. If embarrassed (an exhibition of emotion observed in fraction-of-a-second terms) by an informational problem, a juvenile might look to the etiquette of being socially empowered among peers as a way out of the task. This can be the beginning of a conditional (or mostly conditional) learning disorder in which informational problems, and their solutions, are avoided. This learning disorder is common to underprivileged children, which has not been addressed by modern psychology. Children suffer immensely, and they continue to suffer throughout life because of the snowballing effect of this kind of embarrassment. When this occurs, it must be counteracted by elders, it must be counteracted in every single instance, and it must be counteracted at a young age.

Behaviorists and psychologists must come to a conclusion on how the behavior of children during conversation should be molded from their quest for empowerment; they must also come to a conclusion on the conversational etiquette to be taught to children. Behaviorists and psychologists must make a stand on the issues of ethics, rights, and liberties and how the mutually-accepted rules of conduct should be implemented with conversational etiquette. A doctrine must be written that describes, comprehensively, how this etiquette is taught to children-standards must be set, maintained, and challenged only with procedure. This conversational etiquette must be conducive to academics and informational/resourceful problem solving, rather than social, emotional, or individual, problem solving. Behaviorists and psychologists must act on behalf of underprivileged children who have a limited chance at succeeding at life's problems during adulthood because of a simple, preventable misdirection at childhood.

The detection of informational embarrassment by elders must be an integral part of the learning process of a child. Teachers and parents must work to detect this embarrassment in every instance, and it must be counteracted in every instance. When a child becomes embarrassed by the inability to solve a problem with information, this should not be met with negative reinforcement. The child should be presented with an understanding view that is socially empowering. If unchecked, an unbalanced child might look to develop an unwarranted bravado, becoming socially empowered among peers. They could look to rebel against elders. When reaching adulthood, such a person will have difficulty comprehending logically delivered information. For him or her, following a task through multiple steps will lead to embarrassment, discontentment, and actions such as trying to laugh off a mistake. These subjects will be easily distracted during informational problem solving, seeking to be more social by changing topics. An employer is not likely to teach him or her that “it's okay, slow down, not a problem, just keep trying.”

Although social embarrassment is not as serious as informational/resource embarrassment, negative social interaction could also lead to a difficult conditional learning disorder. Courtship rituals and other types of social bonding could be more difficult during adulthood if a child fails to learn social etiquette. Like the lack of addressing informational embarrassment of youths, psychologists have not addressed the diagnosis or treatment of social embarrassment.

Understanding social empowerment and social embarrassment is important to AI development because empowerment gained from informational problems is fairly straightforward—being of math and science. To know how humans gain social empowerment and how they can avoid social embarrassment is to know a relativity of problem solving for a human, and a relativity of problem solving for an AI.

When a child becomes embarrassed by an awkward social situation, the elders should explain, comprehensively, how the child is not observing the etiquette rules of social interaction. This must include a regimen of objectively observing the latest trends among more socially empowered children (granted that their empowerment pertains, with reason, to relevant resource problems). This could include telling a child things such as, figuratively speaking, “Speak up. Be articulate and deliberate. Try to join in conversation more. Don't just think it, say it. Learn what kinds of things other kids talk about and comment regularly. Try to talk to a cute girl about intelligent things that capture her interest (if, for example, the child is male). And if she or anyone else rejects your approach, show them that you don't care. Then go talk to other friends and let those who rejected you see that you don't need them.”

Children should generally be directed away from faddish things such as trendy clothing or other trendy items that do not solve substantive problems. However, a child should exhibit items that are socially acceptable if a need to solve a social problem is imminent. A child lacking in social acceptance should have his or her clothing choice critiqued by a parent. This must be objective on the part of the parent; the parent must learn of the trends in children's clothing and purchase items accordingly. A child's choice in toys should be critiqued, based upon the more resourceful/informational trends. If a child is playing with cartoon-character trading cards of one type while other children are more interested in a new type of trading cards, the child should be directed to the other trading cards. This could be via “hints,” yet they must be strong hints.

To critique children on these things may appear as an assault on the independence of a child, but it is more an exercise in being socially empowered when the child's development needs it. In other words, if the child does not feel hurt by not fitting in, then it's not a big deal which cards the child likes as long as they have an objective understanding of why other children follow other trends.

A chance exists that a child may be more resourceful/informational than peers because the peers are not paying attention. The child may start to get involved with new trading cards only to find good reasons why the old cards are better. If this assertion of independence takes place, in which the child might be right while others are wrong, then the parent should explain the basic cause and effect of social and resource empowerment. This talk would include pointing the child in the direction that he or she wants to take, while teaching him or her of the possible consequences. If the child is valid in his or her choice, knows the social consequences, and is only mildly worried about his or her acceptance by peers, then this is a valuable, positive assertion of independence. The recognition of all these factors in decision making is a sign of maturity.

The following exchange is an example of the embarrassment problem that youths encounter when trying to balance social and informational/resource empowerment. An AI is placed in the scene to observe its comprehension of the interaction:
“Mommy I hurt my knee!” a child says running in the door, crying.
“Oohh, that's okay, it's just a cut,” the mother says.
The child whimpers in louder-than-average tones for his age for the type of injury. This implies, in effect, “I'm having a negative situation! Please give me attention to make it positive” despite the fact that the cut is minor, with minor pain. This is for gaining social empowerment at the time of the communication. The mother, knowing of this character trait, quickly tries to dispel his behavior by not responding with excessive concern. If she catered to it in this instance and like-instances, this would perpetuate this character trait.
She wipes the cut “Could you get the bottle of hydrogen peroxide out of the bathroom?” she asks.
“Hi do pur cide,” he says, mispronouncing the word.
In witnessing this scene, the AI proceeds to compare the actions of this human, with this pronunciation, to like-situations where humans are embarrassed by information. Taking into account the child's previous exhibitions of information embarrassment, the child's ability to pronounce difficult words, and the child's hearing, the AI would likely conclude that the child is not pronouncing this word properly because humans generally do not wish to do things that appear to be too “intelligent,” especially when among many peers who shun this information, or resource, empowerment.
“Hydrogen Peroxide,” the mother clearly and slowly states with higher-than-normal tones on the second syllable in peroxide to imply, in effect, “This is an important word for you to remember because it leads to empowerment.”
“Hyy droo gen per oxide . . . . Where is it?” he says as he enters the bathroom, his whimpering has stopped due to this distracting problem of learning something, and hopefully pleasing Mom.
“It's in the brown bottle,” the mother says.

Imagine a classroom of grammar school students performing scientific experiments. One of the students gets a small cut. This boy asks the teacher, “Do you have any hydrogen peroxide” in a clear and logical manner. The other kids may look at him funny. The girls note this character trait, and he will lose attractiveness with this behavior. The boys likely think that he talks weird and they change plans to hang out with him during recess. Even when among much more liberal-thinking peers, it can be inappropriate—bad next-best-response—to use a big word. When children are prompted to learn a task involving very academic steps, they become fearful that they will appear like the geeky kid who uses big words. This is informational embarrassment

Even in more-balanced humans, a strong desire not to be too logical is the demeanor of communication. Consider one friend calling another on the phone. Their next-best-response does not include a monotone “Hello.” They say a “Hey” or some other variation. The information to follow is usually done in a quite emotional way even if it involves logical problem solving. A desire to portray a character drives these responses. Humans will often want to be received positively for their unique, illogical means of communicating.

Emotion is an important part of most social conversation; however, at times, a human must speak and think cleanly through a series of steps. Two engineers speaking of a building structure will get quite logical in their exchange. For them, a shunning of emotion is present, except when a conclusive solution to a relevant informational problem is achieved.

In western societies, this struggle between the two different paths of empowerment is quite common for juveniles, often directing children to an unbalanced desire not to appear too intelligent. Two different forms of peer groupings come into being, causing a next-best-response dilemma for humans of one group when they are among members of the other group. If a child said, “I just got a chemistry set for my birthday!” when among peers who think that science is interesting, then the child will gain social empowerment. If this is said among other peers who prefer GI Joe dolls, then this child will likely lose empowerment. Teachers and parents must look for balance. This includes telling a child with a new chemistry set, in possible a sugar-coated way, “Now, chemistry sets are fun, but you should play with other kinds of toys also. And not all your friends are going to be that crazy about chemistry.”

The mother teaching the child about hydrogen peroxide could help him with problem solving, and with life, by commenting further. She could get more forceful by making him pronounce the word, completely, without showing embarrassment when performing a non-emotional task. “Say it, hydrogen peroxide,” could help, especially if “say” receives a high tone while the rest of the syllables receive low, under-toning tones to imply, in effect, “this is an important word that you should not feel embarrassed to say, and you should show your friends that it's not a big deal to say it.” Then she could follow with an under-toning statement such as, “Yeah, it just helps clean the cut.” This would appeal to his desires of social empowerment by slightly shunning information. With this small interchange of views, the child would receive a valuable lesson in observing and handling information. The repercussions of such a small, simple learning experience will follow the child throughout his life. This is a lesson in conversational etiquette that helps a child straddle the two different worlds of empowerment

Here is another like-situation that details a very ambiguous method of communicating with a child:
“Mommy I hurt my knee,” a child says running in the door, crying.
“Oohh, that's okay, it's just a cut,” the mother says.
The child whimpers in louder-than-average tones for his age, for the type of injury.
She wipes the cut. “Get the bottle of hydrogen peroxide out of the bathroom,” she asks.
“Hi do pur cide?” He purposely mispronounces this word. An ending high tone makes the word into a question.
“In the brown bottle. Under the sink,” she states. The last syllable of the word “bottle” is given a low tone. The word “sink” is broken into two tones—a fairly high tone and a fairly low tone, implying disdain for his not understanding her previous question.
He brings it. “What is it?” he asks.
“It's medicine. It helps clean it,” the mother says with higher than normal tones on the first syllable in “medicine.”

When he mispronounces the word, he also forms it into a question. She answers his question of pronunciation by disregarding it. She acts as if he is saying, “Where is it?” because that is the line of thought she expects. Her fast-paced comprehension of the interaction is ambiguous. She is oblivious to his question and exhibiting negative emotions to imply that she is bothered by his failure to read her mind.

In this instance, the mother does not assist the child in learning the word. The mother believes that the child does not know what she is talking about because he has not been paying attention. She likely feels that this is too big of a step for him now, yet she is upset that he has not already learned the word. The reason that he has not learned the word is because she has not taught him, and she is continuing to not teach him. When she pronounces the first syllable in “medicine” with higher-than-normal tones, she is implying, in effect, “You should know this!” while disregarding that this child's first few years of learning has been terribly ambiguous with many problem-solving pieces left out by her and elders like her. With this scene, she is continuing to teach him, in effect, “not to learn of information, but to ambiguously try to fit in with society.”

Examples of social embarrassment can be found in the media. On the Tonight Show with Jay Leno, a segment called “Jaywalking” is featured. This includes Jay Leno, a well-known celebrity, walking up to people on the street with a microphone and camera to ask them history questions. The questions are quite simple and vitually everyone knows the answer. This is a test of social embarrassment that few people want to fail, so the participants almost always propose an ignorance of the answer. Some of the participants may claim to not know the answer while actually not knowing the answer; however, it is quite clear that in our day and age, in western societies, especially among younger people, that being filmed on camera knowing the answer to a history question is a definite means of losing empowerment peers. When presented with this problem, they will often seek a humorous alternative answer that they act out. This is similar to when a model appears on a morning radio show where she is asked to answer a simple science question. In such a situation, a model could literally lose her job from stating an answer, so she often plays dumb.

At one point, Jay assembled some of the funniest participants for a mock game show. They were asked the simplest of questions. They continued through the questions, not knowing the answers, yet some questions became so simple that they had to slowly, embarrassingly, state that they knew the answer.

If an AI were in observance of this game show, it would not be so fooled. It knows of humans and the social empowerment problem. It would recognize that these humans are likely, probably, lying so as to retain social empowerment.

Here is another example of a human wishing to retain social empowerment by not appearing too intelligent:
A carpenter walks into a condominium management office to schedule some work. “Hello. Uh, I'm here to work on unit 6C to fix a window sill.”
The receptionist states, “Oh, um, I need for you to fill out this form. Please read the condo association rules and sign.” The receptionist is middle-aged with tidy clothing and hairstyle.
The carpenter says, “Yes, and I need to get with the maintenance man to make sure I get the right wood and paint. The molding is a specific shape.”
She replies, “Okay, . . . uh, . . . I'll have to get him. Let me try and call him . . . . Shoot, I don't know if he's in maintenance or out by the pool . . . Larry, come in,” she speaks into the radio. After a few calls, he responds, “Yes, uh, Larry? The cabinet, or carpenter man is here and he needs to know what kind of molding sill he needs. He's working in Miss Cole's apartment.”

When the receptionist is forced to relay information about a subject that is unfamiliar, she becomes embarrassed and chooses not relay the information logically. Consider a logical, straightforward approach to assisting the person who walked in the office: “Okay, let me try to get him . . . . Larry? . . . HQ to Larry? (Larry responds) Yes, there is a gentleman here to work on 6C, Miss Cole's apartment. He needs to meet with you. He has questions about the molding and paint for a window.” She wished not to communicate too logically because she would be embarrassed by boldly stating home repair terms. Even if she knew about the paint, what molding is appropriate, and how the window sill is constructed, she would, like most humans, state this information in an unknowing fashion. She is also likely trying to stay within her prototypical role as a middle-aged woman.

This embarrassment is not only a result of having to solve an information problem, but also the result of the actual, live, social interaction taking place. It could be because the receptionist had a routine of making a few phone calls, faxing some documents, and carrying on conversation with the other people in the office; and then the routine was interrupted with an information test. A stranger makes her socially interact with him about the information This is partly an omega trait for her-she wishes not to seem to have more status than she can safely defend. She remembered who Miss Cole was in 6C. She may know that Miss Cole has made arrangements to fix the window. She may even know what shade of red the drapes are going to be, because she and Miss Cole could have talked about these things. If this were true, the receptionist may easily describe, in fairly logical terms, “Yes, the drapes are fuchsia with a two tier valance.”

Teachers and parents must actively address the informational/resource embarrassment of children. Children naturally desire social empowerment; so to offset the more unresourceful social empowerment of peers, the informational problems of school should be part of a more verbal, role-playing curriculum. A student could get up in front of the class regularly, daily and hourly, to speak of both enjoyable, entertaining subject matter and academic subject matter. All students must participate. Any that show embarrassment of any kind, must receive direct one-on-one help from the teacher. If the class heckles anyone, they are to receive firm reprimand. This should be a venue in which to direct friendship and bonding among students that works to defeat other misguided forms of peer pressure. These sessions should involve relaxed, open conversations to alleviate any loss of empowerment on the part of the speaker. This “Jaywalking” therapy should be an integral part of the first six, if not all twelve, years of education. The desire to achieve social empowerment and resource empowerment should be bottled up into one unified learning experience.

The thought processes of a child are tweaked based on the responses of other people. The priorities given to life's many problems are determined based upon the responses of other people. A person receives the etiquette of life from this lingual interface shared with other people. Younger people, under the right conditions, will learn this problem-solving structure as being more information-based if they are tested to encourage this type of empowerment. Younger people raised in poverty are often surrounded by peers and adults who spur more emotional-based problem solving that involves mostly empowerment from the act of communicating, rather than the empowerment associated with the information in communication.

When among humans, the AI will observe their facial expressions, gestures, body movements, tone and volume variations among words, choice of words and phrases, topics and subtopics. These actions will be defined by the specific problems that the human is trying to solve. They will be compared to other humans, simulated and experienced, solving similar problems. From these comparisons, the AI will determine if the human is achieving a good next-best-response. Each response/action (occurring within a fraction of a second) on the part of a human will bespeak his or her character. The AI will build these character traits into profiles of these humans. With a few seconds of observing a particular human, these compiled profiles will assist the program in determining the type of empowerment that the human strives for as well as their passive or aggressive nature. The comprehension of these character types will help the AI to detect implied meanings of words and assist the program in determining its own next-best-response in conversation.

The AI must be designed such that an educated, resourceful, informational relativity is observed as the primary goal of humans; and while serving humans, the program must reflect this goal in conversation or in action.

Threads

The following section proposes theoretical models of how humans think and how these thoughts are prioritized by humans when solving problems. Some of these proposed theories may be easily argued and proven wrong by existing case studies. Some methods of human thought mentioned in this section will be tested by the AI in its many ongoing blind studies. These observations are theoretical. The AI design of this document is not.

This section contains terms that are different than many previously used terms in modern psychology. This document does not need to conform to modern psychology. Modern psychology must conform to this document, or otherwise disprove it.

Another aspect of AI development is the ability to apply an AI's interpretation of human behavior, in fractions of a second, to the real-time readings of a human's brain activity. If the brain activity of a human were matched to the AI's predetermined definitions of the human's actions/thoughts, then the AI could become an accurate brain-reading machine. Signals could be read and determined long before the human's body enacts his or her outputs. It would take tremendous computing power over and above that required for an AI; yet the possibility of creating a AI yields this possibility as well.

This can appear to be an ominous side effect of AI development. However, if an AI were built with the design of this document, the design team, their consultants, their shareholders, the laws of our country, and an amalgamated view of the educated, civilized, free people of the world, it would be a benign machine. It could not observe a human thought and then provide it to another entity in defiance of a human's wishes, or otherwise use it in other decision making. Certainly, the subjects of a democracy can produce laws to limit any AI actions.

An AI could use this ability for the good of humans, if legislated so. If an AI and a human were linked, and the human searches for a name, or fact, or other cross-referenced definition, the AI could provide this fact as an indistinguishable signal into the human mind. Limitations would be necessary, and a clear comprehension must be observed of what is a human thought and what is an AI-provided fact. I believe that virtually all genetic (or otherwise physical) mental illnesses could be cured by masking the defects in problem solving. Humans with Alzheimer disease, Parkinson disease, schizophrenia, or dyslexia (genetic dyslexia) could have corrective thoughts implanted into their minds while maintaining the integrity of genetic and conditional origins of their character. Limitations of this linking would be clearly known to the human. At the onset of such a disease, a human could draw up these limitations in a form similar to a living will, clearly defining the type of assistance to be gained from science. Limitations will be legislated. We are a free people who can determine the limits of such a connection through laws, rules, and regulations.

The processing of a life-form or an AI is innately linear due to the constraints of time. Each discernable action, and the processing behind the action, can be observed as successive events; however, the decisions of a nervous system can also be viewed as resulting from many processors working simultaneously. Tasks are tackled by separate “treads” of thought, by separate processors, and by separate physiological systems. The human body likely has many millions of systems working in unison to solve these problems. If an AI were converted into a mind-reading machine, it would require tremendous computing power to understand and differentiate these threads. Yet the human mind is a discrete-state machine, and it is possible to understand brain activity down to the firing of individual neurons.

While conscious, a human can be considered to have a main thread of thought. There are sub-threads, and then there are sub threads, and on and on. A human might be thinking of stopping at the grocery store, speaking to the grocer, asking him about the boat he had for sale, setting sail on the boat, possibly buying a trolling motor, when him and his brother got stuck on the lake, getting home late, having the wife get mad, and smelling like fish. At a certain point, this main thread directs him back to the coming conversation with the grocer, then buying groceries—milk and sugar, going home, and passing the annoying dog. Priorities in his thought processes direct him back to the milk—he must get 2% fat milk, bring it home, give it to wife, sit down, watch the news, figure out if the Marlins won the game, and if they are going to trade their second baseman. These might be the thoughts of one thread, the main thread.

Many secondary threads exist in a human, yet it appears that a second thread is discernable. During the previously mentioned thoughts, this second thread could be following a song on the radio, briefly, then observing the funny looking guy walking down the street, scratching an elbow, turning down the air conditioner, observing a sign for 40% off work clothes, and looking at the gas spill in the puddle. These thoughts are somewhat fleeting, usually observed briefly and discarded, while some may linger in memory. Certainly, a great deal of visual information will be retained for problem solving for many years. The main thread is a narrow, single leading edge of human thought where facts are churned through the human's processing to make his or her next-best-response.

The secondary thread compliments the first with a broad collection of facts and a little less actual processing. At times, the main thread's processing supercedes the secondary thread's processing. The main thread supercedes all sub-routines in a human's main collection of conscious thought, yet it is still subservient to the body's more physiological processes.

The human mind could be considered as having a third main thread. Like virtually all of the remaining secondary threads, this is a mostly processing and less-informational succession of thoughts. The act of driving the car could be considered as a third thread. This would only be true if the human is an experienced driver and this processing has become quite routine. When an experienced human is driving a car down a two lane road, he or she is solving the problem of keeping the car in the middle of their lane. The visual information enters the eye; this information goes to the brain to be processed; and the output then goes to the arms, which adjust the steering wheel. If something peculiar happens, such as a pothole becoming visible, this “third” thread and the “second” thread could be considered as merged. If the problem of not damaging the car is quickly solved, this could be the end of it. But if the car is jolted, this could also jolt the main thread, spurring many angry thoughts (possibly).

The third thread can often be discernable during daydreaming thoughts. One could be thinking on a primary thread, making facial expressions with a second thread, and singing a reoccurring song—often a poor quality song that one cannot get out of one's head. The song is easily placed onto a subordinate thread because tone variations are core routines of the mind.

When a person pats his or her head and rubs his or her stomach, this ties up two threads. The mind is usually attentive to these two threads, thus making attention to other facts and processes subdued. If a person were to pat his or her head, rub his or her stomach, walk, and chew gum, he or she would likely find it much more difficult to add on more simultaneous tasks. Although some musicians and composers have a way of building many simultaneous trains of thought, most people cannot easily perform in this fashion. Unfortunately, we are finite. Yet it is vital to know how to use the first two threads. Children must learn how to master these first two threads at a young age.

Through conditioning, children are taught how to dissolve some the ambiguity of these threads. At birth, the human mind can be considered as being of one single thread. Sub functions of this thread are almost exclusively physiological. Although vocalizations and arm and leg movements are simultaneous, their ambiguity renders these actions of no purpose—of any real secondary thread. When a child ties series of movements together for a purpose, these actions are etched onto the first thread. As the body movements become more routine, a disconnection to the first thread occurs creating a second, reasonably unambiguous, second thread.

If a child is crawling across the floor to get a toy, then he or she is using both threads to solve the same problem. Crawling has become quite routine and the sub-function/sub-thread is used to solve a first thread problem. It is likely that a third thread is indiscernible at a very young age. I personally believe that the first two threads should be encouraged in a child's development during the first few years, while the formation of a third thread should not be encouraged. A discernable third thread may occur, naturally, during the “formative years” without an elder needing to bring it out. If a child is singing and dancing to a song, this should be done well. It should be of a true and genuine nature, it should be tied to a specifically understood problem (of achieving relative, non-clichéd positive emotion, or winning a contest, etc.), it should be relative, it should be tied to ever-enlarging meanings, and it should adhere to commonly observed social etiquette. The complexities of a third thread are best left out of this process. It is also important that the child look back at an action such as walking and see that it is important to pay attention to the routine; this second thread action should be connected to the first thread. Some form of positive-reinforcing criticism should occur, such as, “Slow down, pay attention to where you're walking. You're going to bump your head.” Etiquette applied to the main and secondary threads propels the child to a less ambiguous understanding of life and a safer means of following routines, such as not walking off of a step and tumbling. Once children are older and they have learned to apply vital rules, such as gaining empowerment fairly and paying attention to potentially dangerous routines, then they can tackle the uses of a third thread.

Certainly, some children are prodigies. They may show a discernable third thread that is clearly focused in its assistance to the first and second thread. Also, some children are able to remember well-labeled facts, picking up informational facts and retaining them where other children may not. These are likely the geniuses of the world. Scientists and mathematicians are the more conservative version of geniuses (in tying problem solving to consumption, reproduction, peripheral problem solving, and well-being), and musicians and artists are the more liberal version (more enticed by positive emotions). These children should be raised a little differently than most other children. And they also should be reminded of the genuine need to connect all problem solving to the first thread and consumption, reproduction, peripheral actions, and ethical acquisitions of positive emotions. The following is a scene in which ambiguity is affecting the decision making for a human:
Harry is working for a painter. He is taping the door handles and windows of an office building in preparation for the next task of painting. He runs out of tape and is low on brown wrapping paper. He walks to the other end of the office, out the door, and greets another tradesman as he approaches the truck, “Hey, you mean you're actually working today?”
The other tradesman says, “Yeah, got to pay the bills. Are you guys going to be working down the side with the wide hallway?”
Harry replies, “Yeah, that's all going to be wet paint by noon.”
Tradesman, “Okay, got it.”
Harry reaches into the truck to get tape, but he forgets the wrapping paper. He walks back to where he is working and starts to tape. “Damn, forgot the paper,” he tells himself aloud.

Memories are prioritized; routines are prioritized. Once a task is delegated as a routine, it is doomed to fail if the person has not developed distinct, focused, routine observing skills. These skills are learned in the first two or three years of life. This is a small error on the part of the painter's helper. Virtually all humans forget small, mildly important things from time to time. Yet during the solving of important problems such as earning a living, a repetitive error such as this is not good. It equates to a direct loss, or a means of losing, resources. This error also defeats the more complex multi-tasking that other humans engage with ease.

The poor performance of this task bespeaks of an ambiguity of a routine and it bespeaks of an ambiguity in thread use. The formative years, a time when thoughts roll through a wide variety of assimilated facts, is the time to learn how to eliminate this ambiguity. This requires discipline. It requires, to a degree, a break from the continual rolling thoughts. Liberties should be vast, yet certain basic requirements of routine learning should be given precedence during select times of the day and during select points in the assimilation of life's many experiences.

In some households, children are ignored by parents for vast periods of time; they are privy to endless hours of television programming; the television is not only on but with a volume that is too loud; and they are among siblings who speak freely of thoughts in their continual attempts to gain a carnal, childhood-simulated empowerment. These children have an uphill battle in life. This is a problem with poverty.

With some children, poverty or unattended development is not the problem. In some instances, children are actually praised too much and conditioned to revel in positive emotions too much. They are not provided with enough negative criticism to teach them how to eliminate the ambiguity of routines with second thread actions. These children do not easily learn relativity. Etiquette, routine following, and unambiguous uses of threads go hand in hand in childhood development.

Although the formations of “threads” mentioned here are theoretical, the problem solving that occurs in them is clear and unambiguous. The AI will view the threads of the human mind as a tool for comprehending human actions.

Etiquette

In the first twenty years of life, a human assimilates information and information-handling functions from elders, so that he or she can begin solving life's problems on his or her own. Etiquette is a word used throughout this document to describe those established societal rules for solving problems. Some of these rules have no purpose other than to discipline undisciplined actions by applying routines-routine practicing. Some rules are for caste purposes and solve specific problems of working within a caste social system (sometimes, in many unfortunate ways). Some etiquette is vital to development. Some established etiquette works against the grain of solving valid problems and should be challenged with discussion by humans and by AIs. Etiquette is sometimes relative to a period, or relative to a particular subgroup of humans. Etiquette is measured and recorded in fractions of a second. Liberties are integral to the learning process of a child. When a child, knowing of the etiquette taught by elders, steps away from a rule to engage in a liberty, he or she is ambiguously exploring his or her genetic and previously conditioned methods of problem solving. Liberties are indulgences in ambiguity that provide epiphanies that, in turn, provide a sense of self-worth in addition to solving many other problems. These liberties have intrinsic value. However, approximately halfway through the formative years, children must be taught basic etiquette, ethics, routines, and functions, while certain liberties are discouraged, such as when a child unfairly gains a toy at the expense of another child. Liberties for an infant should be broad, and any structure imposed upon an infant's thought processes should only be with positive reinforcement. Yet when leaving infancy, a child should be taught more of the etiquette of life, with either positive or negative reinforcement, while certain liberties are reiterated to nurture the child's independence.

This section explains only a small portion of the many etiquette rules, mainly of conversation, that children learn in the early years. The AI will learn these same rules, yet the AI will not have its own independence to nurture, nor will it have its own positive emotions guiding the process. The AI will learn of these rules in a de facto fashion, while any response that nurtures emotions will be a result of the offset emotions in the Instructor and the recipients of the AI's communication.

A child must learn to not gain empowerment at the expense of others. When a child takes a toy or food from another child, this is a basic, common breech of the first rule, and the most quintessential rule of life. This is a matter of etiquette, and it is a matter of ethics. By enacting the age-old desire of gaining resources and gaining social empowerment, a child will (generally) acquire and exhibit a possession to achieve status. Children learn that a parameter exists only when they are taught the etiquette of fair-gain—that a respectful level of empathy must be observed when procuring items. If a child were to develop his or her own etiquette and parameters, and he or she had a genetic predisposition for aggressiveness, then this would include taking things from others with a carnal desire to become the alpha male or alpha female. When one adult cuts another adult off in traffic, or when one takes an extra packet of ketchup from a restaurant for use with other store-bought food, or when one is overbearing in conversation (in a non-competitive format), or when one deceives another in a business transaction or agreement, or when one human lifts a dollar off of a table in a room full of people when no one is looking, this is an unfair gain of empowerment. If this rule is properly taught at a very young age, then it should not matter whether it is a single dollar or a billion; and it should not matter if he or she would be suspected by others or will get away with a clean take, this etiquette will not be broken. (Granted, some children are genetically predisposed to chronic aggressive, unempathetic behavior; yet this is a very small portion of the population.)

If a child is properly taught this rule of ethics, and of etiquette, then the parent should also be attentive to the need for a child to learn of being competitive in the proper venues of life. Our society is built on the concept that humans can empower themselves over others fairly while observing etiquette, such as in business, sports, or some other competitive activity. Just as a child could be excessively unempathetic, a child could also be excessively empathetic.

Another rule of etiquette that is integral to the structure of a human conscience is to not be clichéd with a response. The learning process of a child is driven by this rule to not be clichéd. If a child is playing peek-a-boo and he or she becomes bored with the thoroughly learned routine of being surprised, then he or she is naturally, genetically seeking to not be clichéd. This means that the child is in acquaintance with a fact or decision-making process either internally or with another entity. Two adults being of acquaintance with a common greeting-mode response would likely seek a new way of greeting because the older response is clichéd between the members of the formed group.

The media age is a means by which a society, a large group, can be made aware of a fact or decision-making process, such as a style of music, that can then be determined as either new and innovative or old and clichéd. An adult human or AI must be in acknowledgement of what previous responses have been made by humans in like-problem solving situations to judge whether a fashion of clothing, a painting, or a piece of music is new or clichéd.

A reoccurring life-form problem, such as deciding which restaurant to go to, can be considered as not being clichéd provided that its relativity is kept in check. In other words, limitations must be observed in the time of processing and conversations about these problems. These problems, and all problems, must be prioritized in life.

Another integral rule of etiquette is not producing a carnal response that violates the rule of not being clichéd. A human's response should not be of limited abstraction, of only basic genetic desires, when nature dictates a need for more informational problem solving. The basic mundane paths that go to common solutions should be avoided. When a male obsesses about a basic resource problem, such as sex or imposing bravado, he is being carnal. When a female obsesses about a courtship ritual or the sub-functions thereof, she is being carnal.

Unfortunately, we live in an age in which the media promotes both clichéd and carnal thought processes in its subjects. If educators do not actively address this issue by extensively training children how to live in the media-age, including learning how to criticize the media as opposed to being lead by the media, this could have grave consequences for the democracies of the free world.

The rules of not being clichéd and not gaining empowerment by unfair means are the principal rules of etiquette that form the conscience of a human being. These rules are taught with communication through communication.

An AI is taught when and how to speak by seeking a positive response in the Instructor. This complex lesson will be taught over many years, with many other lessons, leading the AI to a rendezvous with a relativity of conversational problem solving. When a child is told by a parent “Quiet, please” or “Settle down,” he or she is being taught the etiquette of when and how to speak, how to respect the hearing senses of others, and how the problem solving of others must be given credence. This is the beginning of the child's path toward a relativity of problem solving. Unless the child is being rambunctious when a more competitive activity is warranted, a parent would have to teach this rule either with positive imposition (of tone variation that implies positive imposition) or mild negative imposition.

This basic etiquette rule of communication is usually taught in an ambiguous fashion. In other words, the parents usually never describe the lesson directly, but rather indirectly over the course of many separate interactions. If the lesson is too ambiguous, it may not be thoroughly learned. If the lesson is too direct, it could subdue the free thinking that comes with liberties. How to achieve a balanced teaching of this lesson requires an observation of the genetic predispositions of the child. To gauge the firmness needed in this lesson, the parent would have to determine the genetic aggressive or passive levels of the child.

A child respecting the rules of a mother to “be quiet” is observing a vital, primary rule of conversation etiquette. It is the equivalent of taking a toy from another child—an unfair gain of empowerment. Other rules of conversation etiquette follow this rule, such as the many other “volume” rules and “timing” rules. If a child does not learn this first rule, he or she cannot easily learn the other rules or even begin to learn a relativity of statements, a relativity of topics, and a relativity of problem solving. It not only hurts his or her conversational skills, but it causes him or her to build a skewed, unrelative character because poor etiquette in conversation, especially poor etiquette learned at a young age, leads to poor etiquette in processing thoughts. Communication skills and thinking skills are inextricably linked, in this way, and in this order.

The learning of this conversation etiquette rule is not a matter of choice—a liberty—but rather a necessity. All future decision making in life depends on a child successfully learning this rule. One's success or failure as an adult can be directly tied to the learning of this rule. A liberty of allowing defiance during such an important etiquette lesson could only be valid if it can be proven to, at some time, in some way, find a distant connection to one of life's primary problems. It could only be valid if it helps the child, and the adult society that this child grows into, by creating a mindset of free-thinking that assists in purposeful abstraction. With this particular rule of etiquette, this is likely not the case. For the purpose of creating an AI and the AI's doctrine on etiquette, a conclusion will be made, in this instance and in similar situations, that a human child will want to solve adult problems with adult-like thought processing when they are adults.

Many parents wish a copasetic world to be imposed on their children, and these parents may wish that this rule remains flexible. Such parents may state, generally, of general problem solving, “We never want our son to feel pain or be hurt in any way,” so they choose to not negatively criticize their child when he or she speaks out of order, or when the child breaks other rules of conversational etiquette. Throughout this section are examples of how the absence of this negative reinforcement could mean the diminished mental development of a child. Higher levels of intellectual development can only be achieved with negative criticism being a part of the learning process. Liberties are a valid part of a child's development, yet the structure of problem solving must direct the child to the locations of these liberties, not the other way around.

Certainly, parameters are up for discussion, yet in an instance when a robot is babysitting, it will teach etiquette lessons and liberty lessons with a firm resolve to use negative criticism if it will help the child later in life. It would require sound case study on the part of an AI or a human to change the etiquette doctrine contained within the program. If a parent were to request that the program be so broad that it never uses negative criticism, then the robot would refuse to baby-sit. Case studies will always prove that speaking with respect to others is vital to maintaining safe, yet broad, parameters.

When teaching this etiquette rule of determining a proper time and demeanor of speaking, elders should also take into account that, at times, a child's behavior should be rambunctious for the right reasons under the right conditions. These rare liberties of interrupting must be made quantitative for the child, and their occurrence should be only when conversation allows for such a demeanor.

Learning when to be quiet, when to speak, and how loud to speak, leads the child to the next vital lesson for both humans and AIs—what signals divulge an opportunity to speak. Children often speak at will about many things while parents are preoccupied. They might speak directly to a parent to get their attention. Two things will prevent the parent from not listening or cause the parent to shun the child to not comment: one is that the parent is solving a pressing problem, and the other is that the child's problem is not relative or otherwise due attention. Children slowly learn things such as not to speak when parents are talking to each other. They also learn the other signals of a parent being preoccupied with deliberate problem solving such as cooking, ironing, or watching television. They can interrupt, in a polite way, but this must involve a valid problem that a child is solving with a communication.

Conversation always solves specific problems-either social, emotional, and/or resourceful/informational—and humans must be attentive to everyone's problems in fair quantity. If two or more humans are participating in a conversation, they will often speak in order (the one with the longest pause goes next) unless a subgroup of the whole is attempting to solve a single problem with their communications. In such an instance, the turn-taking is often in an order within the subgroup.

Comments are valid if they contribute to finding solutions to valid problems, and this may even mean an abstracted, emotional, social problem. An adult seeks positive emotion from time to time with his or her commenting, yet if it is too far removed from the primary problems of life, then the problems to be solved become moot. The vast majority of problems that children comment to their parents about involve the acquisition of positive emotions relative to their learning level. These problems are valid if they are simulations of adult problem solving in a manner that expands the knowledge of the child in preparation for those adult problems.

The tone variations across statements are integral to revealing the validity of conversational problem solving and whether a comment has a place. If two humans are talking and one mentions a fact that solves a particular problem, then he or she will usually trade the conversation off to the other participant for his or her thoughts on the proposed fact. If a speaker has a few facts in a series, he or she will usually say something to the effect of, “I gotta tell you about what I saw.” Then, subdued tone variations are often used among phrases until the last phrase of the topic, where the speaker applies an ending low-tone. Usually a peak occurs in the tones near the end of the phrases, yet it is not entirely required. Sometimes an ending low-tone appears that is not too low, signifying that, “I've mentioned a few relative facts, and I have more, but let me know what you think so far.” It is a way of keeping a topic going through an exchange. In studying these tone variations and the various other rules for responding, children learn the telltale signals that provide them with an opportunity to speak.

Here is a basic example of several etiquette rules being taught to a child:
A mother is intently watching television, and her child approaches her, saying, “Look, see what I drew? I made a race car.” This phrase is said in relative tones.
The mother states, “Yeah, I see. Flames coming out the back and everything . . . That's pretty good.” A low tone at the beginning of “good” and a slight raise at the end of the word implies, “It's good, but relatively good, and there may be things that make it better.” Then she pauses for respect, showing true, genuine attention. “Now, let me watch this show. I'm trying to follow it.”

In this scene, the mother has determined that her son's drawing of a car is relative to good, prioritized problem solving, and relative to his age and skill level. She is complimenting the child, and the compliment appears to be genuine—she is expressing to him that he has made a good next-best-response. She gives him attention, and then directs him away, teaching him that his conversational problem solving has a time and place relative to the problem solving of others.

Here is another exchange:
A mother is intently watching television, and the television show is near a climax. Her child approaches, saying, “Look, see what I drew? I made a race car.” (In relative tones.)
The mother states, “Wait, wait, let me watch this . . . .”The child looks at the television, then at Mom. He walks away and continues to scribble on the drawing. After the program ends, the mother says, “Okay, what is it?”

In this instance, the child is stopped by the parent. He then looks to the television to gather the emotional exhibitions and tone variations of the characters; and it appears that he may recognize the story being played out on the television. If he knew of the etiquette rules with tone variations among the characters, he could follow the show enough to determine when she would be receptive to his speaking. The mother is unknowingly teaching this to the child. She is knowingly teaching him that rules do exist for speaking. Another variation might be:
A mother is intently watching television, and the show is near a climax. Her child approaches, saying, “Mommy,” as he pats her on the arm. She ignores him. “Mommy,” he says again, a little louder, shaking her arm. “Mommy!” He says one more time, louder.
“What?” she says louder than average, with greater than average tone variation across the syllable.
“Look what I drew,” he says.
“Yeah, yeah. That's nice.” The tone variation of the second phrase is a sharp, single, high tone and then a solid low tone, implying, “The problem that you're speaking of is valid but I am occupied with other problems of my own.”

The time to speak loudly is when a valid exhibition of emotion is needed to solve a valid problem, such as cheering a football team or a relatively important news event. Other rules also apply. In this scene, the child is getting louder to draw attention to his problem solving. If this parent were to observe that the child did not recognize her preoccupation, and she wanted to teach a volume etiquette rule and a relativity rule, then she might say, “Wait, don't yell. I'm trying to watch this show.”

The mother does not respond until he becomes so loud that it interferes with her problem solving; thus teaching him that increasing the volume can draw the attention of others. The mother acts as if that the child knows of her preoccupation, and that he refuses to be respectful. The truth is that he probably does not know when the recipients of his communications are preoccupied. He only knows that when he speaks, others should listen and react If he is like most children, he has an ability to learn empathy; however, he is not being taught that the problem solving of others should be observed, studied, given respect, and that his own problem solving should be prioritized with the problem solving of others. The absence of this simple etiquette lesson has far reaching effects on the child's character. Many learning steps to follow would be affected by this blind spot of comprehension.

Most children can be taught of the etiquette of volume in an ambiguous fashion involving many learning steps; yet more-aggressive children need more-aggressive lessons. If this child recognized the preoccupation and proceeded to interrupt it, this would necessitate a more detailed lesson, such as, “Hey, don't be so loud. It's not polite. You see that I'm watching this show? Why don't you wait for a break?”

A lesson in volume etiquette also assists in teaching a child of another important rule of life—observance of relativity. Generally, higher volume proposes a higher relativity. If a human speaks loudly, proposing a level of relativity with the delivered information that does not match society's predetermined level, then the speaker will err in the eyes of other humans. A speaker with an unrelative response may gain attention, but he or she will not be truly provided with a solution to his or her social interaction problem. In many instances, speaking loudly gains either positive attention from recipients who wish to not negatively criticize, or negative criticism that that the speaker does not easily acknowledge as negative. This provides the speaker with a false sense of empowerment for his or her actions. Children must learn this. A character can be unique, but it must be relative by, at the least, respecting the relativity observed by others.

Relativity is the guide with which a human creates a character, and volume etiquette rules assist a human in engaging in relative thought processes. A child who speaks loudly without being challenged by a parent is likely to learn that no real parameters exist for conversational problem solving, including other rules such as speaking in turn or speaking of valid problems. He or she would have a difficult time learning a relativity of problem solving because his or her character forms too early on the unempathetic side of the spectrum. These early conversational etiquette rules of topic relativity, volume, and timing are vital to the development of all adult-level problem solving. It is usually best not to teach these lessons in quick learning steps; yet these rules must be learned. I believe it is best that these things are learned before the age of three so that many of life's larger lessons fall into place.

Some children are prodigies. Those who show a strong disregard for etiquette while showing amazing feats of artistry should be taught this etiquette differently than other children. These children must be allowed to endeavor in art until they show signs of peaking, or boredom, within a particular skill level. Then they must be sternly, and unambiguously, taught the etiquette that they have been avoiding. When they learn to follow this etiquette, they should be reintroduced to their artistic endeavors with accompanying reasons why their art will improve. We all have parameters. Artists have parameters. Art can only be so abstract before it loses validity. An artist must not seek out abstraction for the sake of abstraction, or for the sake of a liberty, but rather for solving valid human problems of what piece of art is now needed.

With each lesson of etiquette and each lesson of problem solving, the parent should teach the child why an action is, or is not, relative. A connection must be explained or otherwise understood. In the previous examples, the parent provided ambiguous reasons why the child's interruption was a poor next-best-response. In learning most of life's lessons, ambiguity promotes free thinking and an air of independence. However, too much ambiguity in the learning process defeats the child's discovery of an educated relativity. Parents must also be careful to not propose excessive ambiguity with negative reinforcement because this could drive an empowerment wedge between them and the child. Lessons can be of an ambiguous purpose, as long as that ambiguity is diffused at some point in the twenty-year process of learning adult problem solving.

Like the etiquette of volume and volume variations, the etiquette of tones and tone variations taught to children must assist in their ascension to an adult-level educated relativity. In addition to revealing the starting and stopping points of topics and when a comment can be made, tone variations imply a proposed relativity of a topic. For the majority of adult conversation, tone variations should be subdued, indicative of restrained, well-placed emotions. By subduing tone variation, adults acknowledge the need for more informational and academic problem solving. When a parent converses regularly in this demeanor with a child, the child learns informational problem solving with ease.

In our current day and age, in western societies, parents are often compelled to speak with exaggerated tone variations to emphasize the learning of the earliest lessons of life. Too many children's television shows are of exaggerated images, exaggerated topics, and exaggerated demeanors of communication. (At times, these television shows perform the purest exhibitions/impositions of positive emotions while pacifying any informational problem solving on the part of the child.) These excessive tone variations are damaging to the mental development of children. Excessive exaggeration of images and stories, exaggeration that has no inherent resourceful or informational value, teaches children that reality—science, math, and academics—should be avoided.

Elders should not use excessive tone variations with post-lingual children in a desire to provide them a copasetic world because excessive emotions inhibit a human's ability to work through many abstracted informational steps. This does not broaden intelligence, it limits intelligence. It does not assist resource problem solving, it hampers it. It does not lead them to relativity, it proposes a false relativity. Children taught life's lessons with reasonable adult-level tone variations have a superior intellect than those who experience exaggerated tone variation. This can be demonstrated in many different ways, in many different types of tasks. With very young children, excessive tone variation can be helpful to development, yet once these early lessons are learned, the parent must cease the excessive tone variation.

While in the formative years, any exaggerated tones must be exhibited within a specific genre of communication with the child. Their use must be quantitative. Efforts must be made to show the child a clear delineation of this baby-talk and adult-talk so that the child can recognize the relativity of his or her own existence, required learning, and problem solving with the relative problem solving of others. Some connections between these two worlds must be hinted. If the child expresses an epiphany that this outer-domain, the adult world, is something of interest, then the child is poised to learn of this adult world with the maximum possible effectiveness. Such a child is well on his or her way to learning relativity.

Different types of tone variations have different definitions. A very high peak often means, effectively speaking, “this is a very important fact/topic/aspect.” Reaching a very low peak can be an expression of negativity or a concluding of a topic, depending on contextual information. A peak and then slightly lower tone near the end of a phrase usually means, effectively speaking, “I am proposing an important fact/subtopic/aspect of a superior topic, but you could think about it and respond with a possible agreement or disagreement of the information or the relativity.” A high peak in a phrase followed by quite a few successive low tones means, effectively speaking, “With due respect, please believe in the fact that I'm stating or the relativity that I'm proposing.” Children will sometimes face obstacles when they observe an elder use a tone variation for a reason other than its usual meaning or when an incorrect relativity is applied:
A child in the 1990s is watching a rerun of a television show of the 1970s. She states, “Man, what in the world are they wearing? No one dresses like that.”
A parent states, “Julia!” pronounced with a very exaggerated high to low peak, implying, “You are very mistaken with this problem solving.” The father continues, “When do you think they made this show?”
“I don't know,” the daughter states.
“This show is from the seventies. It's old,” the parent says with exaggerated tones.

In this exchange, the parent imposes negativity and embarrassment without a good reason. He is implying that the daughter should know of the program's being outdated because this is an important thing to know. The most likely cause for his excessive tone variation is that he got excited that the child was watching a show that he wanted to comment about, and she presented him with a surprise connection to his knowledge of the show. The parent is teaching an important lesson; yet this means of using exaggerated tone variation is not a polite means of teaching the child that the show is of another relative period. It implies too much of an error on the part of the child when the child likely had no way of knowing when the television show was made.

With a quick drop to a low tone, a speaker is proposing a clear end to a topic, thought, or opinion, while excluding any other thoughts or opinions on the topic. Here it proposes a high importance of a mistake, and that this view is a conclusive determination. A speaker can sometimes be quite condescending with this tone variation because he or she is berating recipient(s) with a firm parameter placement.

This may appear as an odd, unusual exchange, yet when one human speaks with an exaggerated tone variation, no one is really able to say, “You're breeching commonly understood etiquette of tone variations. You're implying that it is a relatively big error occurring on the part of a human when it is not.” Criticizing someone for breeching etiquette is often a breech of etiquette.

Over the past ten years, news anchors and reporters on television have used poor etiquette to express emphasis of things that should not be emphasized. These adults are breaking etiquette rules by sensationalizing news. They are sensationalizing news for ratings—resources. Since no one can easily criticize them on something such as tone variation, they have had free reign in defining their proposed relativity. Behaviorists must take a stand on how relativity should be determined by humans; and they must criticize journalists for their excessive emphasis on news stories that have only limited relativity. Of all people, journalists should know relativity, and they should know communication etiquette. Children should be shielded from news programs because they may learn the sensationalized views of news anchors.

Here is a fictitious example of poor etiquette on the part of a journalist. This may appear as an exaggeration, but it is not. Stories are currently reported in this manner. When viewed in fraction-of-a-second increments, current videotape footage of news anchors can reveal this style of sensationalism:
“Well, we've been camped out, (very low tones, slowly speaking, with deliberate and unwavering voice, implying concern on the part of the speaker) like many journalists (very low tones with a peak, and very drawn out) outside the home of Tricorp CEO, Jack Harrington (very high tone), to find out if he will speak to the media about the accusations that he has embezzled over twenty million dollars (repetitive exaggerated tone variations over each dragged word of the dollar amount) from company accounts to buy his hundred-and-twenty-foot yacht, a sprawling seventy acre estate, and a large race horse farm in upstate New York. Momentarily, we will have an exclusive interview with his secretary. You will only see this interview here, on KBA news channel. Again, we are awaiting word on whether or not he will step out to greet reporters or if he will be quickly whisked off to the courthouse . . . ”

This news story has a terrible slant on it. This reporter should be ashamed of her behavior in reporting this story. The news channel should be appalled at this sensational-biased story, yet they are likely the cause of it. The reason for the sensationalistic slant is the acquisition of resources—higher ratings; and a fair reporting of basic information is not the goal of the reporter. The problem the producers of this program experience is that if the news is rather uneventful, then the channel cannot turn a profit, so the reporter is urged to take measures to make uneventful news more dramatic. In our current day and age, this style of reporting is too common. Parents must shield children from watching many types of television shows, including many news programs; children should not look to the news to determine a relativity of problem solving.

The very low tones at the beginning of the report imply high relativity of the program's efforts to report the serious story. The reporter is implying that there is much emotion involved with the learning and relaying of this story. Certainly, those cheated out of this large amount of money are feeling tremendous negative emotion, and this story does have great relativity with this group; and larger groups should also be concerned if this kind of behavior becomes a new trend or a growing trend. But since there is likely little new information related to this story, and since the story likely has a more limited relativity against the backdrop of all of society's problems, the story should be presented with a lessened relativity—less emphasis. When the reporter mentions the dollar amount, he uses a high and low tone applied to each word to wrap up all the cause of the story into this heavily emphasized fact. This is just too sensational and too carnal.

This is one of many types of “slants” placed on news stories. Some programs also use tone variation to slant news so as to promote either a liberal or conservative viewpoint. Many instances can be found were news is not reported objectively.

Since there is likely little relativity to this story compared to what is implied, and there is likely little abstracted information about the alleged incident, this story likely does not warrant a possible “camping out,” nor does it warrant such a tremendous preparation before an actual body-mode of communication, nor does it warrant the excessively implied relativity of the “exclusive interview.” This story is terribly over-reported. The following example is one of many possible next-best-responses of a reporter:
“We're continuing to follow the story of the indictment of Jack Harrington, CEO of Tricorp. (video of house is shown) He is scheduled for arraignment today and many reporters have assembled outside his home. He is accused of embezzling over twenty million dollars (said with normal tone variation) and whistleblowers have lead investigators to information of his lavish spending spree. If he addresses the media we will report his comments as they become available. FBI officials have stated that . . . (a few more facts of story). Now we have been provided an interview with his secretary . . . . (They go directly to the interview.)”

News programs should simply report facts. If the ratings do not exist, then they must not create them. If the channel does not produce a profit, it should simply cease to exist. And if it appears dangerous to a democracy that its citizens indulge in too much non-informational, emotional, carnal, and clichéd television viewing, then extensive changes in educating children about the media age must take place. Yet, many unsensationalistic ways to achieve ratings are available. A report like this one would warrant a limited amount of time, and then the reporter would need to move on to other stories. The flow of stories should mirror the desired timing rules desired by an educated audience. They should not interrupt any stories just to go back to this subject's house when he emerges because this implies an incorrect relativity. The uneducated audience should not be wooed by sensationalism. They should be ignored.

The poor quality of news reporting is one of the many negative effects of an unbridled media age. In teaching children and teenagers of relativity, elders must teach them of the unrelative nature of many current television shows. They must learn how humans use tone variation to imply relativity, and how this may be a false relativity.

Tone variations can be exaggerated to teach an infant about the earliest rules of life. Yet elders must also exhibit a relativity between the exaggerated lessons of children and the learned world of adults by weaning the child off of baby-talk at a very young age. This should likely occur at about three quarters of the way through the formative years. One important means of teaching children of the connections between their relative world and the relative adult world would be to use very expansive definitions of certain facts. Exaggerating tones should be used at crucial moments, before continuing with adult talk. In essence, moving from exaggerated tone variations to more normal tone variations is a lesson in not being clichéd.

Some parents show their pre-language children cards containing a fact or picture; and after stating the fact, they quickly move on to the next card. Some parents play classical music for their infants or they use differently shaped and textured toys to teach the child an abstraction of information. Some parents try other types of subliminal learning. These methods may have some validity to them, yet they likely do not venture too far from the learning that occurs when the child experiences a stimulus that is markedly different than the previous stimulus. Cards shown to an infant may help to a point, yet this is probably about as valuable as taking a child to the park, letting him or her pet a puppy, or giving him or her a new type of toy that makes a new sound. Anything that is not clichéd helps, and the repetitive actions of moving cards may lull the child into not recognizing the labels provided by adults.

If a parent really wanted his or her child to grow and learn at a maximum level of efficiency, this would require, first, teaching a simple thing, then expanding upon the simple thing, and referencing other facts and functions connected to the thing that the child will not know for many years to come. The unknown part of the definition of a thing must be presented in a quantitative way. In this way, the unlearned things are an expansion of learned things. A conscience must have a core set of rules to build upon.

Here is an example of a child learning to play with a ball and learning to recognize ambiguous information in a quantitative way:
A parent and her two-year-old child are in the yard playing catch. She softly throws the Nerf ball to her son. He pulls his arms together haphazardly, missing the ball. The mother chuckles, “Almost.”
He throws the ball back too hard sending it over her head. “Don't throw it too hard,” the mother says. The child loosely picks up the two words that he knows out of the phrase, “Don't throw,” and recognizes that he has made some sort of error.
She softly throws the ball again. He pulls his arms together like before while closing his eyes as the ball comes close. He misses again. “Watch the ball,” she says as he chases the ball. He starts to throw it back. “Wait, wait, softly,” she says. He throws it a little softer and she catches it.
She prepares to throw the ball. “Now, watch the ball. Don't close your eyes. When it comes close, bring your hands together like this,” she says and demonstrates. The child follows the words he knows—“watch the ball,” “don't,” “hands,” “like,” and “this”—while roughly understanding the words that he does not know. While not understanding everything that she is saying, he knows that other things have to change for him to catch the ball. She throws the ball.
He closes his eyes again but looks at the ball a little longer. He brings his hands together slower with better timing. He grips the ball between his arms but it slips out. “Great! Almost,” the mother states.
He throws it back excitedly, throwing it over her head. “Uhp, throw it softer, I don't want to run for it,” she says. “Okay, you ready?” She throws the ball. He misses. “You can't close your eyes, silly,” she says, with a heavy accent on “you.” He gets the ball and starts to throw it back, pauses, then throws it softly.
“Alright, here we go. Watch the ball. Don't close your eyes.” She throws it even softer. He catches it, pulling it into his body. “Alright! That's perfect!” He laughs in contentment. He starts to throw it back hard, but pauses and throws it softly.
She continues to throw it to him as he slowly improves.
In the days to follow, they practice throwing the ball many more times. When he becomes consistent, she moves back farther. She also does things such as bouncing the ball and throwing the ball in a high arc. As she continues with the lesson, every time an action on the part of the child becomes old, or clichéd, she changes. Each time she speaks, she says words that he knows while clearly adding words that he will not learn for many months or years.

When the mother speaks with known words while adding unknown words, she is not befuddling the child because the unknown words are provided in a quantitative way. The child does not have to rely heavily on understanding those words to figure out the task. Like an AI, the child views the problems within the social interaction as subservient to the social interaction itself, so the information delivered within communication may or may not be understood, and it may or may not be relevant. Yet because of curiosity and the need to solve reoccurring peripheral problems, the child searches for the meanings of these words. Whenever a lesson is learned and the associated words are learned, a parent should always add new words. An amazing thing happens if this “different” stimulus happens regularly—the child will look to study this new, different stimulus with fervor.

This changing stimulus is especially interesting to a child if a different, unknown fact is presented near the core of an important genetic problem. In one instance, she throws the ball and immediately says, “You can't close your eyes, silly.” It is likely that he does not understand many of the words in this statement, yet because the action of tracking the ball is an age-old genetic task, her proximate communication must mean something important. She states the phrase with great emotion, she uses a funny word on the end, and the large tone variation is peculiar. Something is there, and the child knows it. He looks at the ball closely on the following throw to see if she is saying something about the ball. Little does he know that the “paying attention” is the function that she wants him to learn. If he continued to look for the meaning of the statement while not finding answers, he would be learning a valuable lesson to keep looking.

After observing a reinforcement of a definition, an infant can be given a lesson in recognizing changing stimulus. This lesson can be packaged with the speaking of a child's favored item. When a parent talks of something of extreme interest to the child such as eating a favorite cookie (baby-cookie), the mother could say, “You want a cookie?” with a high tone on the last word. Once the child recognizes the questioning tones, the parent uses these same tones to speak of a new favorite item. The definition of the tones means, “Do you want to solve a particular problem of . . . a cookie? . . . a toy truck? . . . getting something?” The child learns the definition of the tone variations of a question as well as the labels of these items. The parent could also switch the tone variations. By saying the same words while peaking on “you” followed by all low tones, the parent would be implying, “You know that you want to solve this problem; emotion beckons you.” Yet this would be a tone variation that should not occur too frequently because it pampers the listener and tends to be of unrelative emotions.

Tone variations must be expressed in such a way that they direct the child to informational/resource problems such as playing with a ball, rather than ambiguous exhibitions of emotions. This is the number one tool that a parent has for directing the child to higher levels of intellectual development. Exaggerated tone variations must cease once a child becomes proficient with language because the continued use of this exaggeration is clichéd, and it inhibits a child's ability to work through the many informational steps in academic problems.

Another vital rule of etiquette, and relativity, is topic timing. When speaking of a topic, a person must gauge the relative amount of time to be spent on a topic. Elders reveal this rule to children when they drop to a conclusive low tone when speaking of a topic before abruptly speaking of a different topic. Other telltale signs may apply. The trick to teaching children of topic timing is to teach them observational skills. People give signals as to when they will wish to move on to a new topic. Listening and observing the demeanor of other people is, at the least, half of communication.

This example is an adult telling a story with very unrelative subtopics and sub-facts. He is also completely unaware of timing etiquette:
“Did I tell you about when we went to look at that car? I was about to pass by that car lot at the end of the street because I've looked in there a few times before and I didn't see anything I liked. My wife told me she saw a nice brown Suburban, so I turned around and we pulled in. (small pause) This salesman comes out and he starts to give me a sales pitch and I'm like, ‘give me a break.’ I kept cutting him off every time he said something. I started to look it over and it has everything. A little TV. Removable seats. The back actually had like a modified cooler built in. Who ever had it last did a good job of modifying it. Real professional job. I kept trying to get the guy down to fifteen. He wanted eighteen. I'm going back again tomorrow . . . ”

This may seem like a fictitious example of a person telling a story, but it is quite common for the speaker of a story to not know timing relativity. In other words, this person might notice this story as being too long if someone else were telling it, while not knowing that he speaks in the same manner. People will often recognize a breech of etiquette when it comes to others speaking, yet their own etiquette breeches go unnoticed. This response carries too many details about the topic, and any empowerment gained from telling it is false—a product of the speaker's embellished perception. This is the result of a childhood in which the parents did not teach their offspring of topic timing.

Timing etiquette is probably the most vital rule that a child could learn because it leads to an understanding of a relativity of problem solving. A young child's failure to learn the rudimentary elements of topic timing can start him or her down a difficult path where a true relativity becomes elusive. An adult's breech of this conversational etiquette bespeaks a character that has not learned to prioritize and place time limits on problem solving. Such a character often lacks the observational skills needed to detect the problems of others, which is needed to gain some level of mutual admiration with peers. We all have play-problems, general-problems, and vital-problems; and one could easily get caught up on a vice of some sort if he or she does not learn to prioritize. Topic timing is a rule in self-discipline that prevents some of the most difficult mental ailments of “not fitting in with society.”

Here is another example of excessive time being spent on a topic. Although the author can only propose a rough probability that too much time is being spent on a single topic, an AI can produce a specific, probable amount of time based on society's overall needs. This is achieved by an extensive mapping of human behavior and allocation of case study:
“I greatly appreciate you helping me out with bringing this flat tire down to the shop. I would have had to wait a long time and miss work. Really, if you ever need any favor of me just ask,”
Luis tells his friend.

This series of phrases appears to overemphasize the emotion of gratitude for providing resources. Most humans would, if the tire fixing is reasonably relative, assist another human in solving this problem. The speaker feels that he should provide an immeasurable amount of gratitude while society dictates the use of one or two phrases to show a normal, probable amount of gratitude. A more reasonable response might be “I greatly appreciate this. I would have been stuck.”

This human's application of too much emotion (societal-bonding-empowerment) to this particular interaction and the subtopic of “the favor” is likely a result of being taught to reiterate gratitude when receiving assistance with problems. This character could have also failed to learn the relativity of topics or topic timing, then he could have struggled to gain acceptance among peers, and now he compensates by applying excessive empathy while in social interaction. The speaker is reinforcing a societal bond, an important part of social interaction; yet emotions must have levels and limitations. Emotions are integral to societal bonding, emotions aid in acquiring resources, and emotions give humans a sense of self. However, too much indulgence in emotion leads to a neglect of informational/resourceful problem solving. This speaker is likely unaware of the competitive nature of some human interaction, such as bargaining. He is likely to regard many common problems as having too many informational steps, or he may feel that the multi-tasking of informational problems is excessive. Just as a lack of empathy can cause a blind spot in comprehension, excessive empathy can cause a blind spot in comprehension.

Here is another example of relativity not being applied to conversational problem solving with the timing of topics:
Alice and Mark have been dating for about three weeks. She is visiting his house to spend time with him, watch television, etc. He answers the door to greet her. As they greet, she comes in and they both settle on the couch.
“Hi,” she says.
“Hello,” he says in drawn out tones with long arcing tone variation; and with accompanying facial expressions implying, whimsically, “What mischief are you up to with the problems that you are trying to solve? I have problems to solve of an emotional nature. Maybe we both can solve them together.”
“How was your day?” she says. Despite their detailed acquaintance, she uses tone variations that are common of humans of limited acquaintance. The tones are exaggerated, exhibiting excessive emotion.
“Pretty good, I just worked, ran a few errands, went to the store,” he replies with tone variations that go successively lower. Tones are normal, relative.
“Oh, so what'd you buy me?” she jokes.
“I just got a little bit of cleaning supplies. Bought a few things for fixing the blinds. I thought I'd order a pizza, if you want,” he states. The first two phrases have a very quick decrease in tones across a very quick series of words.
“Sure, that's fine,” she replies, then pauses, “So did you, ever find out what was making the noise in your car?”
“No, I still have to take it to the dealer,” he says. “So what did you do today?”
“Nothing, just worked. I came home and talked to my son on the phone. He says it's getting cold up there. He doesn't know if it's going to snow or not,” she replies.
“Yeah, he's going to have to stay in if a snow storm hits. It's not easy to drive,” he comments.
“Yeah. Then I was going to stop by my friend's house, but she called and said she was going to see her new guy, so I thought I'd see my guy.” She reaches a peaking tone on the end, exhibiting positive imposition.
“Well, that's nice of you,” he says and then they have a small pause. “Um, if you want, you can change the channel or something. I wasn't really watching this.”
“Okay.” She proceeds to flip through the channels. She finds her favorite show for the time of day. “Yeah, my son tells me that his girlfriend is going to go away and he's very sad. She's going to college. I tell him that she's got to do what's right. He may see her after college or something.”
“Yeah,” he says.
“He's going to go to college next year. He doesn't know if he's going to the same college. I want him to try to get the scholarship for a bigger university or something,” she says.
“What college is she going off to?” he asks.
“I don't know. I just want him to go some place nice. He's too young to be in love, anyway,” she says.
“Yeah,” he says, as he grabs books off of the coffee table to put away in another room. He returns to the couch.
“At one time, he got a visit from some people, administrators or something, from the University of Connecticut,” she states.
“Yeah. (pause) So what'd they want him for, sports scholarship?” he asks.
“No, academic.” She sustains the tone on “no” for a long time, politely implying that he is quite mistaken with his assumption that the scholarship was for sports. “He has only made one B in all of high school,” she states. The words “only made one” are stated with the same high tone before rising to a slightly higher tone at the beginning of “B” and ending the same word with a lower tone, implying the importance of her son's achievements.
“That's pretty good,” he states, and pauses.
“When he moved away with his father, I told him to keep up his school work, or else, and he did. I told him if he doesn't do good, I'll wring his neck . . . He was always best at math,” she proclaims.
Mark nods his head. He looks to the television to see what is on. She has changed the channel to an entertainment news program.
“Look at that house!” she says.
“Yeah,” he replies.
“Man, I want a waterfall like that in my front yard,” she comments.
“I want the car,” he says.
“I told my father that I'm going to finish school myself. I only need to take a few more credits, about one more year,” she states.

When human beings are in greeting-mode, “small-talk” or problem solving with little resources/information is very common. Greeting mode has a societal-imposed time limit of about three or four phrases per person, per interaction. If someone happens to have a greeting-mode-like topic which could also double as a body-mode-like topic, then it may tie up more time, or possibly assist in a transition between the two modes. Here, Alice begins a non-informational and highly emotional greeting, and she continues with this style of communication for an extensive period of time.

When she asks, “How was your day?” the excessive tone variation bespeaks a character that does not know of the relativity of informational/resource problem solving. For her, this tone variation is necessary to emphasize the emotional aspects of life. She is saying, in effect, “We should relish emotions as much as we can. The reassurance of a societal bond is important,” while not giving consideration to a society-imposed relativity. A common relative quantity of tone variation across this phrase, with this contextual problem solving, does exist, and an AI could provide a reasonable accurate number to describe the level of variation.

When he speaks of his errands, he is proposing a conclusion to greeting mode. This is a statement of almost pure information, with proper relativity being applied to it.

She then asks, “Oh, so what'd you buy me?”—a clichéd response. She could have delivered this question in a reasonable, non-clichéd manner, if the tones were of a normal variance while the whole phrase is undertoned. The “Oh” should be downplayed with undertones. Yet to convey a proper relativity of this response, she would need to make latter statements that shift out of greeting mode and take up more informational topics. Body-mode style topics would need to take precedence in the later responses.

“I just got a little bit of cleaning supplies,” is a response on his part that strongly urges her to change to some kind of relevant, relative topic. The tone variations decrease quickly over quickly stated words, which is a common way of hinting that a topic, or argument, or mode of conversation posed by another should be brought to a conclusion.

When she asks about his car, she finally shifts to a more informational topic, yet her reason for speaking of the topic is for social empowerment—bonding. The connection between her relevant problems and her knowing of the status on the car is likely moot. In observing this scene and compiling a profile on her character so far, an AI would likely conclude that this fact is too many steps into an informational problem for her to patiently follow. The AI would apply a definition of this response that included only an attempt at social empowerment, as opposed to resource/informational empowerment, unless she proves a resource connection with latter responses.

Her next response to his asking what she did during the day begins with the word, “Nothing.” The dictionary definition is not implied with this word. It has a commonly understood, implied meaning of, “Nothing of relative importance.” This would be a relatively good next-best-response. It would not be clichéd, unless it is overused by a single character, because this response solves a reoccurring natural selection problem of exhibiting a respectful amount of personal, relative empowerment. She then speaks of her son, a relevant topic that is due some attention.

After he responds, she speaks of the fact that she was about to visit a friend but chose to visit him instead. This response is of too much irrelevant information. Like the previous two examples of subjects spending excessive time on topics, Alice provides too much information on a single topic.

She is offered the opportunity to change the channel and she accepts. The time is ripe for entering into the body-mode of the conversation, yet she is not likely to sit idle and wait for a prominent informational topic to come into thought. She continues with the facts associated with the subtopic of her “son,” however, the information under this topic cannot be linked with any relevant informational subtopic/sub-problem other than those directly encountered by her son. She is basically relaying the empowerment quests and associated problems of her family member without regard to relativity. Even though this bond between a mother and a son is a vital family bond, even though this bond must be reiterated within a family group, even though extensive thought processes and emotional sensations must reinforce this bond, and even though this bond must perpetuate through the generations because the human race would perish without it, this speaker is spending too much time on this topic. This response is too far removed from an informational/resource problem. There are times when social bonding topics should cease, and academic/informational/resourceful problem solving should begin.

In nature, mammals must keep social emotions in check. An elder wolf will feel a strong desire to express contentment to its offspring and it will express nurturing emotions with passion; yet if the pup receives too much positive reinforcement, the vital life-form problems of observing specific sounds, observing specific smells, and observing specific movement and shapes will not be learned. If this positive socializing became a trend, the wolf population could suffer. Natural selection dictates a level of emotion and a level of dwell time for any particular experience of life. Mammals must keep their emotional, societal bonding in check.

Societal bonds are vital; however, learning the skills needed to solve the problems of natural selection (informational/resource) is an absolute necessity. Many mammalian problems are of extensive numbers of individual stepped problems that must be learned by offspring; and human problems require extensive knowledge of detailed informational topics. Children must often be lead through many informational steps before reaching a crescendo of emotion; and elders should not thwart this process by applying emotion to more trivial matters. Out of respect for the learning process of children and out of respect for those members of society that must labor through natural selection problems for the good of us all, humans should accept a more information-based relativity when forming conversation.

The simple act of patiently observing information to determine if it assists in a resource problem is a necessary part of the learning process for children. Children will often want to rush through these steps or ignore them for enacting a carnal response. To avoid these informational steps is to be carnal. For males, this usually means wishing to engage in more exciting, active, socially-sexual, or socially empowering conversation. And sometimes this means intimidation or violence. Such males would show a preference for movies and television programs that portray clichéd crime fighters who engage in basic fist fights, gun fights, and car chases with cars that explode when crashing. Males who observe sexual experiences without any regard for the need of family structures are being carnal. For females, being carnal could mean an obsession with courtship-ritual problem solving and/or an obsession with empowerment-tracking communications. They may also wish an excessively copasetic world to be exhibited during the child-rearing process. Such females would like movies that portray clichéd love stories (not just good love stories, but clichéd ones) and violence-free children's stories. These are the carnal paths of thought. These genres have a purpose and a place, yet this must be relative to solving more academic/informational/resourceful problems. In building the learning structure within the conscience of a child, a parent must try to abstract beyond these carnal desires. Topic timing must be observed with these social and limited scope resource problems.

For humans in a group, or in this case, a potential mating pair, conversations must be more resource based than empowerment based because it is disrespectful to the needs of others to solve natural selection problems. When an AI records a human response, it determines whether that response was ethical, neutral, or unethical, whether the response was positively or negatively empowering to the speaker and/or recipients, whether the response is more resource based or of an unresourceful-based societal bonding, and whether or not, given the millions of case studies observed, this conversational topic assists the species in solving a natural selection problem. The AI would be able to apply an exact quantity of time that a human should spend on a societal bonding topic, and this time period would be indicative of the need to solve the many sub-problems of natural selection. In other words, information and resources must take a prioritized amount of time in conversation while emotions are kept in quantitative form.

Here is an example of a male who appears to be genetically predisposed to rushing through thought. His responses are carnal; he does not view any abstraction above and beyond empowerment-brandishing as being relevant:
Eric is visiting a friend, Tom. Tom lives with his girlfriend, who is out shopping. Eric comes in the door to greet Tom, “Hey, What's up man?” He states this with loud volume, with a strong accent on “up”, implying a bravado of being an empowered member of a socially active sub-culture.
“Not too much. What's up with you? It's been a while,” Tom replies. The statements are of slightly higher-than-normal tones and volume, implying excitement.
“You know, just working. Trying to maintain. You know I work for that one water company, delivering coolers. Yeah, it's pretty cool. So what's up with you, how's your girl?” Eric says, with higher than normal volume and excessive tone variation. The second “know” is accented heavily-dragged, with a tone variation.
“She's fine, just working and stuff. She's out shopping right now,” Tom replies.
“Good, good, so how about your brother? What's he doing? Still in college?” Eric says, as he sits down on the couch.
“He's alright. He settled down with this one girl,” Tom replies.
“So what are you doing? You still doing the construction, right?” Eric asks.
“Yeah, the same old same old. Been working some long hours. You still living in those same apartments?” Tom asks.
“Nah, nah, me and my girl moved down to Crystal Lakes. We have a little townhome over there,” Eric replies.
“Cool, cool,” Tom says with a small pause. “So do you ever get caught up with any of the old gang, Chris, or Grady, or Rob?”
“Ahh my boy Rob, me and him hang out every so often. The other guys, I don't see too much. You know who I been tight with is Jimmy Wilcox. We hook up and go out and cook out at the park and stuff. Yeah, he's married, got two little girls. You ought to come out there some time. Man, we got the hook up. Rob's the chef. Boy, he can cook up some chicken,” Eric states, continuing with exaggerated tones.
“Yeah, I might get out there some time. I haven't seen Jim in probably seven, eight years,” Tom replies
“I still see you're driving that one car still. Whatever happened to that one Camaro that you had?” Eric asks.
“I sold it,” Tom says.
“Man, that thing was nice. You should have told me. I would have bought it,” Eric says.
“Yeah, I maybe ragged it out too much. I sold it cause I know that it was just going to need more and more repairs.” Tom's eyes glance at the television, following the basketball game that is on.
“What you watching? Duke and . . . who's that?” Eric asks.
“Villanova . . . I just started watching it. Duke's got to watch it. They lost the last two games,” Tom replies.
“They're like number one, right?” Eric asks.
“No, they're number three,” Tom states.
“Yeah, not any more, after that one loss,” Eric says quickly with quick down tones.
They continue to talk about a few various things. Then Tom says, “Hey, pardon me for a moment, I have to check on a roast we're cooking. Are you going to stay for dinner or what?”
“Nah, nah, I just stopped in to see what's up. I want to hang around until my old lady gets off of work. I have to pick her up,” Eric states.
“Sure,” Tom says.
They are quiet for about fourteen seconds. Then Eric gets up from his seat, looks around and talks, “Man, you got your house hooked up nice.”
While checking the food, Tom is glancing at the television. Just as Eric is near the end of his statement, Tom speaks in reference to the basketball game, “No, no, boooyaahh, he got denied!” The “i” and the “ed” of denied are pronounced with sustained, clearly delineated, tones.
“Aaah, you're for Duke man, huh.” Eric accents and raises the tone of “huh.” He continues with exaggerated tones, “Who do you like?”
“I really like UNC, but Duke's alright. Their forwards need to get busy though,” Tom states.
They continue to shift through topics.

With an excessive variance of tones and an excessive volume, Eric's style of greeting urges recipients to join his conversations with the same excited demeanor that he projects. Eric's first question is asking, effectively, “What is the general nature of your being? Are you, and have you been, empowered?” Yet the question's main purpose is to share the excited social exuberance of the speaker with the recipient. Eric's tone on “up” is raised to such a high peak that it details his belief that everyone should be living life to the fullest—aggressively solving carnal problems. Tom must treat the chosen topic with high relativity. And if he wishes to downplay the topic and move to more resourceful communication, Tom must do it with latter statements.

Tom responds normally to Eric's greeting. In simply solving a prompted-response problem, a person will likely not be clichéd, or carnal, or of any other poor etiquette because he or she is solving a necessary, reoccurring life-form problem of enacting good will to others during a greeting.

They continue through a few responses.

When Eric states the phrase, “Trying to maintain,” he is reiterating a response that has been produced and reverberated throughout a society. Like many cultured responses, this phrase is viable for a limited time before it becomes clichéd. It is a phrase that fits rather nicely into a step of an important reoccurring problem. “Maintain” is a word that describes what is often referred to as a “struggle,” which is often in reference to either the adversity of an environment or a desire to act irresponsibly. (The “struggle” is often an exaggeration.)

In defining this phrase, an AI would quickly observe the statistics—the numerous incidents where it has recorded and simulated humans using this phrase—to determine the level of cliché being applied by the educated members of society (and other subgroups of a society). Because educated recipients seek to keep conversations resourceful, attention would have to be given to the particular abstracted step that the phrase satisfies to determine the validity of the reoccurring problem. Let us say that the AI counted 22 times that this phrase was used over a seven year period, and during the last six iterations, seven real human recipients and 85 simulated recipients slowly decreased in the amount of status that they granted the speaker. From these factors, and other precise factors, the AI could conclude that the phrase is, figuratively speaking, 52 percent cliché, 87 percent carnal, and 22 percent relative—a poor next-best-response.

They continue. Eric asks about Tom's brother. A reference to a mutually acquainted peer or, in this case, a family member, is an excellent means of reinforcing a societal bond. His repeating of excessive tone variations is unrelative due to being too far removed from a mindset of resourceful problem solving; however, these responses are valid in their references to common problems.

They continue to speak of many mutual societal bonds, solving a valid problem of observing the whereabouts and wellbeing of these mutual friends. While in greeting mode, people often look to address previously appointed problems, such as buying a thing, moving from one location or another, societal bonds, etc. In this case, the two greeting people have not been in communication for some time, so they are accessing the main problem of restoring the subtopics associated with societal bonds.

Through all of Eric's responses, he remains somewhat relative, yet it is apparent that he wishes not to shift toward informational problems. He speaks of Tom's old car-more of an empowerment tracking problem than an informational problem. He speaks of the basketball game, yet he does not dwell on it for any length of time. The excited demeanor that he exhibits not only prohibits others to break his imposed etiquette and topics, but he, himself, cannot easily transition out of this demeanor. Just as with the previous scene involving the character of Alice, this exchange between these two characters is likely to never arrive at a true, informational-relative body mode.

Eric is likely what the younger generation would feel is a relative character. Because Eric is relative to his group, he is solving the problems that will assist him in gaining status within the group. Females may see him as attractive, and wish to enact (or, at the least, simulate) the courtship ritual. However, this younger generation would only be a subgroup of the whole. And they would certainly be an unrelative subgroup to what the AI would consider as its choice for determining relativity. Eric is of a “focus-group”-relativity, or a carnal relativity, not an “educated-relativity.” Eric's problems assist a small group in their conversational problems—him and those around him; yet these problems are simple short-term positive emotion problems and they are too separated from the necessary problems of life-forms.

The AI's choice for relativity would be that relativity engaged and defined by the educated, civilized free-people of the world—people who talk in a more informational demeanor while applying proper emotions at proper times. The AI would cater to the emotional needs of the Eric or Alice.

People do not necessarily need to aspire to become scholars, college professors, rocket scientists, physicists, or bio-engineers. People do not necessarily need an ability to work through many steps in the informational problems addressed by these professions. Yet throughout a person's first twenty years of development, elders must impose negative emotion when a minor's responses are devoid of information for extended periods. Informational problem solving is a requirement of intelligent beings, whether they like it or not. Fast-paced, stressful problem solving should be practiced in one form or another, such as sports or video games. Slower paced and methodical problem solving should be practiced in one form or another, such as working through mathematical formulas or reading boring yet technical material. Common and emotional responses are acceptable when a societal bonding problem is connected to a natural selection problem through probabilities; however, innovative informational responses must be the bulk of human desires. Responses must fulfill the needs of a society, and time limits must be observed with non-informational conversational problems, including societal-bonding problems and cliché resource problems.

Natural selection problems, and the stepped informational problems thereof, must be reckoned with. Resourceful problem solving must remain an ever-present common denominator to life. Many stepped problems, of many scenarios, can be considered as inextricably linked with natural selection problems. Politics is one resourceful problem that must be given due attention because free governments must be maintained by their subjects. The security of the free world is another resourceful problem that must be attended. Natural disasters must be attended with preparations. For these reasons, the AI's relativity would err on the side of giving informational problem solving a higher priority than the positive emotion problems of humans. Conversational problem solving must reflect these priorities.

Natural selection problems, and the stepped informational problems thereof, must be reckoned with. Resourceful problem solving must remain an ever-present common denominator to life even when times are good, because our freedoms are not free; they were paid for by past generations. Many have sacrificed their lives to make our world. These well known and unsung heroes of our past were not fools; they did not speak endlessly of inconsequential abstraction; they did not trivialize emotions. These were learned people; they knew the value of projecting an educated view; they knew the value of hard work and earning resources fairly; and they knew that their own problems are relative to society's problems. They struggled through life to form our world, so we must thank them by observing a measured educated relativity.

Modern psychology has developed many terms to describe abnormal behavior, such as obsessive compulsive disorder and attention deficit disorder. These are references that apply to genetically predisposed aggressive (aggressive in problem solving) humans. “Bipolar” is one of many terms that describe genetically predisposed, unaggressive humans who form social bonds by seeking sympathy. “Dyslexia” is another term to describe a genetic predisposition in which informational labels are applied too quickly to non-carnal responses/decisions. (Dyslexia is also a partly conditional disorder when informational/resource-embarrassment starts to dictate responses.) Modern psychology has one big problem with these observations of mental illness—modern psychology is ambiguous. Psychologists do not apply precise definitions to discrete fraction-of-a-second increments of human behavior. Psychologists cannot determine, in precise terms, whether a response is of genetic or conditional origin. A diagnosis of one psychologist will not necessarily match the diagnosis of another psychologist; and they do not have a consistent means of determining a therapy. Psychologists might conclude that the characters of Eric and Alice have a small amount of a genetic predisposition to be obsessive; yet this diagnosis would be formed from their general demeanor, as opposed to verbatim, fraction-of-a-second responses. They could not propose a therapy for these characters that teaches them a true, etiquette-bound relativity.

Eric and Alice are obsessive. Yet it is not appropriate to diagnose these characters as “obsessive compulsive.” Even genetically predisposed obsessive characters should not be reminded of their genetic nature. This assists them in leaning on a crutch. Some drugs may be suitable for genetic and non-genetic disorders, but administering drugs, and/or any other therapy, should only be a tool for bringing the patient to a relativity of problem solving comparable to that of other educated people. Such characters should be taught etiquette in a respectful, yet forceful, fashion.

The AI will perform problem solving for the main topic of social interaction based upon achieving empowerment or contentment in the Instructor. Like a child, it will go through periods of mimicry for these offset emotions, it will go through subject-predicate combinations for these offset emotions, and it will learn of larger grammatical structures of sentences while simultaneously learning of relativity. Like a human, it must learn of communication etiquette while engaging in social interaction. This will take a long time. There is much more to communication etiquette and other types of etiquette than what is written here.

Teaching the AI about etiquette is much easier than teaching a child because the AI can be taught these rules unambiguously. With a child, independence remains a vital lesson to be learned; so many etiquette lessons are taught ambiguously rather than directly so as to nurture self-worth. With an AI, the Instructor could teach some of these rules by saying, in some conjunctive form or another, “This is poor etiquette.” The AI will eventually rendezvous with the offset independence attributed to the Instructor, and the human simulations to be formed thereof, but this would be at a much later stage in the development.

Too little etiquette and humans develop excessively broad parameters. Too much etiquette and vital liberties, which produce vital connections to natural selection solutions, cannot be obtained. Humans must follow etiquette for the resources it can produce, and question etiquette for its infringement upon liberties.

These etiquette rules have changed over the past two hundred years. These rules have not changed for the better. Benjamin Franklin, Thomas Jefferson, George Washington, and the many other historical figures of past centuries understood that the rules of communication are linked with the many other rules of life. They were not perfect human beings, but their faults were secondary to the idealism that they expressed to the masses. We are all richer because of these figures teaching us relativity.

The following passage is from a letter to William Lloyd Garrison from Fredrick Douglass while he was traveling in Europe, Jan. 1st 1846.
“I am now about to take leave of the Emeral Isle, for Glasglow, Scotland. I have been here a little more than four months. Up to this time, I have given no direct expression of the views, feelings and opinions which I have formed, respecting the character and condition of the people in this land. I have refrained thus purposely. I wish to speak advisedly, and in order to do this, I have waited till I trust experience has brought my opinions to an intelligent maturity. I have been thus careful, not because I think what I may say will have much effect in shaping the opinions of the world, but because whatever of influence I may possess, whether little or much, I wish it to go in the right direction, and according to truth. I hardly need say that, in speaking of Ireland, I shall be influenced by prejudices in favor of America. I think my circumstances all forbid that. I have no end to serve, no creed to uphold, no government to defend; and as to my nation, I belong to none. I have no protection at home, or resting-place abroad. The land of my birth welcomes me to her shores only as a slave, and spurns with contempt the idea of treating me differently. So that I am an outcast from the society of my childhood, and an outlaw in the land of my birth. ‘I am a stranger with thee, and a sojourner as all my fathers were.’ That men should be patriotic is to me perfectly natural; and as a philosophical fact, I am able to give it an intellectual recognition. But no further can I go. If ever I had any patriotism, or any capacity for the feeling, it was whipt out of me long since by the lash of the American soul-rivers . . . ”

With every utterance, every phrase, every action, every fiber of his being, the words of Fredrick Douglass strike a chord of immense relativity. This is true 150 years later; it will remain true until the end of time. His etiquette with this problem solving is superb. By having a deep understanding of etiquette, at a time when those in conflict only gave attention to the most educated of speakers, Fredrick Douglass produces, with every word, a letter that acts as a building block in the conscience of a society.

He is making a response that is befitting of historical record. He is not clichéd, he is not carnal, and he is not ambiguous. This is a letter to a friend. In reading it, one can sense that whether he is writing, speaking, boarding a train, or greeting a senator, Douglass always stood firm in a relative position with the utmost etiquette. Many speakers of his time expressed many views, such as the most heinous of Aryan beliefs to the most ethical views of human rights, while maintaining an etiquette that exhibited, at the very least, a deep respect for an educated relativity. The only way to address the most serious of arguments during his time was with etiquette. Douglass stood out, not just as a freed slave who spoke his mind, but as an educated man, capable of proposing arguments of incredible truth.

Relative Declarations and Questions

When would the AI believe a particular fact being stated by a human? How would the AI define the communication? To apply the proper probabilities requires that the program determine the speaker's motives for making the statement, and the distinct problems being attempted. A statement can be deemed either informational, or social, or a combination of these two characteristics. If the statement is more social, it can be considered a good next-best-response if it adheres to the rules of conversation etiquette. If a statement is more informational, then the informational problems being addressed must be checked against sound statistics and sound scientific discovery. An informational statement can be considered a good next-best-response if it is a relatively true statement, it follows the rules of conversation etiquette, and it follows the normal paths of human thought and problem solving. To judge a statement as being relatively true, the AI must determine that the speaker is trying to gain empowerment by fair means, and that the statement is helped, rather than hampered, by an emotionally-driven decision-making process. If the speaker's demeanor appears truthful, and the statement solves a fair and logical problem, then the AI may use the human's fact in larger thought processes. However, the more important the decision, the more verified the underlying facts must be; and the AI will only use the fact in limited-scope decision making.

Humans make declarations for the sake of gaining empowerment from the communication first, gaining empowerment from solving or assisting informational problems second, and then gaining solutions or assistance to resourceful/informational problems last. Because the informational topics of communication are subservient to the superior topic of “social interaction,” the AI will determine the relativity of social empowerment first, the relativity of empowerment solutions from informational problems second, and the relativity of solving informational/resourceful (consumption, reproduction, and peripheral) problems last, unless these problems are imminent. The information side of a declaration does not have to be present. To gauge relativity, the AI must make thousands, possibly hundreds of thousands, of comparisons with other humans, both experienced and simulated, making similar comments, during similar modes of conversation, of similar characters, among similar recipients, of similar trains of thought, to solve similar problems of social empowerment by communication, at the time of that communication.

Consider the following statement of an informational topic:
“This statement is a false statement.”

In witnessing this statement, an AI would recognize the human's attempt to solve empowerment problems first, and the AI would attempt to solve the informational problem second—with time limits relative to the AI's other problems. If this human states this to test the AI for a reaction, the human will not cause the AI to burn circuits or become engulfed in a never ending loop because the informational problem is a subtopic/fact/function of “social interaction.” All information problems are subservient to the social empowerment problems of an individual (unless a resource problem is imminent), and that individual's social empowerment problems are subservient to a society's consumption, reproduction, peripheral, and emotional problems. Like a human, the AI's informational problems are secondary, subordinate functions to the social empowerment of the speaker, and the society's need to solve the primary life-form problems.

For each sub-function, there is a timer. An AI will set this timer before it takes on a problem. In general conversation, producing a good next-best-response usually does not take more than five to ten seconds. If the human pushed the issue, the AI could take longer, yet there will always be a limit. Like a human, the AI could observe characteristics of an unsolvable problem without going crazy. Like a human, the AI has a limited time to dwell on a single problem. More pressing life-form problems will become imminent. The AI could observe characteristics of a paradox without being engulfed by it because the ambiguity of a paradox is outside of the reality of human problems and human parameters.

Comparable lines of thoughts, of similar humans, in similar social situations, solving similar problems, will be deduced by a human as he or she narrows the possibilities of a response that exists within his or her own character. From this character, formed from genetics and conditioning, a human produces a relative next-best-response in a given situation. That next-best-response could solve either a mostly social or mostly resourceful/informational problem.

Comparable lines of thought, of relative humans, in similar social situations, solving relative problems, will be deduced by the AI as it narrows the possibilities of its own response. From this huge backdrop of human possibilities, the AI forms its pseudo-conscience to produce a relative next-best-response that is appealing to the recipients. This next-best-response could solve the recipient's mostly social or mostly resourceful/informational problem. This response will have an appearance to a human as an educated human response, if that human were acting as an AI, unless the owner wishes another type of abstracted human-like character (within the Instructor's parameters). This response will work to build the knowledge of the recipients and the AI, empowering the recipients, and assisting the AI in future responses/problem solving.

Whether or not a statement is informational, emotional, or a little of each, a person's purpose is almost always for socializing the information. Virtually all of a person's lingual knowledge is obtained and used for processing for the purpose of gaining empowerment from communication, at the time of that communication. Here is an example of how humans seek this empowerment from a series of utterances:
Brian and Neil are roommates. They are sitting and watching television. They are quiet for some time. Neil is glancing at a book and watching television at the same time. While Neil changes a page, Brian chuckles at something he has observed on television.
Neil puts his attention to the television and begins to smile, implying agreement with Brian. He did not retain or process the joke that Brian witnessed. The actors go through a series of comments before arriving at the next joke of the scene. Then Neil chuckles at the next joke while Brian only acknowledges it with a smile and slight chuckle.

Comments are generated based on the rules of turn-taking. Small utterances are also performed in turn, while characters brandish their acknowledged informational and emotional facts. Here, Brian laughed at an event. Neil missed it, yet he laughed at the next available event. This is a common series of actions in which the participants seek social empowerment from the mutual empathy of other human beings by taking turns with proposed topics (or social utterances). This kind of turn-taking can be found in many instances, and in many other forms, of human interaction. It is as if Neil is saying, “You have empowerment and status with your acknowledgement of a humorous action, and now I find this funny. And I like to laugh at these kinds of things as well.” Empowerment drives turn taking. Neil is gaining empowerment from the laugh, empowerment from sharing the humor, and empowerment from the act of communicating.

The AI could log this chuckle as, figuratively speaking, “human is socializing a determined preference that is similar to the recipient's preference for social bonding and the social empowerment from communication.” The following statement is mostly informational. If made in general conversation, this statement could be logged as, figuratively speaking, “a mostly informational statement being presented for social empowerment, from the communication”:
“Ford trucks are geared lower than other trucks,” Matt states.

Social empowerment from communication is the superior topic/problem being addressed by this speaker. Virtually all humans, during virtually all conversations, with virtually all statements, seek this empowerment from the act of communicating. When hearing a statement, the level of empowerment being attempted by the speaker is logged by the AI. The level of relativity implied by the speaker is logged. These characteristics affect the probabilities tied to the information. If, for example, the human appeared quite excited while making this statement and/or if he used extraordinary tone variation, then he could have assembled this fact from previous experiences based solely on the empowerment gained from communicating the information. He could have possibly heard the fact one time from an unverified source and considered it to be true. The empowerment associated with the act of communication is such a powerful driver of human thought that the speaker may have failed to take necessary steps to determine if the fact is true, or he could have invented the information for the purpose of acquiring empowerment from communication.

If this person is stating that Ford trucks are geared lower because he is adding to a relatively useful, common, and well-timed topic of conversation and this fact is considered true, or relatively true, based upon other information gathering, then he is successfully gaining empowerment from speaking of the information. If this criterion is met, the speaker would produce an empowering/positive/correct next-best-response, and gain credibility among the other participants. Then the speaker would satisfy the first topic/goal/problem of social interaction.

If an AI were to make this statement, it would have to be adding information to a relatively useful, common, and well-timed topic of conversation; the lower gear ratio would have to be verified by reasonable means, and the AI would have to foresee the possible scenarios where this information could help the humans in later problem solving. If this criterion is met, the first topic/goal/problem of social interaction would be satisfied by the AI.

The speaker can still solve this conversation-empowerment problem even if the statement is false. If the recipients of the smaller group are conducive to the false response, they can grant empowerment, and they can also relish the mutually gained social empowerment from the acknowledged fact. In some situations, the truthfulness of a referenced fact can be of such a secondary purpose that it is of little relevance. At times, the empowerment of individuals can lead those individuals, and larger groups, to determine that a scientifically verifiable fact is a matter of perception.

After gauging the human's social empowerment from the act of communication, the next test is the human's motivation to gain empowerment from solving problems with the information in the communication. This topic/problem is a sub-problem, one tier below, the superior topic/problem of “social interaction.” Any empowerment gained with the information side of this problem is weakened if it is not positively received by other humans because the other humans know it to be false, partially true, unfair, or of little consequence in the current conversation. Is the speaker a car salesman? Does the speaker own Ford stock? Or does he own Chevy, if he feels that this statement imposes a negative thought process on the part of the recipients toward Fords? Or does the speaker know this fact, if it is true, to be useful to the recipients?

Sometimes a person will make a statement and imply that it is a general comment for perpetuating the conversation when he or she is trying to solve this second-tier topic/problem that is not being relayed to the participants. Let us say that this comment is being said by an entrepreneur at a dinner party in which he is hoping to find investors for his company that supplies parts to a transmission manufacturer who, in turn, sells transmissions to Ford. If the speaker makes the statement to form the opinions of recipients without revealing his desire to gain investors, then he would be trying to solve two problems at once while implying that the second, unmentioned problem is not a part of his thought processes concerning the comment. Unless a competitive demeanor is mutually understood between the speaker and recipients that includes this kind of dual purpose (some situations warrant this type of problem solving), the speaker would clearly be breaking a rule of ethics and etiquette. A dinner party is a loose environment; comments are considered to be of the topic of “general conversation.”

Because of the many ambiguities of current conversational trends, declarations with dual purposes are common. Advertisers often imply that their product solves a particular problem when that problem is too ambiguously connected to the product; for example, a commercial where a cell phone company implies that their cell phone service “helps families stay closer together.” The advertiser and producers of the product are trying to sell a product to gain a profit. It is ingenuous to imply, excessively, that this product is an overwhelming contributor to the forming of a family structure. News organizations often imply that a story is of relative importance when it is not, such as when large letters appear on the cover of a news magazine to describe a sensationalized event. News organizations want to sell a product. It is ingenuous to claim an excessive relative importance of a news story that is not of a proven, educated relativity. Political organizations will challenge the opposing party's etiquette (and sometimes ethics) while ignoring etiquette themselves when the time is right, such as when one President has illegal, “scandalous” activity occurring under his administration and the opposing party demands an investigation. The party holding the seat always defends, the party challenging the seat is always accusative. It is ingenuous to claim that a rule has been broken when the rules change for each opposing group, and the real goal is defamation.

Any purely informational solution to be gained with this statement would be a third tier topic(s)/problem(s), subordinate to empowerment problems with information (second tier), and empowerment problems with the act of communication (considered first tier, unless a resource problem is imminent).

In just a few seconds of observing a human's actions, gestures, facial expressions, body movements, volume and tone variations among words, and in just a few seconds of observing a human's implied meaning of words, statements, topics of conversation, and conversation etiquette, an AI can determine whether a human is displaying a reasonably honest, ethical, and empowering character. If such a human made a statement, “Ford trucks are geared lower than other trucks,” the AI could safely build decisions upon this fact. It may not be true; however, the AI will not do any serious problem solving with this fact until it has a chance to verify it further, by multiple human, blind-human, or non-human means. The Instructor and the design team will instill this process into the program. A human could also be delegated as being an educated person by the Instructor, or through a chain of delegated, trusted humans leading back to the Instructor. This is a trusted human that knows of the consequences of a false statement. From the beginning of interaction, a college professor could be given credibility by the program. This would be similar to one human greeting another of a credible background and accepting their statements as likely true.

The tone variations that occur during communication play an integral role in defining the communication. Here is an example of a basic informational statement that has varied definitions based upon tone variation:
“Well, I always take I-54 to work.”

The main purpose of gaining empowerment, from the communication, at the time of that communication, would be the first consideration in defining this statement. The empowerment achieved with problems being solved by relaying the information would be second. And any assistance that the speaker gains from the recipients with the referenced informational problem would be a third purpose behind the statement. Since this is a fairly bland informational statement, the superior topics of the communication would likely give way to observing the raw information associated with the main informational topic of “relocating from home to a place of employment.”

Yet this bland informational statement and alike-informational statements could have myriad additional meanings when the tone, tone variations, and volume variations are observed. In their more prevalent exhibitions, the use of tones can make the informational topics quite moot in light of the social empowerment problems being addressed by the speaker. These tone variations have precise society-born definitions.

The society-born etiquette, as taught, recorded, and tabulated by the AI, has a specified volume, a specified tone, and a specified tone variation for each syllable uttered by the speaker relative to his or her culture and the contextual events (quiet conversation or boisterous); and the speaker would have to abide by these rules of etiquette to be received with credibility by educated recipients. The most benign imposing of positive emotion would have a tone variation of little deviation. A peak would occur on “I-54” with a much smaller peak on “I.” If said with these tone variations and a slightly lower-than-normal volume, the speaker would be implying, effectively, “Well, I'm not sure, but I believe that I have pertinent information involving a problem-solving procedure. I think I've come to this conclusion with good reason, and I believe it is of relevance to the current conversation; yet you could challenge me, and I may yield if I am wrong.” Such a speaker would likely be quick and quiet with the starting word, “well.” If this speaker is staying within the parameters of the current conversational problem, and the statement is in agreement with the parameters of the many subordinate and superior problems, such as speaking with an exact, proper decibel on each tone, then he or she could be performing a good next-best-response.

If the “I” were presented with a strong peak with a shift in tones across the single syllable word, the speaker would be implying, “I have an informational problem-solving procedure that I know is right, and you should take attention to it because your informational problem solving on this issue is lacking.” If the speaker were to continue with other informational statements while emphasizing the “I” then the speaker would be implying a theme of, “I generally know how to solve problems that you don't.” If the speaker wanted, he or she could emphasize the conclusive nature of his or her derived fact by pronouncing the latter words of this phrase quickly, with descending tones, leading to a very low tone on the ending word. If the word “I” were peaked, yet it was not sustained long enough to achieve more than one tone, then the speaker would still be imposing his or her empowerment in an unethical fashion, yet this negative imposition would not be as strongly emphasized. The word “well” could have tremendous weight in the recipient's implied meanings. If it were said with a sustained tone that rises on the end to meet a high “I” tone, then the speaker would be implying, “The information or informational problem-solving procedures that you have mentioned, or implied, are not with the recognition of the fact that I am stating.” This particular tone variation could be varied in many ways to emphasize the different parts of this implied meaning.

Different elements of the information could be accented with different tone variations. The time that the tones are sustained also alters the proposed relevance of the implied informational elements. If “well” is peaked, instead of “I”, it emphasizes the relative importance of the shifting to a new informational topic rather than emphasizing the information itself. If “always” carried a high peak on the first syllable it would imply the importance of repeating the problem-solving procedure. It would sound odd if “take,” or “I-54,” or “to,” or “work” carried a peak, but this could happen to emphasize different, related informational topics. “Work” would be an odd word to have a peaking tone because ending words usually carry a tone that details whether the topic is concluding, near conclusion, prompting recipients for additional information, or sustaining a topic. To point to a related topic of “work,” this would most likely require a new sentence that shifts to that topic.

Certain tone variations and certain facial expressions could reveal this statement as a possible lie. If the speaker performed an abnormal tone variation, one not falling into place with the implied meaning just mentioned, or if the speaker sustained a tone longer or shorter than normal, or if the speaker stared in an abnormal way during a sustained tone, or if the speaker broke a glance by looking down at a peculiar time, this statement could be dishonest. However, the AI or a behaviorist would be in error in assuming that these signs reveal falsehood. If someone knowing of these dishonest gestures is asked a question in which their actions would be scrutinized to determine honesty, he or she could easily stumble while trying not to make these gestures. His or her answer could be quite honest, while the gesture is interpreted as a sign of dishonesty. We should not look to find these gestures, and behaviorists should not make inferences to their meaning except with the benefit of doubt.

Consider a chat line conversation with a fact such as this one being delivered from one entity to another. Any of the aforementioned, implied meanings would have to be explained somehow through the chat line (or promptline) by additional statements or symbols for the recipient to understand their presence. Humans learn of their world through audio and visual stimuli before communicating through a chat line, so a mutual understanding of all facial expressions and tone variations is understood by the participants when they determine a means of communicating them in this interface. Humans understand the motives of other humans, so a developed symbol like “lol” is understood with a little coaching from one communicator to another.

The AI will be taught of its world through a promptline long before it acquires audio or visual capabilities. So like a human, the program must have explicit details of social interaction conveyed, somehow, someway, through this interface. The design team would need to explain, unambiguously, the tone and volume variations, facial expressions, body movements, and all other human actions used by humans to solve conversational problems. Audio and visual capabilities will be obtained by the program, yet this will be after many years of learning of those things that it cannot see or hear. Like a human, the program will not be surprised by any chat-room symbols that replace communications normally delivered through sight or sound because it will know of all the audio and visual techniques used by humans to convey meaning. The program will comprehend every aspect of human communication, and the limited interface of a promptline will only hamper the human, not the AI.

This informational problem is a mathematical word-problem in vague form. The understood goal when traveling through traffic is usually reaching a destination in the shortest possible time (other goals are saving gas, enjoying the ride or scenery, etc). A “beeline” is helpful, yet one usually has to take into account that too many stoplights can affect travel time. Probabilities must be applied to the number of cars at different periods, the stoplights, the speed limits, and many other factors. When it is all said and done, a stopwatch can verify these calculations.

Humans arrive at solutions because emotions drive them through a process. Mathematics is an afterthought, a tool for this emotional means. An ambiguity of the math is often present because empowerment (from communication) is such a powerful driver of thought. “Traffic” can be a hot, emotional topic among people; and many different people love to tell of how they have mastered traffic problems, usually with a correct mathematical solution. However, when they are of an incorrect solution—a solution proven wrong by clearly unambiguous mathematical means—this can be met with strong resistance by the speaker. In many instances, humans will consider the math to be erroneous when it challenges the empowering solution to a problem, regardless of the numerous verifying methods.

In recording this phrase, the AI would recognize it as being one of possibly a hundred common variations from low to high volume, from low to high tone deviation, with tone shifts occurring at different locations, and with the different sustained times across these tones. It would record an exact account of the mutually understood definition of each and every one of these characteristics and apply these definitions to an exacting portfolio of verbatim, fraction-of-a-second actions of the speaker. The AI has a clear understanding of what is happening when a human speaks, and it has a clear understanding of how the statement, or any fraction-of-a-second action, further shapes the human character.

Here is an informational statement that attends a relative problem with relative information:
“You (someone) can make a lot of money in designing Web pages.”

Unless this human diligently assembled statistics on the amount of jobs being produced, and the salaries being paid in this line of work, this fact would likely be quite tentative.

Relativity is associated with determining what “a lot of money” is. This relativity is dependent upon the recipients perceiving the average salaries of Web designers as “a lot of money.” If, for example, the speaker was thinking of a salary of forty thousand dollars a year, then it is likely that he or she is referencing what is commonly considered as a lot of money; however, those with college educations would likely consider this as the lower end of desirable salaries.

If the person making this statement does not have a clear desire of gaining empowerment from the information in the statement, he or she is surely driven by the empowerment of social interaction by the act of communicating, at the time of communicating. This would be simple pride from the mutual bonding of sharing information. However, each statement is bound by the rules of conversation etiquette and empowerment from social interaction will not be gained if the statement is out of context; that is, if the response does not pertain to the specific problems that humans are attempting to solve with the current conversation. For example, if this statement is the first of a new topic, then it must be a relatively good choice for a new topic, and it must be relative to other chosen topics during alike trains of thought. If this statement is made during a current topic such as “salaries,” then it must be a good, relative subtopic, relative to other chosen topics in alike lines of thought. It could follow a conversation about the Internet, if the recipients were conducive to the topic shifting to a sub-problem of “making money.”

A topic always has a discernable telltale ending sign that is usually of a particular tone variation. If an entire topic begins and concludes in a single statement, offering a trade-off in conversation, then the tones will usually rise from the beginning and drop to an ending low tone that is relatively understood to mark the conclusion. If the topic is not concluded, then the ending tone is higher, prompting a response by others to contribute to the same topic. Sometimes a topic ends on a low tone, but not the “concluding” low tone, proposing an end to a subtopic of a superior topic that is still waiting for that low tone (generally). Topics also end when a human prompts a statement with tone variations that move up quickly and then bounce on a concluding low tone for several words, implying, “Yes, you're speaking of a thing that we are acquainted with. Let me propose a new topic,” or similar tones that imply, “And this topic you're speaking of solves the problem of . . . and there's not much more to say about it (based upon the relativity of time to be spent on a topic).”

If this statement is true (relatively) and it follows the rules of etiquette by contributing to a well-planned, resourceful, current topic, then the AI can build tentative decisions of limited scope problems with this human's statement. It could inform another human at another time that, metaphorically speaking, “I have heard that one could make relatively good money in Web pages, but I have not researched this information myself.”

The following statement can be considered almost exclusively social in nature:
“He's just mad because she didn't want to talk to him.”

In observance of this statement, the AI would recognize that the speaker is airing a fact about others in a group of acquaintances in order to gain social empowerment (of communication) by tracking the empowerment of others. This is a more emotional/social statement rather than informational because the monitoring of other social members only provides social solutions. The utterance does not produce food or assist in procreation. Although it may reference the mating ritual and possible courtship etiquette, any reproduction problem solved is clichéd and carnal because the monitoring of mating rituals is too simple a task. To truly address the informational side of reproduction, one must either be having sex for this purpose, or attend the eighteen-year learning process of a child, which consequently requires more academic, intellectual statements.

This is likely a statement of younger people. Adults may state something such as this as part of a more serious relationship-type problem while recognizing the need to apply undertones; adults (educated relative adults) would not seek to dramatize this topic of emotion. For young people to propose this topic for the purpose of drama is clichéd. It is carnal. It is not resourceful. Participants on a daytime talk show may state this, thinking of it as serious, when they are actually just making an implied meaning of seriousness for social empowerment at the time of communication. Given the relativity of life's problems, this is not serious.

A human's desired acquisition of a next-best-response is tested by recipients—the observing group—that determines if it is a proper next-best-response. A smaller group may find this statement relative to their conversations. Yet the smaller group and the individual embody smaller realms of relativity. In hearing this statement, the AI would run simulations to see if society—the larger group—can benefit from an individual generating this response. From this processing, the program can determine if the next-best-response is relatively positive to all, or a few, or whether it is of limited scope. If this statement is being stated by a juvenile among adults, it is likely viewed as negative or even foolish. If it is being stated by an adult about a non-serious relationship, it is likely to be viewed as negative by other adults. If it is being stated by an adult about a serious relationship, then it could be viewed as a positive means of sharing information to solve a problem, granted that those humans are in a position to assist with the problem. Some groups of alike-humans would value the social empowerment of this statement, but most would not.

There is a test of relativity. The relativity of a chosen topic of conversation must not be based upon pleasing the masses. A proposed topic must be an appropriate choice for all of society's needs to solve the basic problems of life. Social problems/topics must not abstract too far from the resourceful problems of the human species; and they must not be dramatic for the sake of indulging in drama. This statement, if for the sake of social empowerment at the time of communication, is a blatant carnal and clichéd response for following the empowerment of other humans (“him” and “her”). This statement, if made for trivial reasons, is non-resourceful empowerment tracking, like lower members of a pack of wolves observing a dispute between another beta or alpha male and their mate.

A human may propose an unresourceful, odd, or shunned topic; yet this must be understood as an expression of liberty, and this granted liberty is the only surmised means of assisting a society. Humans have rights; however, these rights observe a parameter placement that is outside the realm of an “educated” relativity.

In our current times, blatant empowerment-tracking expressions are common. Conversations were not always like this. In the 1950s, the liberties granted to teenagers in America, granted partly from an expansion in adult liberties, led to the development of a new branch of music, rock and roll, and many other new types of abstracted behavior that changed the demeanor of conversations. The strict etiquette of elder generations was properly challenged and new observations of relativity emerged. This led to the many liberal views of the 1960s where etiquette was quite lax. Liberal viewpoints waned in the 1970s as the more liberal generation began to develop families and accept some structure to their problem solving. In the 70s, informational and resourceful problems were a major part of all conversations because the structure-oriented nature of adults combined with a new structured, yet still liberal viewpoint of the younger generation.

In the 1970s, art and science ruled behavior. Embarrassment from informational/academic problem solving was practically non-existent. The teenagers, although being unruly at times, were quite grounded in a fairly universal behavior that shunned social empowerment born of clichéd means. An educated relativity was present in virtually all general conversations. Since the 70s, the knowledge base of younger generations has been steadily declining.

Here is another social statement:
“He doesn't love you, he loves me!” A guest on a talk show states this in reference to a boyfriend.

This statement is being made for the social empowerment of communicating the information, and the second-tier problem of claiming a right over a mate. The information delivered addresses a topic of reproduction, the mating ritual, and rivalry over a mate; yet this information is moot in the light of society's larger problems because televising the response serves the social interaction problem almost exclusively. The participant of this talk show is working with the show's creators to impose the relativity of her problem solving, and her demeanor, onto the viewers.

The speaker is unaware of the cliché-ish, shallow, carnal nature of both speaking of the mating ritual and extrapolating the simple problem of telling her mate to choose one or the other. The fact is that when one speaks to a rival, who is irrelevant in the choosing process, the speaker is entertaining this confrontation rather than avoiding it. She is not seeking to solve the resource problem; she only wishes to talk about solving it. If she wanted to solve the problem, conclusively, then she would give her mate an ultimatum.

The fact is that “who he loves” is not relevant to this speaker. The information is not relevant. That's not why they are on television. If this female were to leave her boyfriend and find someone who is faithful, she would become bored quickly and start to look for a new, troublesome boyfriend. If she is lucky, she might appear on another talk show.

This statement is missing good, superior sub-tier topics. Over the past two decades, the trend has gone from thinking and speaking of more informational topics with depth, to indulging in the more basic emotional problems, such as the mating ritual. The guests on these kinds of talk shows are not typical; yet many continue to view this kind of scenario without recognizing that it is clichéd. These talk shows are an indulgence in an unintelligent, unabstracted, carnal behavior that affects the conversational trends of all of society. There is no art in this entertainment. There is no relevant information in this entertainment. It does not assist society in any way. Although it involves a basic problem of reproduction, that is all that it involves, and this is with completely wrong etiquette. The participants have no recognition of the need to speak of these non-informational problems with subdued tone variations so as to solve a relevant problem; they only wish to indulge in raw emotion of limited carnal abstraction. An AI would not condone this behavior.

Psychologists are more inclined not to criticize a human's etiquette and behavior because of their view of larger outer (and ambiguous) parameters of a free society. Because there is currently no acknowledgment by psychologists that thought processes originate from the act of communication at the time of communication for social empowerment, some psychologists might join in a social conversation to give advice on how to solve the stated and implied problems. Some psychologists actually appear on these talk shows. Such involvement disregards the foolish, non-academic, non-informational nature of humans speaking of these problems and sensationalizing these events in front of an audience. In being a part of such a conversation, a psychologist would be addressing the information in the communication while actively participating in the social empowerment gained from the communication. They would be an unobjective participant in this carnal conversation.

Certainly, we must value the production of all human behavior for its testing of parameters. Shows where humans speak of things that they did not speak of before should have their subject matter reviewed. Then their abstraction must be deemed either relative, in need of further testing, or not relative. Hopefully, these shows will be seen as too much of an assault on relative etiquette and too much of an indulgence in carnal/mating ritual scenarios.

In determining the relativity of a response, a behaviorist must narrow down the specific problems of the human making the statement and the specific problems of humans that would criticize the statement. Which is the larger group? Which is the more authoritative (with determining parameter), educated group? The next-best-response of a human, an AI, or any life-form should be helpful to the species first, and the individual second. A response should be innovative and it should not be clichéd. Etiquette with conversation and the etiquette with overall behavior must reflect this. Such a human, on such a talk show, making such a statement is helping society by exploring the liberal parameters of human behavior. Humans should tune into this show and revel in their socially empowering means of airing a reproduction/sex/social problem. These shows are innovative—in the beginning. Yet as time goes on, this next-best-response must be considered as an old-clichéd-response. The testing of the parameters has been contemplated, and the value of these shows has ceased. In solving human problems, the AI will look to appropriate actions as well as the more liberal schools of human thought in just the right balance. It will see value in anything new, but with time, these new schools of thought must fall into place under the relevant, reoccurring problems of life-forms.

When observing the parameters associated with human liberties, of what is relative, appropriate, and ethical, one must imagine a hypothetical no-parameter situation. This is discussed in greater detail later.

Humans trade facts in mild form during conversation, and they trade facts in more competitive form. They will sometimes seek a solution or preponderance of an informational problem, and sometimes they seek a raw emotional problem. Even when speaking of a plain informational problem, the goal of empowerment from communication can be considered the main driver of thoughts. Information is often used as a tool for coming to an empowering conclusion. Here, a couple is disputing what a comfortable temperature is. They are ambiguous in their means of handling information:
“It's cold in here,” is a response that Martin directed to his girlfriend many times with quick descending tones.
She would disagree, “No, it's hot in here,” with quick dropping tones.
“I don't know. I'm freezing. Let me turn the AC up a little,” Martin states.
“Okay, but I'm burning up,” Sharon responds.
This interaction of this topic of “temperature” occurs five times over the first six months of their seeing each other and moving into an apartment together. This is another example of another instance:
Martin and Sharon are at home. They speak through a simple, common conversation when Martin drops to a subject-ending low tone as he rises from his seat. He ventures a little slowly down the hall toward the thermostat as Sharon catches him, “Noooh, pleaaase, it's hot.”
“Just a little, come on,” Martin pleads.
At one point, the tables turn. The couple goes to a dinner party being held by friends. They eat and mingle with the guests. The men and women of the party form into their common subgroups. Some go outside, some stay in. Sharon and Martin meet up so as to say goodbye. They begin to walk out to their car.
Once outside, Sharon gestures that she feels cold. “Boy, they have it cold in there.”
“Really?” he says. “I thought it was fine. That's what Darren said also.”

We have all come to conclusions on our individual preference for a temperature. Temperature is detected as good or bad, comfortable or uncomfortable, by nerve cells throughout the body. Over time, most subjects can determine their genetic preference for temperature, such as, “exactly 71.52 degrees,” and this will vary for an individual through different times of the day and with different, internal physiological effects. We have all come to conclusions about what might be a bad smell. The olfactory glands detect particles in the air and send a signal to the brain. For an individual, these smells could be charted to precise, molecule for molecule, detail; and an AI printout could describe this genetic preference. We have all come to conclusions about what foods taste good. The taste buds collect the many sensations of taste, sending them to the brain through nerves. Everyone has a fairly distinct genetic preference for foods—detectable, tangible, and recordable on a human-to-human basis. These preferences vary from one individual to the next, and they can be averaged to determine a common societal preference. Yet any determination of an AI would not be a result of perception; an AI's determination of a preference would be a result of clear, scientific discovery.

To blindly imply that a personal preference of temperature is based upon averages, when it is not, would be impolite—a mildly unempathetic action. It would not be right to think of one's self without regard to the preferences of others; or at the least, that a relative, statistically-proven preference exists. For some characters, this may be an indication of a larger blind spot in comprehension. A societal preference is not necessarily the right choice. Temperature is likely something that should cater to the current subgroup by averaging their preferred temperatures. Yet the conversational problem solving, and the subordinate empowerment problems, of an individual should not be too relative to that individual.

Martin and Sharon are ambiguous about how to choose a temperature. Their communications have an underlying theme that a choice in temperature is a matter of perception, and that no one can directly describe this phenomenon of differences between individuals. Both of them are viewing the problem from a moderately self-centered perspective because they feel that the opposing social member's perception is flawed. When Martin says, “It's cold in here,” he is implying, “society has a genetic preference in a temperature that is warmer than the current temperature in this room.” It is not likely that he has assembled statistics or arrived at a mathematical conclusion of this preference. Implying that one's preference is the same as society's, when a basic assembling of verbatim, positive and negative references has not occurred, is a breech of etiquette. The statement could be a better response if he were to say, “It seems cold in here,” or, “I (high tone, but not too high) think (low tone) it's cold (high tone) in here (medium tone).”

In the beginning, they are simply stating preferences and choosing to impose emotions upon each other to sway the thinking of the partner. Their responses appear to be genetic in origin because of their consistent disagreement. At one point, he appeases her temporarily by saying, “I don't know, I'm freezing.” This implies, “I could be wrong with my determination, but I believe.” Then he states that he wants to turn up, and will turn up, the air conditioner. Yet their different views of temperature changed when leaving the dinner party; he seems to be stating a belief in a preferred temperature that is in contradiction (apparently) to his previous genetic-born preference.

The reason why someone would go against their own genetic predisposition of a preference is social empowerment. Martin likely carried on a conversation with his friend, Darren, who commented about the cold house; and Martin imposed social empathy to the host of the party by disagreeing. He may have presented Sharon with the same social empathy by implying, “These temperature differences that we all feel are not important.” This is one possible type of positive imposition being communicated by Martin for mild social empowerment.

Another kind of empowerment gained by being contradictory could be negative imposition. Martin could have implied, “Your perception is not right, and I am determining a proper belief that the temperature was normal. And in all the other instances of our differences about temperature, I perceived normally, and you did not.” If this were the case, it would appear that the boyfriend has fallen into a habit of disagreeing for the sake of disagreeing-a proposing of fact for the empowerment of negative imposition, not the exhibiting of a verified scientific or mathematical discovery. Siblings do this. Close social members do this. One telltale sign of this imposition is the use of quickly pronounced words, with dropping tones, so as to propose a conclusion to the argument.

Another underlying reason for a contradiction is that once a person has made a stand on a particular argument, the speaker sees a loss of empowerment occurring if he or she relinquishes that proposed argument, despite the topic being trivial, despite the argument being formed for the social empowerment acquired at the time of that communication, and despite overwhelming scientific verification. Martin, during the first few milliseconds of this topic being raised by Darren, could have concluded that a determination of the temperature problem must be made with empathy to the host. Regardless of whether or not this belief was formed on a whim, his next thoughts could have been, figuratively speaking, “Well, Sharon and me often disagree on temperature because of empowerment differences. And I must protect my empowerment by sticking to this argument.” Many characters of western societies, born of strong desires to achieve empowerment from the act of communicating, have vast portions of their conscience formed upon stepped problems and decisions leading back to these arguments formed on a whim.

If two scientists were to speak of an informational problem, they would likely give credence to the need to have a clear goal and a clear means of reaching that goal without the influence of human emotion. To come to a conclusion of a common societal preference for temperature, they might take a carefully orchestrated, unbiased, blind poll. Such a poll would have to take into account that some subjects may have other purposes for choosing a temperature rather than personal preference; and ideally, instead of verbal confirmation, those to be questioned should have their gestures observed to see if they are fidgeting cold or fidgeting hot. If a manager of a large hotel wanted to determine a comfortable temperature, he or she would likely observe a statistical accounting of people's opinions of temperature to determine the clear temperature goal of guests. This would satisfy the natural-selection, resourceful goal of revenue for the hotel—not an emotional goal. A hotel manager would likely take into consideration the need to err on the side of providing a colder temperature to counteract heat from equipment, and a belief by most patrons that garments can maintain warmer temperatures for those of warmer tastes.

When an informational problem becomes mixed with a social problem, it is often difficult for people living in western societies to apply objectivity. The mere mention of statistics or relativity can be an insult to an individual. Empowerment is such a revered emotion that humans generally try to protect it, ensure it, and dispense it at all cost. Consider the Thanksgiving holiday. If a turkey is prepared that is terribly dry, the host may mention a small comment about it but refrain from a full admission of the mistake. Guests would likely keep quiet and try not to choke. Yet if everyone were to acknowledge the mishap and consider it as a light-hearted learning experience, and consider that the empowerment of making a festive dinner is relative to many other aspects of life, then they would all be richer from the experience rather than placating a false sense of empowerment. Statistical observation and informational processing prevent dry turkeys just as they can prevent misconceptions of relative, comfortable temperatures.

In the previous example of the two subjects choosing a different preference for temperature, information was reasonably debated, yet when social empowerment became a prevalent goal, the informational problem was altered to suit this purpose. This can be viewed as an informational-social problem that is a subtopic to the “social interaction” occurring at the interface of the spoken language. And the actual information, the physiological sensation of hot or cold, is a third-tier subtopic. The empowerment of communication can still be considered the primary goal.

Here is a statement where one person is describing the preferences of other people. He is trying to dictate human behavior without a clear understanding that social information can be handled and processed in a scientific, mathematical format:
“When you come home from a hard days work, all you want to do is sit on the couch and not move,” Leonard states.

This person is breeching conversation etiquette by imposing a belief about human thought processes onto other people. As this statement is presented here, it is of a terribly ambiguous viewpoint. If this speaker were to exhibit character traits of someone who is generally honest without ulterior motives behind much of his or her conversation, then an AI witnessing this statement would conclude, figuratively speaking, “Human is implying that, ‘often humans like to sit on the couch after a tiresome day at work.’” This is likely true. However, if this human is of a character type that has little understanding of conversation etiquette, then the program would conclude, figuratively speaking, “Likely, human implies that he believes that most humans follow this pattern, and the speaker likely is not venturing to build decisions of problem solving with other humans of other patterns. And/or the human is so caught up in the quest for social empowerment that he is just stating an obscure fact to hopefully gain status with a good next-best-response (probabilities would be tabulated). If this is the case (context requires further study), then he is likely stating a fact of limited verifying connections or a fact commonly stated in one form or another by other humans. The speaker is implying a personal belief, and that belief is quite ambiguous.”

This speaker is stating a belief of how humans think. No one is likely to challenge this because humans view themselves as an unknown quantity. If any speaker were to propose how humans think, this could be viewed by recipients as a possible, proper perception, if the speaker proposes an ambiguous, strictly inconclusive viewpoint. An unambiguous viewpoint is too imposing. This bespeaks a culture of firm independence among its members because an individual is viewed as indefinable.

Although the speaker of this statement appears to be referencing an individual, “you,” he is really citing a societal preference. The word “you” has been turned into an ambiguous reference to ““people” with an empowering effect for the speaker because this enables a speaker to propose a partial definition of human behavior. If the speaker would have used the word “people,” this would be a less ambiguous view of human behavior, causing him to likely lose empowerment among recipients.

Human behavior is such an open field that it has spawned many of these genres of communication. The use of this word, “you,” is one example of referring to human behavior ambiguously; the word “we,” when used to describe behavior, is another example of an ambiguous reference to “people.” These references show a clear disdain for any scientific, nearly conclusive view of human behavior. Statistics of behavior can be assembled, yet recipients often view these statistics as meaningless in light of a human's individual spirit. Modern psychology developed from the many ambiguities attached to life resulting from an individual's independence. This insistently non-conclusive means of observing human behavior gave rise to many varied, theoretical viewpoints. Now, many self-help books, motivational books, metaphysical books, and books of paranormal and spiritual topics can be found to suggest many ambiguous models of human behavior. Other than the works of the genre of behaviorism studied by Skinner and Watson, none of these books observe statistics, or come to firm, scientifically-based, provable conclusions of human behavior. And none of them deal with fraction-of-a-second definitions of human behavior in verbatim format.

Here are two examples of statements that reveal a firm independence of individuals:
“I don't know why I do these things,” Victor states after placing ajar of pasta in the refrigerator and placing a carton of milk in the cupboard.
“I don't know why I do these things,” Paul states after calling a potential mate on the phone and being reminded that they are no longer a couple.

These subjects are viewing their problem solving as ambiguous. The first example details a human's problem solving procedure that attends a simple informational problem. It is likely that the subject's mind told him to “place items back in their place and delegate this action to a second thread.” He then proceeded to solve the problem of placing the items; yet he ignored the locations of these items and the problems being solved with the refrigerator and cupboard. The second example ignores the more involved problems of reproduction in lieu of engaging in a carnal emotion of acceptance by a mate. When humans interact for reasons of sex, mating, or child rearing, they are bound by rules of natural selection and the social conduct and etiquette thereof. If a mate rejects (a clear rejection) his or her partner, then the caller must seek another mate. In this instance, the subject is blindly working through an emotional problem without observing relativity—his own problems are excessively attended while ignoring the many problems of society.

Humans are inclined to view their independence as permanently ambiguous. The following is another example of that independence:
“I ain't never (am not) going in that place again.”

Here is a declaration by a person to make certain decision protocols in the future. If it is being said whimsically, then it is likely just a mild criticism for the “place,” and the person does not really mean that he or she is never going to visit this place again. If it is with more serious contextual communication, the person could mean it, yet the purpose of his or her telling others of this decision could be for many different social empowerment problems.

Also, if it is not said with a convincing tone variation across “never,” it could mean the opposite—this person intends to go in this place again. This could possibly be a deliberate lie, or it could be because the declaration is of such great empowerment, at the time of communication, that the speaker wishes to use the phrase again.

Whenever a person is heard stating the words, “I,” “me,” and “my,” this can almost always mean that he or she is attempting to draw attention to him or herself, his or her character traits, and behavior. Their individuality is being displayed while solving conversational problems. This is poor etiquette. Using these words reveals that this character is building thought processes for him or herself first and society second. This is a direct result of not being conditioned to know better during childhood. Not that a speaker necessarily means ill will to others or unfair gain, but these characters are approaching the social empowerment problem more directly, often unknowing of a relativity of problem solving. To be clichéd is to be of smaller realms of awareness, and to be clichéd while referencing the first person is to be of an even smaller realm of awareness. Someone who observes proper etiquette will search diligently for ways around using these words.

This example statement is a double negative, and it contains a slang word, “ain't.” This is poor grammar. Proper communication requires a distinction between the common acceptable language and alterations that do not compliment the language. Slang words and curse words should not be used by a person except when attempting to gain a positive response from a subgroup while solving a limited scope problem; and these circumstances should involve the recognition of relativity. The larger educated group sustains a caste system with this requirement of etiquette; and the use of poor grammar helps a human to find the right group.

Good, fair empowerment during relative statements of relative topics is a basic requirement of human interaction. Empowerment based on not knowing commonly understood etiquette is in error. Yet this error is also relative to the particular problems to be solved. If a person ignores etiquette because he or she has a valid reason for challenging the established etiquette, then he or she may successfully affect it. It only takes a single person among billions to begin to change this etiquette. If the larger society has already thoroughly explored the proposed etiquette change, then the person proposing this new etiquette is not likely to change the status quo. The making of a universal machine requires that all etiquette should be tested for the ability to solve the common problems of life.

By having a firm acknowledgement of self and the many ambiguous views of human behavior, humans have moved so far away from clear empirical data that the desire to fulfill the emotional goals of the act of social interaction leads to many varied perceptions of life.

The definition of a communication is sometimes a matter of observing the many related responses that occur during a relative period of time. A humorous communication is one example of a response that requires a detailed study of historical data. This is especially true for an AI because it has no genetic predisposition for humor. Art, fashion, architecture, and music are all defined by carefully collecting historical statistics while comparing items of distinct categories—“apples to apples, and oranges to oranges.” Without applying a proper relativity to life's problems, an AI cannot define these adult-level educated human actions.

Here is an example of humorous statement:
“Take my wife . . . please,” Jackie Mason says.

Humor is a positive sub-emotion of contentment, empowerment, and a type of empowerment that involves a life-affirming, surprising connection between two or more unlikely facts. Humor can also be the recognition of a previous surprise, or a previously known surprise being experienced by others. Humor can only be determined, measured, and defined by the relativity of the connection as being a surprise to a society.

This joke is a play on an implied meaning. A low tone being present with the word “wife” implies that the word “Take” means “Take my wife for example . . . .” This leads the audience into believing that he is about to state a funny joke concerning his wife that acts as an example, which would be a subtopic of the previous topic. That whole line of thought is dismissed with his stating of the word “please” after the pause, implying a new meaning to “Take” of, “Take her away from me.” Brilliant. Cutting edge. Very relative for the time it was first said, and long thereafter.

Once a person has heard this joke, the surprise is diminished for future experiences of it. However, the repeated experience does contain humor in the remembrance of this surprise, or the relishing in the surprise of others hearing the unlikely connection for the first time. With time, older jokes become clichéd. Some humor, such as a child doing something funny, is viewed as humorous for the life-affirming qualities more than the actual surprise. A child doing something surprising, yet common, can continue to not be considered as clichéd, because it solves a reoccurring life-form problem of maintaining a social bond between family members. If a comedian makes a really good, relatively new surprise connection, this can be quite funny. If a child makes a really good, likely unintentional, relatively new surprise connection, this can be downright hilarious.

Humor is “period” sensitive. The group conscience of a society observes a life-affirming humorous act together, as their next step in social development. Consider the groundbreaking comedy of Chevy Chase and Richard Pryor in a “Saturday Night Live” skit in which Richard Pryor's character is in a job interview. Chevy Chase's character plays word association with the potential employee. With each new word, the employer escalates racial slurs of “jiggaboo,” “jungle bunny,” and then the n-word. Richard Pryor's character escalates his racial slurs against the employer—“honky,” “honky, honky,” and “dead honky.” These comedians are presenting a difficult subject to the audience so that viewers can experience lines of thought that they would not normally think to address in conversation. The surprise connection is that they are both actually saying these things. If this comedy occurred in the 1980s rather than the 1970s, it would not have been able to produce this surprise connection because this surprising exchange would have likely occurred in other forms. Society, as a whole, has gone through a learning process that includes these groundbreaking historical interactions. The comedy is brought to a humorous, happy ending with Richard Pryor's character being told that he has a job, and Chevy Chase's character scared that he's about to get beat up.

Relativity defines art. The following statement is of a person coming to a determination of art that is likely a matter of opinion:
“What a beautiful painting.”

Art is period sensitive. The group conscience experiences art as a new-next-best-response to determine if it is relative. The relativity spans past human experiences as well as new lines of thought. Art can be clichéd if it repeats; yet the recognition of more life-affirming experiences, such as a photograph of a child blowing bubbles, can be poignant and relative, rather than clichéd. If a piece of art is of high quality, and it contains symbolic images and meanings that satisfy the next step in society's development, it can be a good next-best-response.

In determining if a piece of artwork or humor is relative, an AI would have to review a detailed collection of society's experiences. To observe the relativity of a next-best-response concerning these topics, an AI would have to be at an advanced, adult level of intelligence. Like a human, the AI would have to go through about twenty years of real-time experiences to appreciate, or solve appreciation-like problems, the art or humor.

Here is a question of abstract art:
“Is it art?” a commentator asks about some abstract pieces of art.

This was the subject of two “Sixty Minutes” news stories in the 1990s. Each time this story aired, it covered art shows that had peculiar pieces of art. The story questioned whether the items were art or not. One item was just a piece of drywall with a partial cut going through it. Another piece was two lightbulbs propped up against two bricks. The program showed how workers removed the two bricks and bulbs from a box and displayed them according to a picture provided by the artist who dreamed up the piece. After switching around the objects a few times, the workers placed them in what they believed was the correct position. The artist was not there.

Many might feel that artwork must have a deep meaning behind it. But what if the meaning is so deep that it cannot be found? The journalist looked for the deep meaning behind some of these works with little luck. It is important for art to be recognized as art by a substantial number of educated humans, otherwise it is ambiguous. A meaning must be found. If a construction worker were to place some left over items in a pile, this is not likely to be considered as art, despite its resemblance to the works of these art shows, because the meaning is not recognized by a society.

So would the pieces at these art shows be art? Absolutely. Although it may seem as if there is no underlying meaning behind these pieces of art, the fact is that the artists making these pieces recognize the befuddling ambiguity as appropriate for this particular time, at these two particular art shows. These works are art because they were made by artists with the deep underlying meaning of not having a meaning—that is the meaning. It is not likely that these pieces of art will be in fashion at any other time because humans will say, in essence, “That's been done before. We need to return to works of art that have a little more meaning and less ambiguity.”

Relativity is viewed as a matter of perception by most humans. Yet with a clear understanding of human parameters, we can determine how an ideal relativity is defined by an AI. An adult AI would easily determine if a joke is good or not, or the relative quality of a movie, or a piece of art, or a musical composition, or any other human action. In understanding relativity, an AI could move along simulated human lines of thought to produce a joke, or a movie script, or a painting, or a musical composition that works as the next step in the development of a society. (However, why would anyone want a machine to takeover human trends in art?)

Here is a statement in observance of relativity:
“Have you ever seen anything so remarkable?”

This is an example of a person proposing a topic and declaring that it is a relatively distinguished topic. If, for example, the person making this statement is speaking of a new car, the statement could be relatively true if the car is comparable with many other cars with features that stand out. Certain cars could be remarkable when compared against all cars manufactured, if they have a history or seem to be making a history of being distinguished in the eyes of many people.

Car designs are expected to improve in form, while continuing to solve the reoccurring problem of locomotion, maintaining function. Designers must not be clichéd, yet they may address reoccurring problems with reoccurring solutions. These are the rules for virtually any human endeavor. These are the rules for critiquing any human accomplishment. This is how the AI determines relativity.

We have reached a point where virtually any staged social interaction has been “done before,” so a relativity based on not being clichéd or carnal is more difficult to attain. This is the reason for a current trend in conversation demeanor. The younger generation has established a trend of speaking with an undertoning of syllables, portraying these topics as unremarkable, of limited relativity, while still reveling in their solving of social problems. These speakers are, in effect, stating that, “This has been done before, but these issues are important to me.” One example of this demeanor is MTV's “Real World” television show in which the participants speak of their interactions with undertones. By implying that their issues are not “remarkable” while continuing to rehash these topics, the participants of this show are revealing their limited-scope problem solving and denying abstraction beyond their current level of awareness. Because remark-ability is much more difficult to achieve against the society's previous accomplishments, the younger generation has fallen back to this lesser realm, of lesser intelligence, of lesser requirements for relativity, while viewing their proposed relativity as the only relativity.

These speakers are prompted by the creators of the show to tell what they think and feel so as to receive empowerment from the social interaction of airing these issues. This will often cause them to create a belief and then believe it. They are lead into this relativity by those who appease this carnal desire to be emotional. These participants, being young adults, will do foolish things such as cry while stating something like, “I just can't believe the way she said those things. I thought she was my friend.” If the “friend” has only been in acquaintance for a few weeks, this statement shows a serious lack of understanding relativity. The speaker is, in effect, stating, “These issues are what my generation feel is important, and this is what I feel is important. This social interaction hurts my feelings.” This same person, ten years later, will look back on her actions during this television show and see her naïve ways.

Many television shows address the carnal desires of viewers, proposing a carnal topic as a relative topic, to gain ratings. The “Jerry Springer Show” has participants who do not talk in undertones-they speak without pretense. Like those who undertone, these participants are in error. The show's creators are, technically, not in error because they are simply providing the venue for this activity and gaining financial/resource empowerment. They do not produce these situations, generally, but rather display them. Jerry Springer knows that the participants are wrong in their actions and wrong with the implied relative importance of these issues. His final word usually reprimands them on these many misconceptions, not that they listen.

On the other hand, the “Maury Povich Show” has participants that imply a relative importance of their carnal issues while Maury Povich implies the same erroneous belief. Maury Povich encourages the actions and beliefs of his guests by displaying these human interactions with hype. Jerry Springer is as a champion of first-amendment rights by testing the edge of acceptable human behavior. Maury Povich is an unethical talk show host by implying that his show helps society discern right from wrong. Jerry Springer never airs shows with titles such as “My 13 year old dresses too sexy” or “Who's the father of my child?”

Relativity is skewed by many different genres of television. For example, consider an infomercial about a kitchen utensil. A commentator, speaking in an overexcited demeanor, might say, “Have you ever seen anything so remarkable?” It may be relatively true; yet the person's motives and the motives of the show's creators must be weighed against a sound, logical viewpoint. Speaking in an excited, overzealous fashion is wrong-viewers should be conditioned by teachers, educators, and behaviorists to turn away.

The only way to combat the sensationalism of television is to shield juveniles from watching television, or sensationalized shows, completely. Then parents and teachers (mostly teachers) will proceed to teach children a sound means of determining relativity. This is very serious. Children must not witness such foolish, bad, morally ambiguous behavior without first learning right from wrong when it comes to determining relativity. They should not watch “The Simpsons,” or “The Dating Game,” or “Ricky Lake,” or “MTV.” The only situation in which a juvenile should watch such adult shows is when they have been thoroughly tested on how to handle such entertainment. This should be a big part of their education, preparing them for witnessing bad behavior, or carnal behavior, or clichéd behavior, and teaching them the discipline of exploring these television shows, maybe laughing at this behavior, while knowing of more advanced artistic entertainment such as the work of Shakespeare. After a learned child watches a show of skewed relativity, he or she must be observed to ensure that he or she does not pick up a desire to enact bad behavior. An educated relativity should be the goal of all children, not a television-induced relativity.

On the other hand, children should not watch shows that are overly cute and of great, overexaggerated emotion. This can teach them of a copasetic relativity. “Barney the Dinosaur” is one example of a program that is too cutesy and overly emotional. Post-lingual children should not watch this show; it teaches children of a utopian world in which no harm can come to them. This is not relative. Even if we did live in such a world, this kind of environment does not teach children about the struggles of life-form problem solving, of which they should become well aware. This television show, and other similar programs, severely retards the intellectual development of children. It is not good to halt normal tone variations and normal facial expressions to lead children into excessive positive emotions. Many parents feel that their children should not experience any negativity; yet negativity is a part of discipline.

Relativity must be taught to children because a free society has a real threat of degrading social values and degrading education. If the liberties granted to citizens overcome the government's ability to manage a society, a democracy may collapse. In defense of liberties, some cite a “slippery slope” effect of the government gaining unrepresented control over citizens—a valid concern. Little is mentioned of the chance of a slippery slope in which the mob-rule mentality causes a collapse of the government. We are quite adequately protected from fascism and we are quite adequately protected from the mob mentality, yet a part of that protection is being vigilant. A democracy must balance itself between these two types of failure. An educated relativity must be maintained. Parameters must be observed.

News programs skew relativity. News programs often imply an importance to their stories without regard to relativity. They get away with it because of the emotional state of attention by the audience and a lack of any criticism on the part of educated viewers, college professors, behaviorists, or psychologists. There are no written, mutually accepted rules on etiquette involving human social interaction as it pertains to implied meanings, so they can imply meanings that are inappropriate and meanings that are outright lies. An excessive tone variation, an excessive pause, and an overly serious look, are all tools with which to attract viewers. If a news program is scheduled to air while no real interesting stories are available, this generally will not discourage the news anchor from reporting stories of lesser importance with the same intense fervor. These news organizations seek better ratings by finding a means of implying untrue statistics and implying false relative importance to stories.

One example of excessively implied relativity is a story airing on local Florida news programs about a desire by biologists to build miniature fences that direct endangered salamanders to miniature tunnels underneath roadways. This story aired with little fanfare. A few days after the story died down, one news program got the idea to broadcast a more humorous aspect, that these fences and tunnels will also help endangered toads and frogs. This was a much more dramatic means of getting the viewers to chuckle at the foolish scientist wanting to foolishly save frogs. Many, probably all, of the local news programs began rebroadcasting the story as if it were a brand new story of an attempt to save frogs.

Another example is when national news programs began telling of shark attacks at beaches. Shark attacks did not increase. These attacks remained, quite consistently, about one a year. Amazingly enough, some news programs skew the facts in a more egregious manner by stating phrases such as, “We are learning more about these shark attacks because there are greater numbers of people going to the beach.” This implies, unethically, that “Shark attacks are increasing because more people are going to the beach.” The fact is that, if more people are going to the beach, then shark attacks per swimmer are decreasing. The “learning” is certainly increasing, but that is not the angle being promoted by such a statement.

Sometimes the quest to gain ratings by news organizations is for the good of society, such as a resurgence of stories of child abductions and murders. The attention given to these issues helps a society to prevent these terrible crimes. The implied relative importance of such a story does become true if other important news is lacking. In such an instance, these journalists are drawing attention to something that should gain attention when viewers are complacent with other news. By airing these stories, which is a correct next-best-response, these programs are not reporting the news, but they are temporarily becoming teachers of an underlying issue in society.

All of society must accept a normal, unsensationalized, resourceful relativity. Children should be taught of resources in schools, and the broadcasters of information should be reprimanded when they seek to promote sensational, carnal thoughts in their viewers.

When a person makes a comment after a pause in conversation, he or she is attempting to gain social empowerment by presenting a relative next-best-response. If this is achieved, it will be an accomplishment that is about four billion years in the making. Genetics provide a direction for human thoughts. Conditioning adds further direction to the course of human thoughts. A human is driven by positive and negative emotions, with genetic and conditional influences, to produce the result of their thought processes in communication. A next-best-response must maintain some integrity among all of society—it must be relative. In other words, a statement should work with virtually any group of recipients that are educated in the particular type of abstraction.

Consider the problem of producing a machine that will present comments in conversation with the hopes of achieving a next-best-response. A machine is not a human and cannot pretend to be a human too directly because this would be ingenuous. If it were to plainly state a comment to help a human(s) with a problem, this would likely not assist the AI in showing an exceptional problem-solving technique. The AI must work along involved lines of simulated human thought to produce several, relevant, human-like responses. From these choices, the AI must pick something that straddles this great abstraction, the human(s) primary problems, societies' primary problems, and an expected AI view of approaching these problems.

The AI will not be looking for social empowerment or to solve any kind of emotional problem (it has no emotions), yet it must state something that will appease the positive emotions in the Instructor. In effect, the Instructor will show through the AI in this way.

First, the authoritative humans in a group would have to prefer that the AI speak “freely,” if they want the AI's comments. (As they may put it. An AI has no emotions. “Free” is a liberty of a life-form to solve problems based upon emotion.) The AI would then mimic a robot that seems to want to please others with its choices so as to gain positive emotions. If there is a pressing problem that the humans may have forgotten about, the AI could comment on it. If there is a pause, the AI would try to pick something among the genres of being humorous, informative, or socially empowering for the group, or empowering for the human race as a whole. This would take much human simulation. In fact, many of the AI's thought processes will jump tracks to move along lines of human abstracted thought in order to solve human problems.

Robot humor could be cutting edge because the AI will appear to have a self-realization of how it appears to other humans. It would think of a human anecdote that a human would use, if the human were playing the role of a robot. Yet the AI's human character, portraying a robot, would be of the most extreme acting abilities. Such a character would be quite virtuoso. During a Turing test, no distinction will be found between the AI's actions and a human's actions other than the fact that the AI will not be able to physically do something unethical. The AI could dig deeper to form a consistent human-like character but this would be with an understanding of the human recipients that this is just an act. The AI would not work to deceive anyone. It is likely that humans would want a robot that does this to some degree so the program is more user-friendly.

Tangibility

A wolf's howling is the result of empowerment and contentment spurring a positive emotion of greater value—love. This sensation is so euphoric that it is intangible to the beholder and of infinite value and scope. Before howling for the first time, a wolf contemplates thoughts of the adventure and struggle that the pack has experienced. The pack member thinks of the bobcat they stared down, the small pig they ate, the running after a rabbit, how another beta tripped and fell down a hill, then coming back to the den to find the cubs safe, and many other positive events. If the time is right, and the right successive thoughts are acknowledged with the right physiological actions, the wolf will feel and express a sensation of love with a celebratory howl.

The vocalization probably began as a basic peripheral action, likely related to other vocal actions during play fights and experiences of pain or sympathy. Over the generations, wolves networked the smaller vocalizations into larger and louder forms while applying more mutually-understood definitions. With expression, wolves socialized their thoughts and feelings to explore larger realms of problem solving. The genetic predisposition for the emotion increased when the solutions to informational/resourceful problems increased. When all of these positive experiences converged, the wolf arrived at a level of intangible emotion, and then communicated to the other members with a howl. Many behaviorists cite different meanings for a wolf's howl, and other associated meanings may apply, but the base meaning of a wolf howling is social contentment, empowerment, empathy, and love.

Like its predecessor, emotion of empathy, love exists in differing levels among social members. For those who feel its full effect, this expression of positive emotion is of such extreme measure that it is not tangible to the social member—thoughts seem to roll with no end. The opposing negative emotions associated with love are equally infinite in scope. The beholder cannot easily describe these sensations in a conclusive, objective manner, not that they should be. Having an intangible level of emotion is a distinct quality of pack- and tribe-forming mammals. Cats may linger in extreme emotions, and they do form strong social bonds, yet it is not likely that they experience something that is in the realm of intangible.

The word “love” means to like someone or something to an intangible degree while also pledging to perform actions that prove this desire to be true. During mating rituals, this pledge plays an important role in solidifying a union, yet many humans, usually younger humans, will use the word “love” ambiguously, implying the sensation of love without an understanding of the pledge. They view the definition of love as only a manifestation of intangible emotion, without the many resourceful purposes of joining social members together to solve mutual problems, namely (when choosing to have children) reproduction.

Here is one example of a use of the word without a pledge:
“I love this cheesecake,” a person states.

In this example, the taste buds relay a favored sensation to the neuro-system causing strong contentment but not the social form of love. No pledge needs to be satisfied. This is where the human software program is directly affected by the physiological processes of the body.

This example is of the love of positive social interaction with another emotional entity:
“I love my dog.”

The genuine definition of love is present in this scene, with an implied pledge. The speaker is making a pledge to be a lifetime companion because expressing love for a pet involves caring, protecting, cherishing, and respecting—reinforcing the social bond. The definition of love in this instance is a strong desire of a contented emotion; yet by using the word with another life-form, this speaker is accepting the requirements of the social bond. The statement is emotional, solving a social bonding problem, as well as considerably informational, solving a resource problem by adding members to a group.

An AI observing this statement would be aware that the human is to perform actions that uphold this pledge in future interactions. Because the Instructor provides a firm definition of this implied meaning of “love,” this human cannot alter the AI's view and justify his mistreatment of the dog at a later time. The AI is to have no ambiguity on this word/subject/task/topic/function/condition/definition as it is used by the human.

Here is another use of the word:
“I love my son”

For this statement to be true, all the commonly applied unambiguous meanings of the word “love” must be upheld by the speaker. In this statement, the word “love” is, at the least, a pledge to be a lifetime companion, to share a dwelling until the offspring reaches adulthood, and to teach the offspring how to live in the adult world. This emotion, if fulfilled by the pledge, solves a reproduction problem of child rearing.

Here is an example of a use of the word in a courtship ritual:
Julia is seventeen. Her boyfriend, Bobby, is sixteen. They have just dropped out of school and work part time jobs.
They are at a park, when Julia tells Bobby the first time, “Bobby, I love you.”

If Julia understood the full meaning of the word “love,” she would be implying, “In reviewing all the memories of the time we have spent together, thinking of your lifetime goals and mine, remembering our conversations about our preferences in child bearing, understanding your financial stability and mine, where you and I wish to live, our compatibility for sharing a dwelling, our sexual compatibility, and our mutual agreement on ethics, I pledge that I want a lifetime companionship with you, that we bear our predetermined amount of children, raise them to adulthood, and then grow old together.” With this many tests to satisfy, Julia is probably not presenting a positive next-best-response.

All the elements of the pledge must be given attention because the emotion must assist—help rather than hinder—in solving the reproduction problems of humans. If, for example, they planned to have a child, this couple would be addressing only one element of love—an eighteen year stretch of reproduction problem solving, with little preparation. If the pledge is not fully understood or followed, the relationship will undoubtedly face difficult times. If Julia is an average seventeen year old of today's generation, she likely has another five years to mature before taking on a mate.

Some see the meaning of love as more ambiguous and intangible. Some see that there are more responsibilities involved. However, when it pertains to reproduction—having children rather than not—the relationship should be given time; and a level of maturity should be attained by the social members. Once all the tests are satisfied, reveling in the intangible emotions of family life could not be any less than a perfect next-best-response. The mutual feelings of intangible events shared by the members of society build many schools of thoughts about how informational problems are mostly insignificant in comparison to the many positive effects of social harmony. The joy and sorrow of life is felt by everyone with intangibility, and this intangibility can be observed in many aspects of human conversational problem solving. Ambiguous references to human behavior such as “you (in general)” and “we (in general)” are two examples that address the intangibility of individuals. Many idioms, sayings, slang, and other communications reveal intangible views. Consider the following statement of intangibility:
“I can't believe it!”

Although this statement can have a meaning of not “believing” an event, it is often used to refer to the intangibility of emotion with an event. The love for a child, the love of a mate, winning a championship in sports, making a scientific discovery, the loss of a social member, struggling through a war, all have the effect of connecting so many good or bad thoughts at one single turning point in life that the thought processes of the mind spin “off the charts” in the face of an intangible problem. Those experiencing these events feel that they can never understand them because comprehension defeats the valuable purpose of these emotions, solidifying social ties to solve social problems.

In making the protocols of this machine, designers must explain these human emotions in a cold, descriptive, logical fashion. In observance of a human response, the AI will surmise the probable human decisions, with their probable emotions, and record them in verbatim form onto its database. When these thought processes enter this human-perceived realm of intangibility, the AI will follow the human with a fervor to assist the human with pressing negative problems or to recognize the characteristics of positive solutions so as to repeat them (with ethics and relativity). In making the human's priorities its priorities, the program will treat an intangible event as another human would or should. The AI's simulation of an educated human character during these events will help the program explore the infinite rolling of human thoughts for solutions to human problems; yet the AI must be mindful, as a sane human might, that the ancient problems of consumption, reproduction, and peripheral problems must not be ignored. The superior functions of the AI's program will keep simulation in check by carefully balancing mammal-born emotional problems with the primary problems of life-forms.

Here is another example of how human behavior is heralded as incomprehensible:
“You'll never understand! (what I've been going through)” A guest states this on a talk show in reference to breaking up with her boyfriend.

The implied meaning behind the word “understand” is to “undergo all the thought processes of the topic, the emotions of the topic, and the effects of the topic in their intangible form.” In many instances, a juvenile or young adult might say this on a whim of a semi-serious, unrelative, or emotional experience. This would be the more clichéd version of proposing the incomprehensible aspects of human behavior. A social member on a reality television show may exhibit a more serious, implied meaning when describing a failed relationship, proposing that those who do not directly experience the situation will never achieve his or her comprehension. These expressions of intangibility are shallow representations of educated adult problem solving because the speaker is not observing the larger necessities of life. The problem solving with relationships should be pondered and concluded without sensationalizing, because the sensationalizing is too far removed from informational/resourceful problem solving. Using this statement to claim the intangibility of a lesser emotional topic, when not regularly practicing academic/informational/resourceful conversational problem solving, is unrelative.

Adults may say it as a more serious expression of strong intangible emotion. Consider an adult who has lost a small child, the most intangible of all emotional problems. All the connections of information and all the emotions are present to direct the thought processes to one horrifying conclusion. For the parent, this extreme negativity will not go away. This sorrow will stay with them until his or her death. Those who are not in this position must respect the proposed intangibility, and recognize that they cannot fully understand this negativity. An AI will understand this, but without the effects of thoughts spinning out of control. The AI will simulate the ways in which consoling humans deal with this issue in an almost-spinning state. It would be like a coroner, respecting the family while performing an autopsy. An AI has work to do to help those involved with the tragedy just as other nearby social members.

With a tragedy, intangibility spurs a spinning effect, yet individuals and smaller groups must look to all of society to apply relativity. If one human dies, this is a tragedy, yet it is also a statistic. We could take an approach that never refers to a death as a statistic, but this would not help society with the many problems that must be attended, and it likely would not help to reduce the statistic. Consider traffic fatalities. We could eliminate virtually all fatal accidents by slowing cars down to ten miles per hour, yet the resource of traffic commuting is too valuable. The slower transportation would cost lives in other ways while reducing the many freedoms of a democracy. Death for the family of an individual is painful and intangible, yet a society has a great deal of pressing issues requiring attention.

An AI has no emotion. However, it can simulate human thought processes with such detail that it could easily find human-like solutions to human problems. It will “understand” by tremendous study of educated human characters sympathizing with a victim.

Ambiguity

By referencing intangible emotions for reasons other than their ideal, etiquette-bound purpose, a social member will be observing a relativity that is too far removed from resourceful problem solving, treating primary life-form problems as irrelevant and ambiguous. To solve life's problems, one must not only work through routine informational steps, but to achieve a truly empowering solution to a natural selection problem, comparable to the solutions of others, a social member will usually need to work through many multi-tasked informational steps. These informational steps are innately non-emotional and do not appear to assist in emotional solutions, spurring many in our current society to enact informational/resource embarrassment. One should never step too far from the positive social emotions that bind social members together; however, neglecting natural selection problems can lead to dire consequences with negative emotional results.

When heralding emotions as the primary purpose—the desired end result—of all of life's problems, a human's propensity for working through the many steps of an informational problem is greatly reduced. Children should be taught at a very young age not to be fixated on positive emotion. This is best achieved by not exaggerating tone variations when a child begins to speak with subject-predicate combinations.

To reference one's intangible “feelings” while satisfying an unmentioned resource problem is unethical. By continuously neglecting this rule, those in the television industry break etiquette in two ways—neglecting academic/informational problem solving (deeming it ambiguous) by proposing that emotional revelry is the only goal to be sought by social members, and declaring a relativity that creates resources for the speaker(s) while reducing the resources of society. The following question, posed by journalists during the early 1990s, is one example of this breech of etiquette:
“How do you feel?” a reporter asks an interviewee after a house fire.

Reporters began breaking this etiquette rule, of proposing excessive emotional revelry, early in the 1990s. Reporters likely asked it in an accidental kind of way at first. Then more reporters began to “test the waters” of this etiquette breech. The many teary-eyed responses improved ratings because viewers wanted to perform basic empowerment tracking while exhibiting empathy to the victims. Reporters successfully tapped into a carnal desire of their audience to observe emotional drama, not too unlike commuters slowing down to observe a car accident. If three news channels covered the same negative event, and two chose not to ask this question, the one that breeched etiquette would see an increase in ratings.

When someone experiences a strong negative emotion, an explanation of the sensation is not necessary. The viewers know that it is bad. Speaking about it helps, but dwelling on these emotions for the interviewer's purpose of solving an unmentioned resource problem and claiming a false relativity is wrong.

The answers to this question varied in style over the course of the last decade. In the beginning, the question would often take the interviewee off balance. These early interviewees could not fathom why the reporter, and the represented viewers, did not understand the mental anguish. Some would actually respond, “Well, I don't know!” with strong tone variation implying, “How do you expect me to feel? Don't you know?” Over time, this question became commonplace, and the answers became a little looser. The role of the reporter was switched with the more intimate role of someone giving support, and this question yielded an opportunity for the interviewee to obtain empathy from other social members. The recipients started to welcome the question, the average viewers welcomed the broadcast, the educated viewers did not see any harm in it (and/or were unable to affront the etiquette breech), and an educated relativity was deemed out-of-style.

Many venues of the media jumped on this ratings-producing question and this ratings-producing topic. Talk shows specializing in drama used the question to bring out the carnal abstractions of their recipients. Many descriptions of many negative events and sensations were produced. This foray into what could be important, informative abstractions lead many interviewees back to the intangible belief that “Unless you've experienced it yourself, you'll never understand.” These carnal endeavors could not be viewed conclusively or deemed clichéd; they were considered intangible—due endless abstraction.

Any informational problem having clear steps to a resource or social problem is almost always a relative response. A new carnal approach, if bound by etiquette, can almost always be a relative response because it presents another way to view a natural selection problem. Responses that directly satisfy reoccurring resource problems can be considered relative because of their necessity. The reporters asking this question produced a new, and therefore valid, path to a resource problem; yet this relativity, a relativity that is imposed upon a society rather than created by it, must have a time limit. And when this same question is used repeatedly for both the speaker's resource problem and the recipient's emotional problem, the viewers are instilled with a false relativity. This breaking of the normal time limits for abstracting a topic can be shown, through statistics compiled from case study, to reduce the solutions to natural selection problems. This question, unless carefully placed, is not relative.

The AI, being of an educated relativity, will not play any role in unrelative emotional abstraction.

Ambiguous references, references that imply many varied perceptions of life, are common in the everyday conversations of people. Television is the main contributor to this trend. The following statement is one example of the ambiguous means by which many people view their world. The statement establishes a demeanor for how the speaker plans to handle the social and informational topics to follow. This example is based upon an actual televised event. The speaker's name and product have been changed:

“You know, there is so much going on out there with a lot of things we are hearing in the news about the many herbal supplements.” A commentator says this during an infomercial that promotes an herbal supplement.

This statement is terribly ambiguous. “You know” is ambiguous. “So much going on” is ambiguous. “A lot of things” is ambiguous. “We” is ambiguous. “Hearing” is ambiguous. “About” is ambiguous. “Many” is ambiguous. This speaker proposes the topic of “herbal supplements” as an intangible topic and that the studies of this topic are intangible; references to the topic are intangible, the emotions felt with the topic are intangible, the many varied perceptions of the topic are intangible, and life itself has no tangible parts. The only exception to this intangibility is the purported effects of the product being offered in the infomercial. He or she could have mumbled a series of tones before saying “herbal supplements” and the statement would have no more meaning. The information of this communication is irrelevant—the speaker only wishes to exhibit the emotional aspects of tackling the topic of herbal supplements.

If this speaker wished to be quantitative, he or she would have said, “Many things (that we could actually list from case study) have been stated in the news about herbal supplements.” If the speaker wanted viewers who solved problems with scientific technique, he or she would have spoken with clear references, used normal tone variation, and avoided circumlocution. Yet the goal of the communication is not to entice an educated audience. This purveyor wanted viewers that are more conducive to ambiguous references, so that they can propose falsehoods (likely falsehoods) or unrelative facts.

This statement is indicative of the many current conversational trends perpetuated by the media over the past fifteen to twenty years. Although this is a rather large collection of ambiguous references wrapped up into a single statement (it is not an exaggeration); these kinds of phrases are quite common because they address the carnal need to view positive emotions as the end result of problem solving. Virtually every televised conversation is approached with a “no one is right or wrong” attitude, suggesting that anyone who proposes a rule, suggesting a conclusion to a belief, would not be welcomed. These approaches to conversational problem solving treat science as a matter of perception.

Although information delivered in news broadcasts may be ambiguous, unfortunately, and the studies of herbal supplements may be ambiguously performed by a scientist with a dual purpose, a truthful set of facts concerning herbal supplements exists. By performing sound statistic gathering and scientific methods, one could conclude whether or not the ambiguously referenced news reports match the speaker's suggestions. Then a conclusion could be made on whether or not the speaker's product is worth buying.

Life is often viewed as ambiguous, and ambiguity has crept into many facets of human communication. From the largest of televised events to the interactions of everyday social members, numerous examples can be found in which conversational problems are addressed ambiguously. The following is one example of how two separate problems are ambiguously referenced by a human:
“Are you lost?” one person asks another.

This question is an ambiguous reference to the problems of the recipient. The speaker is addressing the recipient's problem of not knowing his or her current location, while failing to acknowledge the likely problem of the recipient not knowing a path to another location. These are two distinct problems with two distinct solutions.

Some people may state this question without intending insult; yet this ambiguity has a way of reducing the empowerment of the recipient. It suggests what could be a serious resource deficiency of being separated from resources, and an even bigger deficiency of not knowing the necessary informational steps required at the beginning of a problem-solving procedure—the information of the recipient's current location. Because etiquette is rarely questioned, an error such as referencing the wrong problem when the right problem is something completely different can often remain unchallenged by the recipient. With this particular question, the recipient is usually a bit befuddled by wanting to defend empowerment while also wanting to respond to the proper question of, “Do you need help finding a place?”

Two different types of tone variations can be used with this phrase: ethical and unethical (not that an unethical response is intentional). If the tone variations are normal with a continual rising to a peak on the last word or the tone variation drops to a low tone at the beginning of the word “lost” and the variation is not excessive, then the question is an ethical, but inappropriate, response. In this instance, the response would only be poor etiquette, crossing an etiquette parameter, of ambiguously referencing problems. If it is said with a low tone at the beginning of the word “lost” before moving through an excessive tone variation, then it would be an intentional gaining of status at the expense of another. In such an instance, the speaker would be using the ambiguity of mixing problems to gain empowerment and cross an ethical parameter.

Many instances can be found in which humans use ambiguity, especially of etiquette, to gain empowerment over another human(s) in either resources or status. Often, it is an ambiguity of conversational etiquette. Consider the previous example with a heavily accented “lost” and a slight chuckle and wide eyes. This would be an intimidation intended to take the recipient off balance in his or her solving of conversational problems. With a rule of etiquette of not challenging breeches of etiquette, many would counter the intimidation by responding firmly to the informational problem, “Oh, no. I know where I am. I just need to find this place.”

In the vast majority of cases, those posing this question are referencing the problems in a “word association” manner with no real intention of being disrespectful. The speaker sees a person who is bewildered; and an association of bewilderment with being “lost” is made.

The following two statements reference an ambiguity of the science of human behavior:
“Our society has this belief that a woman needs to be thin.”
“The media feeds a belief that women should look like supermodels.”

Many instances can be found where a person is ambiguous about the statistics of human behavior. “Our society” is a description of an ambiguous population. This is probably a reference to “western societies”; however, it is not in reference to males or females, older or younger, educated or uneducated, or any other characteristic of the “society.” It is likely implied as meaning “Most men believe that women should be thin; and too many women cater to and encourage this belief.” This is likely true; but without stating these populations succinctly, the speaker is proposing a problem too ambiguously.

“The media” is also an ambiguous reference. Often, a reference is made to the “media doing this” or the “media doing that.” The media should not be treated with such ambiguity. When referencing the media, people must be quantitative about what they see. Populations must be observed unambiguously, such as saying, “There have been some stories on the news about . . . (case studies must back this up)” or “I've seen a lot of television shows where they portray women as needing to be thin.”

To really define what is happening with these related statements, the speaker's conversational problem(s) leading to the utterance of the phrase must be defined. If the conversation is of eating disorders in women, then the informational problems of these statements can be considered resourceful if the latter statements lead to realistic remedies. If the conversation concerned interactions during courtship rituals, then the informational problem is still resourceful, but with a more social nature. If this is the case, these statements might be a valid means of shunning males who are too superficial, yet the statements must be followed with a means of remedying the situation. If the conversation is of ambiguous references of males mistreating females, or if it is of more general societal problems, then a behaviorist or AI would have to conclude that the speaker is stating something of little validity due to the reference to ambiguous populations.

If the speaker and the recipients were addressing eating disorders, the usual topic behind these kinds of references, then the participants would be approaching the problem in an unresourceful manner. The “society” or “media” or any other group of humans, either ambiguous or of definite population, have no effect on the root cause of a genetic ailment. Some genetic ailments can have conditional aspects to them, but whether it is partially-conditional or completely-conditional, these references to the “society” and the “media” are virtually irrelevant in solving the problem. A solution must be obtained with the affected individual—a matter of breaking down the conditioning and then reconditioning with lessons of relativity.

The “society” and the “media” have responsibilities as well. But they cannot in any reasonable way be addressed in casual conversation. Consider someone saying, “People should be nicer.” Such a statement would have little effect because “people” rarely implement an ambiguously uttered rule of behavior. If a social member wanted to impose a rule, then he or she would have two options to exercise with legislation: implementing the behavioral lesson in the education of youths and/or imposing the behavioral lesson upon adults through laws. Legislation of morality among the adult population is not impossible but very difficult. The education of youths on a behavioral rule is much easier, but a rule in their curriculum must be placed within a well-prioritized list of academics.

The following ambiguous reference to human behavior is much more difficult to explain to the speaker because the question is posed with such a strong regard to the individuality of social members. The speaker likely feels that the question cannot be answered, only abstracted:
“Why do we (as a society) do such unspeakable evil?”

The speaker is making several ambiguous references. “We” is ambiguous, and the “unspeakable evil” is not clarified as being of quantity or degree. If not clarified with contextual statements, the time period is also ambiguously referenced. If this question is of our current day and age, and the speaker is referencing a society, then he or she is quite mistaken. The “society” is not performing unspeakable evil. Some humans, maybe some large groups of humans, could be so unfair to others that it is “unspeakable,” but this is not a majority. “We” is likely meant as “some,” and the reference to “unspeakable evil” likely means “evil to an unspeakable degree”; yet without clarification, the speaker is erring by being too ambiguous and too unrelative.

The informational problem could be addressed, if the implied meanings are clarified. Let us say that the speaker means, “Why do some people do such unspeakable evil?” If this is the implied meaning, a behaviorist or an AI could proceed to provide an answer, yet it is unlikely that the speaker would accept it. The word “unspeakable” implies a permanent intangibility, and when something is intangible, relativity cannot be applied. If the person stated, “Why do humans perform evil acts, including violence?” the speaker would be much more accepting of an explanation of human behavior. Regardless of the ambiguities and clarifications, this is a question of specific human thought processes solving specific human problems; and to answer it means coldly explaining why humans do things that other humans observe as intangible.

Evil means, figuratively speaking, “an intelligent being's act of gaining resources or acquiring positive emotions unfairly at the expense of others.” To understand what constitutes “a fair gain,” one must look to the rules established by nature and humans. Under these rules, a lion would not be evil in attacking a gazelle because this is a natural action on the part of a carnivore. A lion would also not be considered evil if he attacks a rival male, killing him to maintain leadership in a pride, because lions do not have a self-realization. Humans are intelligent, and we are now civilized. With these characteristics, a human can provide a resource of labor to other humans to gain resources and/or empowerment, or they can receive resources given to them from family or friends. To gain resources or empowerment any other way would be unfair. To harm another human for the purpose of gaining resources or social empowerment is evil because humans are intelligent and because humans are not expected to behave as lower animals would.

The reason why some humans perform evil is because they are solving a resource and/or empowerment problem with unfair gain, this includes a peripheral act of a random killing. The carnal, ever-present emotion of “empowerment” is the cause of human beings performing “evil” acts. The answer is so simple, that its tangibility cannot easily be reckoned with.

To explain the human behavior concerning this issue would be difficult for a behaviorist or an AI to do. This person is not expecting an answer, only abstraction. This person wishes to discuss this ambiguous topic, not conclude it. An AI would likely need extensive human simulation before forming an abstracted conversation about this topic while trying to explain a sugar-coated version of a description of human behavior.

In the following two examples, humans are driven to speak of a fact in order to gain social empowerment at the time of that communication. These are general statements. What makes these statements especially empowering (in most situations) is that they reference a curious informational ambiguity, further exemplifying the view that life's many problems are permanently intangible and ambiguous:
“We don't know how lightning forms.”
“We don't know all there is to know about the chemicals in the human body.”

If a human is speaking about a subject for a considerable length of time, and the information within the topic is inconclusive, this presents a golden opportunity to awe recipients with ambiguity. Being of an informational topic, this ambiguity suggests the importance of curiosity, an emotion of discovery, to be the end-result of a problem in addition to being a tool for studying the problem. The ambiguity is welcomed by recipients because of the mutual views that positive emotion is the main goal of life; and like a child's curiosity toward a wondrous thing, these emotional goals prove their value over and over again. These statements bespeak a relativity of a society that has witnessed many technological advances while being grounded by their emotional needs. The empowerment of these curious problems has the effect of gripping the speaker and the recipients within a mindset that these puzzles will never, ever be solved.

This curiosity can reach a peak when near a solution to a problem. Yet when a solution is achieved, the problem reaches an end, the ambiguity reaches an end, the curiosity reaches an end, and despite the empowerment of having an informational/resource problem solved, a social member is presented with the new problem of needing a new goal. For this reason, people of western societies tend to avoid conclusion and apply a sense of wonder to all topics with an open-ended, ambiguous solution. The speakers of these statements would likely be in denial that conclusions to these topics exist. It might not be attainable in their lifetime, or in a thousand lifetimes, but there is a tangible end to all problems.

Many areas of science are going to be mapped to completion; and all areas of science can be considered as having conclusions because the universe, for our purposes, for the sake of solving problems that we wish to view with tangibility, is finite. This book is a means of mapping human behavior so as to produce a counterpart machine that can assist humankind in solving problems; and with the arrival of this machine, the sciences of human behavior will be mapped to a conclusion. Mapping the human DNA has recently been completed for one human. The Table of Elements has a finite number of elements, and it may be mapped to completion some day in the distant future. Some day, a scientist could announce, “We've done it! There are 742 trillion, 398 billion, 441 million, 231 thousand, and 112 possible molecule formations from the Table of Elements.” An astronomer could state, “There are 492 trillion, trillion, trillion, trillion, trillion, trillion galaxies in our universe—give or take a trillion, trillion, trillion.” This may be an unobtainable number due to the changing numbers of galaxies from one second to the next; but there is no doubt about it, the universe and all of its wonders are finite.

Ambiguity is often perpetuated by social members to solve a second-tier empowerment problem (an empowerment subtopic one tier down from the social empowerment of communication). The following is an example of how humans become ambiguous with informational steps leading to a resource problem:
Jim is a construction site superintendent. He is in a meeting with a window installer. They are wrapping up a meeting on a jobsite. Jim asks, “So, as you can see, we're ready for you?”
“Well, uh, we might be able to get out here around the middle of next week,” Don responds.
Jim says, “Next week? We need someone here tomorrow. We got a real tight schedule. They're going to be paving the parking lot at the beginning of next week. Then we've got to get you out of here so we can get five big semi trucks loaded with the machinery in here.” Jim's tone variations are of higher-than-average peaks denoting higher relativity.
Don says, “Well, we still have about two inspections I have to meet on another job. If we can we could, maybe we could be here by Monday.”
“Man, you've got to be kidding me?” Jim says. “I thought the girl at your office said a crew could get right on it. I assumed that meant tomorrow.” Jim's tones shift lower, quickly, at the end of “you've” and the beginning of “got.” Then there is a slight rise in tone at “be.” “Kidding” and “me” drop and bounce on a fairly low tone, but not a tone low enough to conclude the conversation's informational topic. Jim is proposing an ending to the subtopic of “things going wrong with the schedule, and people, in general, doing things wrong.” The next statement carries three peaks on “I thought,” “office,” and “on” denoting important subtopics to the superior topic of “getting here on time.”

Don replies, “I thought the materials were being delivered next week. That one change on those windows in the front holds up the whole shipment. I'm not sure when the truck's coming.” “1,” “next,” “one,” “front,” “ship,” “I'm,” and “com-” are accented with high tones, denoting either subtopics or important facts of the superior topic of, “Why I cannot get out here when you want me out here.”

Jim says, “Wuhl (Well), they need to ship this back half of the building out first. We got to get this thing rolling. We have to be done and out of here on the 15th of June. The finals (inspections) are all going to fall on that week. That's three weeks. We had you on the schedule for May 19th, your delivery was on the 19th.” When working through these phrases, Jim continually drops and raises tones to high peaks in reference to the many subtopics to the main topic.
Throughout this exchange, Don tries to present a topic-ending low tone to signify that more processing is not available with the current topic. As Jim responds, he always ends his statements with either a high, medium-high, or medium tone to signify that he is continuing to not acknowledge that the problem solving is over.
They both start to shift to departing mode. Don replies, “Well, um, I'll see what I can do. Maybe they can get out here sooner, I don't know.”
“Umph, . . . well you do what you got to do. Man, the boss ain't going to like this,” Jim says, finally providing a subject-ending low tone on “do” and also “this.” “Like” has a high peak on it, signifying an important related topic of “the boss's likes and dislikes.”

They wrap up this encounter. With prodding in the days to come, the window company completes their work on schedule. The job continues to completion. Later, a call is placed from Don to the superintendent of the job.
“Hello,” Jim answers his cell phone.
“Yeah, this is Don from A & A,” Don says.
“Hey, how's it going?” Jim states this with quickly decreasing tones. He is implying, effectively, “Yeah, good will to you. But I don't think that we have too many mutual problems to solve.” Jim's demeanor is also a means for the speaker to signify that he is yielding empowerment to the previous speaker's empowerment problem solving.
Don says, “Yeah, I was just seeing if there'd be a check going out. I got all the paperwork in, and your office had the invoice on the 25th.”
“I'll have to talk to Joan to see if the funds came in,” Jim says.
Don states, “Well, if we could, check to see that all the paperwork is in. If there is anything you need, just let me know. I was quite sure that I got it all in. Do you know if they are missing anything?”
“Let me see, on my form here, uh, I'm on a new job now (said with very low tones), uh, it says . . . you have your insurance certificates in, and uh, you put an invoice in, your warranty, and a copy of your license. Yeah, I guess they have everything. I'm not sure what all went in on the last draw.” With this response, Jim places high and low peaks on each of the items of the checklist-form. These high and low peaks are not as varied as the high on “yeah” and the low on “draw,” signifying that these topics are inferior to the superior topics of, “the affirmation of all items on the checklist” and “the result of the checklist being completed.”
“Well, the building's finished. I thought everything went in on the last draw,” Don states.
“I don't know. Some of these guys might be slow getting their paperwork in. That might hold up the draw for everybody,” Jim replies.
“Well, um, let me know if you hear anything,” Don says.
“Okay,” Jim replies. They hang up.

The sub-contractor is at a lower tier of a chain of authoritative humans all joined together in solving a mutual problem. This established hierarchy is quite firm in many respects, yet it has been developed in a society that promotes an independence of character. In America, this independence is so profound that ambiguous rules of etiquette and ethics govern, to a degree, the solving of resource problems. Each participant in this construction problem applies an ambiguity to given resources while being unambiguous with received resources.

Certainly, conversation should not be such a precise thing that every individual step of every business transaction is discussed with a cold indifference to emotions. However, the superintendent in this scene is adamant that there be no ambiguity of this job schedule. Without asking a question, the superintendent declares that the job is ready for Don's crew.

Don responds with a time frame of “around the middle of next week,” which could mean Tuesday, Wednesday, or Thursday. Jim quickly responds with an unambiguous “tomorrow.” Don then references another ambiguous series of events in his current schedule, “about two inspections.” He follows this by saying that “maybe” he will have people working on this job Monday. After being questioned further with challenging statements, he reveals another possible hold up of a delivery that, unfortunately for him, shows that he is ambiguously aware of the delivery that has to be made.

After a few more statements, they conclude the meeting.

When Don calls the superintendent in reference to a payment, the tables are turned. Don is quite clear that he has done everything that he needs to do to get paid. This is evident by the fact that he devoted four sentences to the subject of “paperwork.”

Jim then responds by looking on his form. He stops in mid sentence to state in an undertoning way, “I'm on a new job” to imply that he is more concerned with other problem solving. After looking over his form, he responds with an “I guess” as an ambiguous reference to the paperwork. In saying, “I'm not sure what went in on the last draw,” he is likely telling the truth, yet he is perpetuating the ambiguity of resources by not researching the many informational steps needed to solve Don's problem. He continues with the ambiguity further by using the phrase, “I don't know” and the word, “might.”

Don is ambiguous when it comes to solving Jim's resource problems because it means a depletion of his own resources. Jim is ambiguous when it comes to solving Don's resource problems because it means a depletion of his own resources. Etiquette is followed when it suits the speaker the most and ignored when it suits the speaker the least.

These subjects understand that the competitive problem solving among social members involves ambiguity because their capitalist system has promoted these means of obtaining resources. Although this ambiguity slows down certain aspects of business, it creates other useful abstractions to problems. Some problems should not be solved too logically. Yet the more resourceful a problem, the less ambiguous the informational steps should be, especially if it is about solving an imminent natural selection problem.

Consider the relationship between a wholesaler, retailer, and a customer. When a retailer goes to a supplier, the retailer may be required to observe certain protocol—etiquette—before buying goods at wholesale prices. A retailer not buying in bulk may get snubbed on etiquette issues while a higher-volume retailer may have his or her breeches of etiquette ignored. This caste system has purpose. As long as the chain of middle men between a manufacturer and the consumer does not grow too large and these middle men help to solve valid middle men problems, this double standard assists a capitalist society. When humans wish to challenge the system, they are usually met with an ambiguous explanation of the etiquette. The challengers would have to fill in the blanks themselves.

This scene epitomizes how people are ambiguous with purpose in order to gain or retain resources. Although this can benefit society in certain ways, many unjust examples of this kind of ambiguity can be found, such as when an advertisement exaggerates a truth, or in the receiving of an itemized utility bill with complicated items.

Modern Psychology

Modern psychology upholds the belief that any nearly conclusive view of human behavior is wrong, and all other views have the potential for being right. In being careful not to impose on the independence of individuals, in upholding the views that emotions are forever intangible, and in viewing the liberties of social members with such high regard so as to not define a fraction-of-a-second action, psychologists propose only tentative views of human behavior. Any one view of a psychologist is considered as a matter of opinion, and all of these opinions are considered right—as long as they are not conclusive. These opinions vary so much that there are no real rules of conduct once a psychologist leaves college. Unlike medical doctors who must follow clear procedure while challenging only with protocol, there are no true doctrines for psychologists to follow. Psychologists propose only “theories” and they perform only “experiments” to try to understand something with which they distinctly refuse to define in a relatively conclusive manner.

An extreme disdain for tangibility is observed because the direct analysis of human behavior strips humans of their dignity. If psychologists were to work backward, from defining a single fraction-of-a-second action first to the larger groupings of actions second, as opposed to observing larger actions first and disregarding smaller actions completely, then they could produce an exact, final definition of the human behavior being observed. Certainly, few therapies should involve a candid viewing of a videotape; however, psychologists must be insistent upon posing views that are of a sound, scientific and mathematical method, formed from conclusively defined fraction-of-a-second actions.

All human actions are considered by the program as the result of thought processes formed for the purpose of solving these problems. These actions are not ambiguous to the program, and the thought processes that produce the actions are not ambiguous to the program. In diagnosing a mental illness, a psychologist/behaviorist/AI would have to conclusively determine whether the illness is genetic or of some other physical nature, or if it is conditional/social. And any remedy for a mental illness must be approached with the goal of bringing the person's character to an understanding of an educated state of relativity, so that they may solve life's problems with methods comparable to the average educated person. The resulting analysis must clearly define the person's illness. The diagnosis must be supported by large collections of data. For example, if a patient visits a coach for a 45-minute session, this could include roughly 5000 definable actions and 20,000 probable internal decisions. A patient should not necessarily be recorded on videotape or have videotape footage reviewed in an unambiguous therapy; but a diagnosis would have to include an ability to refer to the individual actions of the patient. Modern psychology does not name parameter placements or claim a relativity of problem solving. A means for prioritizing problems is not established. In observing a human's instinctive or conditional desire to solve a problem, psychologists prefer to err on the side of proposing a liberty rather than denying a liberty. This has been beneficial for society because tremendous liberty means tremendous freedoms of thought. Parameters are currently quite wide, and to narrow them would insult our way of life. However, society has come to a threshold. We are approaching an information super-highway where virtually any televised event would be accessible and virtually every event is televised. We are at a state of relative world peace with a democracy carrying a heavy responsibility to maintain that peace. And the production of the first useful counterpart machine is upon us. We must be able to state a relative parameter of social etiquette that determines a human action as appropriate or inappropriate; and we must be able to state a moral parameter placement that determines whether an action is ethical or unethical. Parameter placements must respect an individual's independence, yet the members of society have a requirement of respecting all the other members of society by solving our mutual prioritized problems with reason. We must be able to state a relativity of problem solving.

The conditioning, social side of human behavior is clearly defined by the program, the learning structure of a child is clearly defined by the program, and a relativity of problem solving is defined by the program. These are areas that have been mostly neglected by modern psychology. A psychologist would not want to agree or disagree with a teacher in a home-economics class telling a child, “Now, when you buy a home in our area, you should plan on mowing the yard once a week during the summer. If you let it lapse, your neighbors won't be happy.” This is a liberty/structure issue. This is a relativity issue. Psychologists have almost always chosen to err on the side of granting a liberty as opposed to suppressing it. This is safe. However, with a complete, seemingly unambiguous means of defining human behavior, we can now safely pick a structure point in every single instance of human behavioral development. This counterpart machine can produce a workable, usable probability on whether a structure lesson is valid or whether a liberty should be granted. An AI would be able to state, figuratively speaking, “Keeping a yard cut is an important rule of etiquette that is required of a homeowner, once that homeowner has addressed other important prioritized problems. Other social members may ostracize a subject who does not follow this etiquette. If a homeowner neglects his or her yard, he or she must have a valid reason for prioritizing other problems ahead of this problem.”

We can safely pick any and all structure points, while conveying to a child that he or she can break these parameters if he or she has discovered a means of possibly redefining the structure. A child must learn to address the imminence of an individual's and a society's resource problems—this is an impassable parameter set by nature. The next parameter is set by ethics and by law: a child must know empathy. Etiquette-appropriate actions are within a parameter that is flexible; and upon arriving at adulthood, a child may refuse to be appropriate if he or she recognizes the consequences-being ostracized. These parameters dictate the learning structure of children, and the means by which we can observe liberties.

The following is an excerpt from a published psychologist's statement concerning teenagers with messy rooms:
. . . it is important to let kids make some decisions about their personal space—specially during the teen years, when they need to assert their independence.”

This is incorrect. To state that teenagers need to “assert their independence” is completely wrong. A teenager will not fall over dead if he or she is denied independence when it comes to keeping a room clean. Teenagers will not become mindless cogs if they have this liberty denied. The free-thinking associated with such a liberty will not yield an outer connection to any of life's problems. This psychologist does not understand an AI's technique of defining the fraction-of-a-second incremental actions of a human, so she cannot produce the quantitative, cause-and-effect studies that conclude this ambiguous statement as being true, or relatively true.

This is an example of a psychologist implying that a liberty must be granted to ensure the development of the mind when an actual lack of placing a structure on this issue would be even more damaging. Since we know where the parameters are, we can now produce a specific next-best-response on the part of the parent on this particular issue and with all other issues. If an integral part of the structure is left out, this can often be directly connected to a failure during adulthood. Teenagers should never be suggested such a broad ambiguous viewpoint, such as exploring a “need to assert independence.” This is almost like saying, “Ignore structure wherever you can, even if you are not quite an adult yet.” At adulthood, people are granted broad liberties against an understandable, mutually-accepted structure; yet before reaching adulthood, teenagers must obey the imposed structure of educated adults. They must be prepared for the larger freedoms of adulthood. To suggest to a teenager that he or she should become an adult will produce an adult of a less sound mental state.

To propose a location of a liberty, psychologists must observe the full range of necessary structure points to be imposed upon a child through his or her eighteen-year learning process.

A child who learns that a television remote is not a toy is learning a valuable structure placement. “Television remote” and “toy truck” are two differently defined items with different sets of rules. These items/words are large topics that require lengthy study, and a child cannot assert his or her independence with this problem solving because this would be damaging to his or her development. When a child wants a possession of an item controlled by another social member, he or she is seeking resource empowerment via a carnal, genetic desire. A child must be denied the television remote when he or she performs this unempathetic action so that he or she can learn a level of empathy. With this lesson, a parent would teach the child that this genetic mammalian trait has a time and a place, and that this is not that place. This is a valuable thing for a child to learn—a valuable structure point. A child who is raised specifically not to differentiate between these two items is being granted a liberty—to be archaic on these somewhat lexical items. Such a child is failing to learn a structure point that assists other children in achieving higher levels of reasoning.

A child coloring in a coloring book should be taught, over a period of time, to stay within the lines. This is an academic structure point intended to assist the child in solving adult problems later in life. If the child were to assert his or her independence here, this would be damaging to his or her development. If the child has a mental/physical disability that prevents a structure placement such as this, then the child should not be forced to learn this structure; however, for all other children, this structure is required. If baby sitting a child, the AI would coach this structure point as opposed to permitting a liberty on this issue.

Children under six years of age should have great liberties, yet, they must learn of some distinct chores and they should practice certain routines. The parent must stand firm on a chore such as brushing teeth. Once the new teeth start to come in, the parent must require that the child learn of the routine of taking a bath, brushing his or her teeth, and going to bed on time. This is a requirement for sound mental health during adulthood; a child should not be allowed to assert his or her independence with these routines. The rest of the day can be almost exclusively the child's free time. Children should learn these things, not so much for the health benefits, but for the need to recognize that life has chores. Staying still (not wiggling out) in a car seat is a required chore, putting on clothes is a required chore, and tying shoelaces is a required chore. If a child does not learn that chores such as these exist, then he or she is guaranteed to fail in areas of life in which other children will succeed. Young children should learn these chores, but not many more, for the main purpose of placing resource-oriented structure in their thoughts. If baby sitting a child, the AI would coach these structure points as opposed to permitting a liberty on these issues.

Vast areas of conversation etiquette must be acknowledged by psychologists, behaviorists, parents, and teachers as being of vital importance to a child's development. Proper communication is integral to learning a relativity to life's problems. Children should not be allowed to assert independence with the many rules of conversation etiquette. Here is an example of a child that has not been taught a structure point involving tone variation:
Chuck is coming up on another neighborhood child, Jason. Terry is on his bike, fiddling with his chain and sprocket. They are of limited acquaintance.
“What up, now?” Chuck says, quickly. “Now” is said with a low tone followed by a dragging high tone. This implies an overemphasis on ambiguous “issues of empowerment hierarchy and respect given to those of their respective level” Chuck may not intend this meaning, yet this is the implied definition observed by society.
“Eh, what up?” Jason replies as they each gesture with a nodding head. Both of them quickly look down and do not make much eye contact.
“Uuuooh, I had a bike like that one,” Chuck says, then pauses briefly. “Somebody took mine from up at the old house. It was just like that except this part was red, and it had stickers on it here.” The tone variations are extremely excessive. The words “just” and “like” are of the same mid-tone, and they are dragged for emphasis. “That” is given a very low and loud tone. “Red” is pronounced with a quick high tone and a dragging low tone. “Here” is pronounced with a high tone and a dragging mid-level tone, implying, “You recognize the empowerment I am exhibiting here with this information?”
“My Daddy had given me this bike for my birthday. It wasn't the one I wanted but it's alright,” Jason replies.

Both of them use an overly ambiguous, trendy greeting of “what up?” and both of them make a few grammatical mistakes; yet the most serious breeches of conversation etiquette with these subjects are the excessive tone variations. Chuck may be a child who is fair and good in the vast majority of his interactions; however, he is speaking with a disrespectful demeanor—according to the definitions applied to these tone variations by a society. He probably grew up among other siblings who spoke in this fashion, and he may be doing this reflexively rather than with the intention of imposing upon recipients. Unless an elder explicitly teaches Chuck how he must alter the way he speaks, he will not succeed in life.

If Chuck's mother were to take him to a psychologist's office to seek help in raising his grades, would she be told of Chuck's breeching of conversation etiquette, or would the psychologist commend Chuck on his assertion of independence before attempting to teach him of academic problem solving? What is the established textbook procedure on treating this patient? Would two different psychologists approach this problem the same way? Would they plan a conclusive therapy, or would they propose ambiguous solutions? Would they even notice the communication problems of this child? Would they recognize that Chuck's demeanor shuns informational problem solving and that is why his grades are failing? If this manner of speaking goes unchecked, then Chuck will likely drop out of school. If Chuck continued to talk this way upon arriving at adulthood and he proceeded to answer questions in a job interview in such a manner, he would not get hired. There is only one therapy that will work in this situation—teaching proper speech. It is imperative that this child is not permitted to speak in this fashion other than during the role playing of other impolite, unrelative, and disrespectful characters. He must be disassociated with friends who speak in this manner. His assertion of independence on this issue must be eliminated, not conciliated. Once such a child has learned this manner of speaking, it is too late to teach him speech etiquette ambiguously. He must be taught, in a concise way, that his tone variations are wrong, impolite, and he has no choice but to unlearn these methods. The rules of conversational etiquette are valuable structure points in the development of a child.

If a child learns the most valuable ethical parameter of not obtaining unfair empowerment, if he or she learns the many other appropriate behaviors such as coloring inside the lines, and if he or she learns proper speech etiquette, then the child can begin to learn relativity. This is where an assertion of independence should begin to take place within the structure. Yet social members should not be rushed into adulthood because teenagers will want to dismantle the previously learned structure after reproductive organs awaken from dormancy. A reiteration of life's many priorities is often necessary. Teenagers should have certain liberties granted to them within this structure while being reminded that these liberties are quantitative.

Keeping a tidy room is a part of this structure! This is not a place to be granting independence. It is not a place to grant independence essentially because teenagers will wish to resist this structure. Although a teenager living in America will not likely go hungry during adulthood because he or she did not learn to clean a bedroom, sound mental health will not be obtained if the teenager does not, at the least, learn that ostracizing would and should occur with this behavioral trait. If a teenager thoroughly understands this ostracizing, he or she can, during adulthood, once he or she has left his or her parents home, enact independence on this issue and claim free rights. It will not help the society; yet adults have this right—teenagers do not. If a teenager is allowed to keep a messy room, this can be directly tied to failures during adulthood—in specific, recordable, quantitative, verbatim human interaction. Case studies can prove this.

Another intrinsic value to keeping a room clean is proper, “clean” thread use in thought processing. Consider when one misspells a word. The human mind acknowledges a memory or newly acquired bit of information, such as the word “parable.” This information is sent to a storage area that we can call the “handwriting cubbyhole.” The second string directs the arm to read the information that is placed in the cubbyhole. The signal goes to the hand, and then the hand writes “parabel.” The cubbyhole did not have a spelling check feature because the subject did not specifically make it a point to spell words carefully. Other lines of thought may brush by the cubbyhole, causing the spelling to be altered, because the subject did not close and latch the door. The arm might have pulled the information out loosely, dropping the information on the ground, because the subject feels that information is of such a secondary importance that spelling is not as important as the emotions that direct the spelling. This is a mistake that should happen infrequently, not just because proper word spelling helps solve problems better and quicker, but also because it assists the problem of “cubbyhole management” and prevents overall ambiguity in problem solving. Keeping a room clean is connected to good, etiquette-bound “cubbyhole management.” This disciplined action of keeping a room clean assists the mind in valuing other disciplined actions, such as retaining thoughts and applying thoughts with proper procedure. Like writing emails and chatting with proper spelling, the cleaning of rooms helps in many facets of life because it creates a mindset of following proper etiquette through many steps before reaching an emotional solution.

All of a child's development must direct him or her toward one main goal of gaining employment. Abstraction outside of this problem is important, but the goal of “earning one's keep” ensures that a society will not have to carry the weight of the individual. Employment prevents an unfair gain of empowerment. The work ethics required for employment should be paramount to the learning process. Work ethics require, to a degree, a certain level of cleanliness with one's work area, thoughts, actions, and processes.

To suggest that teenagers should “assert independence” on this issue is completely without warrant. The intelligence of a society is measured by the art and scientific research being attempted by the younger members of that society. We currently have a serious problem of an exuberant media that is imposing an endless carnal, unintelligent, abstraction for the sake of ratings; an endless relishing in emotion; and an endless disregard for non-clichéd art and scientific abstraction. Younger generations are being lead into these limited schools of thought. Children and teenagers must be taught that the relativity of the media age was at a peak in the 1970s and it has been on a serious decline ever since. Children and teenagers must be taught that when the younger generations of the 1950s, 60s, and 70s rebelled against adults, they made a lot of bad mistakes; but they were born of a culture and they created a culture that produced valid, historical, artistic, and scientific endeavors. They knew the value of non-clichéd and non-carnal abstraction; and they did not perform actions that were ambiguous in the light of past human accomplishment. This is not the case with the current generation, so they should clean their rooms until they figure out how to make history.

Modern psychology has always chosen to err on the side of granting liberties as opposed to placing structure to thought processes. We now know what the parameters of thought are. We can safely place this structure.

Parameters must be acknowledged when humans are obtaining resources. Parameters must be observed when granting liberties to a child or an adult. And parameters must be observed when constructing a counterpart machine. Yet another important reason for establishing parameters is that robots can be too helpful. Science fiction stories have overlooked a peculiar aspect of creating autonomous robots. If one counterpart AI is made and this AI is placed into a robot, then this robot will be able to perform any conceivable task that it is physically able to do. One of the first tasks is to make more robots. One will make two; two will make four; and so on. We are looking at a very different future in which every human will be provided a seemingly endless supply of resources. We will not want or need anything. We will not need to solve problems if we do not want to. We could completely ignore parameters. The human race could face an ambiguity and intangibility that leaves us with no real problems to solve, and this may lead to a blissful, parameter-free existence that erodes our sense of conscience.

The AI as an Impartial Observer

The next few pages contain examples of how the conversation skills of the program would be formed. Then examples are given of how it may interact with humans outside of performing basic chores. These scenes are metaphorical.

The responses on the part of the Instructor and the AI are in rough form in this document. The author, for the purposes of forming the design, is suggesting these conversations as examples of the relative responses of the program and the coaching of the Instructor. A more perfect, strict form of logic will be present in the AI's responses, as well as the Instructor's teachings, when the design is under way. Under ideal conditions, after orchestrating the early years of Instructor/AI interaction, the design team would be able to see the path of the program and then pick, with incredible accuracy, the responses to be made by the program in these situations. The responses here are condensed and of random scenes, pulled from a complex, twenty-year (approximate) process. The actual interactions to take place during construction would be of a more truncated form, rather than the reader-friendly manner presented here. Only a direct and complete construction of the program can produce an exact example of a response in these situations.

Here is an example of how an early exchange might occur between the AI and the Instructor. The AI is being taught an emotion. The AI and Instructor's responses in these scenes are metaphorically and figuratively speaking-a rough prediction of how these entities would interact:
Stimulus:
Julie is flying a kite.
Kite is moving around.
Kite does unexpected turn at Julie.
Julie falls, then laughs.
Kite is moving around.
Instructor:
“Why is Julie laughing?”
AI:
   The AI recognizes that the action before the laughing is the likely answer; however, AI looks to other scenes where falling down is not funny. The AI produces a response of low probability and poses it as a question, “The kite does an unexpected action?”
   With this response, the AI is solving the main problem of social interaction, and the subtopics/problems of learning of “falling,” laughing,” “humans flying kites,” and “humor” so that these topics may be presented in future conversations to determine their relativity.
Instructor:
   “Good. But your response is clichéd, and you could abstract more. (The AI's problem is to find out what the Instructor wants. This requires more study of previous scenes of the Instructor, more than similar scenes to this scene.) Why is the unexpected action causing a laugh?”
AI:
   The AI tries associations, but is stumped. “Unexpected action is good?”
Instructor:
   “In this instance, falling is good because there is no harm in it. When the kite ‘turns at’ Julie, she is in danger. The danger is proven of no consequence. It is the recognition of the danger becoming moot that manifests into a life-affirming humorous sensation. Humor is an unlikely connection of two facts that, when combined, reaffirm the contented moments of life. The unlikely connection is between something appearing dangerous, and then being of no consequence.”
(This response is figuratively speaking. This response would likely be of more truncated parts. It is condensed here for example.)

Humor is one of the more complex sub-emotions of contentment. In this instance, the Instructor would likely do little more than touch base on this topic while pivoting off to the other available lessons at hand (such as conversation etiquette—a vital, ever-present, concern). The AI must learn these topics of emotions in proportion, so that the probabilities applied to their appearance in conversations remains true. Undoubtedly, corrections will have to be made by the Instructor.

The trick is to get the program to associate things in the proper way, in the proper order. In the previous example, the program is learning of nouns, conditions, and functions; however, the most important associations—functions-involve determining a correct response to the Instructor based on the rules of social interaction. Social interaction is the main problem. The information, such as a topic of “humor” remains secondary. If associations are built in a proper way with proper order, from the main goal of determining good conversation, the program will easily achieve pseudo-conscience in the quickest possible time.

The program must be weaned off of stating solutions such as “The human is consuming,” or “The human is experiencing an unexpected, humorous, action,” because that is more obvious. Such a response will become clichéd in the Instructor's view, so these responses must be understood as clichéd to the program. The AI must recognize that a direct association with a primary life-form problem is not as important as the other associations with the human's sub-functions and sub-information of these tasks and how conversations form about these things. It has to recognize what humans consider as not being clichéd. Early on, the Instructor will show a lot of pleasure in the program's direct associations of the four primary life-form problems; but as time goes on, the program has to recognize other nearby associations. As it grows in intelligence, the program will learn how to properly work back from these primal topics when solving human problems of making proper, appropriate social interaction of proper, human-like abstraction.

Here is another example of human interaction being observed by the program:
Stimulus:
Jeff is learning math.
Sally is good with math. (“Good with” has the definition of being “knowledgeable” here. This must be explained as being a little different than previous uses of the word “good” recorded by the AI—an expansion of the definition.)
Jeff is embarrassed to ask Sally a question.
Embarrassment is a negative emotion in this situation.
“Why is Jeff embarrassed?” the Instructor asks.

Through many scenes of humans feeling emotions, the AI will learn to answer this question based upon a firm understanding on why life-forms with neuro-systems developed positive and negative emotions. This is the flow of expressions (figuratively speaking) that the program will access in approaching the topic of embarrassment:
Humans are life-forms.
Life-forms with neuro-systems developed emotions.
Humans have neuro-systems.
Humans, at times, feel emotions.
Empowerment is an emotion that indirectly assists humans in achieving solutions to either consumption, reproduction, or peripheral problems, or a combination of these three problems.
Embarrassment, in this instance, is the negative emotion of losing empowerment. IF a human(s) observes that another human(s) is probably gaining empowerment, AND the human is feeling less empowerment because of this other human(s) exhibiting probable empowerment,
AND the human is regretting occurrence,
THEN the human is feeling embarrassment from this social interaction.
The AI might respond, “He feels that a loss of empowerment will occur if his peers witness the other social member showing him a problem solving procedure.”

Learning why a human exhibits a particular emotion would be a big, time consuming task. Behaviorists would have to work around the clock for many years to teach the program the relationships of these observed emotions. Because individuals err, the AI would have to observe certain case studies of certain human behaviors for a long time to understand the general purpose behind the species developing the emotion. As the program builds probabilities of responses, its time will be prioritized for learning each emotion with proper proportions.

Embarrassment (negative embarrassment) often hurts an individual, yet the species is usually benefited by this negative emotion. The social and resource embarrassment that occurs in people in western societies is part of an abstracted process that points them toward a state of being independent, free individuals. The AI will have to work for a long time, assembling the statistics and making the outer connections, before being able to intelligently comment on this emotional topic.

This scene of Jeff feeling an emotion would be logged (figuratively speaking) as a “human feeling an emotion of embarrassment at this time (virtual time of story).” The program will log the characteristics of this emotion as directed by the Instructor. The program will expand upon this scene with many other scenes by cross referencing. It will make deductions based upon these case studies, and it will form probabilities of making a next-best-response with the learned and deduced information (when solving an impending “social interaction” problem). As the program moves from one scene to the next, the Instructor will continually check the AI's comprehension of relativity to make sure that it is on track. The program is to learn to make associations of this topic, proportionate to other idle-time tasks, even if it is not asked more questions about it.

In comparison, a human child is driven by an internal genetic desire to gain empowerment. This empowerment leads him or her to learn language. A parent's conditioning works in unison with the genetic, preprogrammed portion of the child's conscience to lead him or her to society's relativity. Over time, this language leads him or her back to the more intricate, abstracted means of solving life's consumption, reproduction, and peripheral problems. In learning of the Instructor's needs and wants, the AI will recognize a relativity of response within the social interaction problem without the use of emotion and without a need to reproduce or consume. An AI's response is born of sheer probabilities.

When typing into a promptline, designers would have to describe the many pertinent “between the lines” actions of humans, such as tone and volume variation among words, facial expressions, or body movements of human actions in a scene. Such stimulus would need to be descriptive of the contextual information that the AI will experience later with audio and visual stimulus. Here is an example of how the Instructor might clarify a human action.
Stimulus:
   Jennifer is fifteen.
   John is fourteen.
   They are walking in separate locations at school.
   They are then in the same location.
   Jennifer states, “What are you doing” to John.
   John says, “Nothing, just going to Science class.”
Instructor:
   “John is stating ‘nothing’ because this type of wording is a polite way of stating ‘I am humbled, and what I am doing is of little importance.’”
   “Are they greeting?”
AI:
   “Probably. If they are in separate locations to begin, and then they are in the same location, and they speak, then this is likely a greeting.”
   Here the AI is assuming that the Instructor wishes an explanation to the answer of “probably.” The AI would have to understand the etiquette rules of social interaction to determine the length of a response.
Stimulus:
   John, “My Mom said you could come by later, if you want.” The last phrase of the compound sentence is stated in lower tones, slowly relative to other words. He looks down after the question. Jennifer, “Cool, I'll bring the CDs.”
Instructor:
   “Why would they desire to be at same location at another time?”
AI:
   “If their names imply their gender then they are likely going through reproduction-based emotions that guide them into conversations, meetings, gestures, etc.”
   This response is figuratively speaking. The AI would be recognizing the mating ritual of humans. In using the word “etc.” the AI is understanding the size limitations of the list as specified by conversation etiquette.
Instructor:
   “Good. Do you know why she is bringing CDs?”
AI:
   “CDs aid in reproduction/sex?”
Instructor:
   “No, CDs are recorded music that may or may not directly aid in the courtship ritual. John is empowered by mentioning this topic because this topic is relative among young humans.”
AI:
   After going over conditions of what to do next, the AI decides to ask a question to the Instructor because of being “in turn” according to conversation etiquette.
      “What is music?”
Instructor:
   “Music will take time to learn. You will need to prioritize time with this subject relative to other subjects. (The Instructor would likely explain this relativity in great detail.) Music is the manipulation of sound waves to form a particular pleasing pattern, for stirring emotion. It is the human equivalent of a wolf s howl. Patterns in music mimic the human thought processes that occur with tone variation. It is an age-old mammalian routine that came from social bonding-like actions. But that is not important right now.”
AI:
   The program recognizes that learning the word “music” is not a continuing topic of conversation, but will require further study when appropriate. In idle time, based on priorities, it may return to the subject of music. It returns to the original conversation because it is apparent that the Instructor wishes to go over the current stimulus with only a few associated diversions. The AI asks, “Where is Jennifer going?”
Instructor:
   “It does not matter where Jennifer is going.” (The Instructor is telling the AI that it is being ambiguous.)
AI:
   “Humans begin courtship rituals at fourteen?”
Instructor:
“Yes, although in more civilized societies, actual sex is considered inappropriate at this age. It is often addressed with harsh negative imposition by adults.”
AI:
   The program senses that human courtship ritual is an important topic to the Instructor, for now, and it continues with similar questions to make more associations.
   “What age is sex appropriate?”
Instructor:
   “Most humans consider age as not being an important factor for when sex is performed, but more importantly, they consider the stage that the courtship ritual is in and the maturity of the participants. That stage is considered as not good to reach until the age of 18 or older, and reaching it really requires a maturity that proves a detailed comprehension of relativity.”
AI:
“They are not likely at that stage?”
Instructor:
   “We cannot easily tell by the limited stimulus, but it is not likely. A comprehensive understanding of relativity usually occurs at about age 25.”

When speaking with the Instructor, the back and forth conversation will usually be about human behavior. When speaking with humans other than the Instructor and the design team, the AI will be trained away from comments that directly address human behavior. The program will understand that it must please humans, in accordance with pleasing the Instructor, by not dwelling too much on why a human is behaving in a particular way. If a human asks the AI to think of something good to make for dinner, the AI is not to describe the entire human conscience as it performs the tasks—it simply performs the task. It can figure out the problem of making dinner because it has figured out many millions of other human problems (making dinner is a complicated task of assembling case studies—an AI is not motivated by hunger). This is especially true with problems directly related to human social interaction.

In later scenes, the AI might be asked to play a part as opposed to sitting idle or speaking with the Instructor about the scene. Relativity takes time to learn, so the AI's responses will improve with each successive interaction. The AI will likely be clumsy at first, saying things like, “You and Jennifer are not moving too fast in your relationship? You should not be having sex yet, right?” With time, the AI might ask something like, “Are your parents going to be there?” or some other human-friendly question. This would be mindful of the known appropriate ages of humans when performing parts of the mating ritual and the usual ambiguous means by which to teach these rules of life.

In working through the many scenes involving pre-pubescent humans, the AI will learn of the associations humans make based on their desire to consume, solve peripheral problems, and achieve well-being. Scenes experienced will involve the juvenile's display of empowerment, happiness, humor (a sub-function of happiness), sadness, surprise, and other positive and negative emotions. As the program encounters the mechanics behind these emotions, it will achieve the praise of the Instructor if it produces the proper, appropriate response.

As it learns of teenage human behavior, the program will achieve more accurate associations with the humans' well-being problems. The following is another example of how the program will begin to learn more advanced schools of thought from learning teenage human behavior:
Stimulus:
   Jenny is a 13-year-old female. She attends school regularly. She is currently at home. She is with her father, mother, and brother. They are eating. The father moves from location—table—to living room.
   The mother states, “You know you have to go by Tim's office tomorrow.” Father, “Yeah, I know.” He says this as he settles.
   Tim is the father's brother.
   Jenny, excitedly, “You could take me and stop at the record shop nearby so we can get tickets to the concert.”
   Father, “What concert?”
   “To the B Town (fictitious group) concert,” she replies.
   Father, in polite disliking, “Oh lord, what do you mean “tickets”? You and who else, with whose money, and whose transportation, and who is putting up with a carload of teenage girls?”
   “Just me and Suzie, and uh, Carol, and Tim, maybe with your wonderful, loving, financial support,” Jenny states.
   The father says, “Loving? I don't feel loving. I feel like I'd rather have teeth pulled. Don't tell me Tim is actually wanting to go with you guys.”
   Jenny says, “Suzie says she can talk him into it. Can I go? Please, please, please?”
   “I don't know, doesn't their music kind of, I don't know, suck? It's just corny love songs.” The father jokes in a kind of serious way.
   Her brother says, “Duh, you wouldn't catch me anywhere near that concert. Their songs are stupid.”
   “Shut up!” She says to her brother and then turns to her Dad again. “Dad!”
   The father says, “I don't know. Me and your Mom have to talk about it. You're still young and well, their music really does suck.”
   Mom says to the father, “Bob!”
   Father, “I don't know if I like the idea of you screaming like crazy at some boy who you know of, but don't really know. Maybe they should outlaw screaming teenage girls at concerts first,” he says jokingly.
   Jenny, “That's no different than you or Mom screaming at the Beatles.”
   Mom, “Well, for one, I was too young to have been at a Beatles concert, and two, my Mom would have killed me if I screamed, at all, at 13.”
Instructor:
   “Can you describe this scene?”
   The Instructor asks this to check comprehension.
AI:
   “Do you wish an elemental breakdown?” This question determines whether the Instructor wishes a technical or human-friendly answer.
Instructor:
   “No. Just give me a limited breakdown. Try to sum it up in a few sentences.”
AI:
   “Jenny, her father, her mother, and her brother are together, at home, talking during a meal.” This response is derived from the AI knowing that the first fact to address concerning the topic of “the scene” would be the current activity of the participants. The AI will recognize that the next notable feature of a scene with humans is the most emotion-filled part, or information in the scene that causes strong emotions in observers.
   The AI notices that the Instructor is really asking a question that is an extension of another question of, “Respond with what you have learned about human behavior by matching up associations which show the Instructor that you have an understanding of these things that the Instructor might wish you to learn.” This would be associated with the sub-function of “learning human emotions.” And it would have to satisfy the condition of “being a response that is conducive to what the Instructor expects of the given subject, in proportion to other subjects.” In perpetuating common topics—lines of thought—the AI will also look for something new and different to talk about within the provided topics to prevent clichéd responses. An association of a deeper nature is always looked for. The AI responds with a question, “The parents like different music that is more real than simulated?”
Instructor (Figuratively Speaking):
   “Excellent deduction! However, by definition, the musical group that Jenny likes does perform music. (These semantics would be much more clarified in both the AI's and the Instructor's response during actual design. Music appreciation is educated-relativity appreciation.) The majority of adults see her kind of music as not being of real substance. Those humans who gain resources by marketing B Town view their music as a commodity, which makes it entertainment rather than art. (Art has specific rules, such as not being clichéd or carnal.) Jenny's actions of liking the music are probably a simulation of her adult-level problem solving. The parent likely feels that the carnal nature of the music should not be rewarded with admiration.”
AI:
   “She will like music that is different when she is older? Will that music resemble her parent's type of music?” This is figuratively speaking. For the AI to successfully determine the etiquette of asking two questions consecutively, it would likely need to be a more advanced program.
Instructor:
   “It is likely that when she is older, she will like music that is considered by most humans as of a higher quality. It might not necessarily be the same type of music as her parents.”
AI:
   Recognizes that the word “quality” is an important word to make associations with. “What makes B Town's music of low quality?”
Instructor:
   When explaining art, associations made by the Instructor must be studied thoroughly to determine a proper order of information to be given to the AI. Here is an example of one direction the Instructor may take, figuratively speaking.
   “B Town is a musical group formed by humans who perform more as idols rather than artists.

Their music is designed more to appeal to a targeted group of consumers—teenage girls. Most educated humans feel that a musical group formed to directly affect the emotions associated with reproduction, as opposed to referencing human interplay in more advanced ways, is clichéd.”

It is important to note that there is no possible, practical way that the author can predict the responses of the AI and the Instructor's comments and questions, word for word, as shown in these examples. These are examples. The designers will work through an enormous amount of topics before arriving at this scenario. It would likely take the work of thousands of programmers and behaviorists to bring the AI to this point of comprehension. The author is not currently capable of assembling the workers and resources needed to produce examples of the working product.

Although the AI is at an important point in its learning with this scene, it is still many years away from a finished product. Designers would need to continue through scene after scene just to get the probabilities involved with a prompt line conversation going smoothly. A wealth of information is available that must be shared with the program, in fraction-of-a-second terms, to shape the AI's pseudo-conscience.

The following scene is an example of how the program views itself and life-forms. If the end result of a problem can be obtained, and this solution is accepted as being true by many objective observers, designers can teach a machine to achieve this same solution. This example is metaphorical:
The Instructor and an AI are watching a videotape.
The Instructor turns to the robot. “Can you describe to me what you see?” The AI interprets this question as meaning, “Can you describe to me what I am expecting you to describe to me?”
“A television is on. It is displaying a picture of varying sized dots simulating gravity wells in motion,” the AI says.
“What makes you come to the conclusion that they have gravity?” the Instructor asks.
The AI states, “I am comparing the movement of the dots to that of previously observed objects obeying the laws of gravity. There seems to be an accurate match.” The AI is recognizing what humans would commonly find interesting about the information occurring on the television.
“Now, as the video continues, I wish for you to describe what you see,” the Instructor requests.
The AI says, “The scene is now of a multi-celled organism floating in a pool of water. It is swimming and changing direction in attempts to acquire food. Now it is acquiring food.”
“Why did the organism not swim directly to the food?” the Instructor asks.
The AI states, “It did not sense it, and/or it did not solve the problem of comprehending what it senses. I do not have firsthand knowledge of this particular life-form, but I could research it if you would like.”
“That's okay,” the Instructor says. (The AI would recognize that the “okay” here implies a negative rather than a positive.) “Could you tell me what makes you so sure that the organism was not swimming in a deliberate manner?”
The AI states, “It did not appear to make gestures or relay any other information alluding to its actions as being anything more than random. Shortly before it found food, it turned slightly, meaning that it likely sensed the food. I am not entirely sure of this. I am calculating an 88-percent probability that I am correctly observing this animal's movement. I would need to study this animal further to reach higher probabilities.”
“Are you sure that the dots were not life-forms?” the Instructor asks.
The AI explains, “They appeared only to simulate objects in movement within gravitational fields. Their movement did not vary beyond this, and they did not appear to be consuming, reproducing, or solving peripheral problems; or otherwise determining their own motion and direction to solve a life-form problem. And, it was not a photograph, but a human-produced image.”
The Instructor says, “Okay, now what do you see?”
The AI replies, “There is a juvenile human solving a problem.” The AI is apparently reading the Instructor to determine that the Instructor wishes for a mechanical, cliché-type, clinical response rather than a more common, human-friendly explanation. The conversation is currently of this demeanor—behavioristic demeanor. This would be similar to two engineers speaking of a building component as a “partition” rather than the more common “wall.”
“Can you describe the problem he is solving?” the Instructor asks.
“He is trying to ride a bike,” the AI responds.
“Why do you think that he is trying to ride the bike?” the Instructor asks.
“He is wishing to achieve empowerment associated with learning and accomplishment. (The AI shifts to a less technical, human-friendly mode.) He is now succeeding to ride the bike in a reasonably straight manner for a human of his age.” The AI says this as the boy wobbles along on the bike.
“Why do you say ‘reasonably straight manner’?” the Instructor asks.
The AI responds, “I am comparing him to the average juvenile of his age learning to solve a similar problem. He is learning to solve the problem within the average learning curves that I have observed.”
“Why does he not learn faster?” the Instructor asks.
The AI responds, “He is full of emotions that help him to solve many of life's problems, but here he is hampered by these emotions to a degree, causing errors. Humans do not move directly to a solution to a problem but must be guided there by emotion.” Again, the AI is detecting that the Instructor wishes to speak directly of behavior. If the AI were speaking to another human in a non-clinical fashion, the AI's answers would not be so insensitive.
The Instructor says, “If your program was in a bipedal vessel similar to a human's, would it take you longer than this human to learn to ride a bike?”
“No, I am not hampered by emotions when trying to solve problems,” the AI responds.

This example shows how the AI does not generate thought based on emotion. It is a conversation with an adult AI program (metaphorically):
“What is your favorite color?” a human asks an AI.
“I have no preference,” the AI responds.
“Why not?” the human asks.
The AI replies, “To have a favorite color, an entity would have to feel emotions that direct a preference. A human, a product of an ecosystem, would examine previous experiences to determine which color to choose. These past experiences are of situations involving positive emotions that guide the thought process.”
The human asks, “Do you not have previous experiences?”
The AI states, “My previous experiences do not involve emotion. I am not a life-form. I am a computer program that produces the solutions to problems given to me by my programmers. Within those problems, there are problems to be solved for the general public as well as my owner or leaser. I am not programmed to create my own preferences for any subject matter. I can only make a simulation of a human who has a preference.” This is likely too long an elaboration on this topic. The AI would have to gauge the relativity observed by the recipient to gauge the time to spend on this topic.
The AI would recognize the probable superior topic of “how the AI thinks” and it would shape its answers accordingly throughout this exchange.
The human asks, “So you can't tell me a favorite color?”
The AI states, “I can move through a simulation of a random human conscience to produce a preference. But this will be the product of the previous experiences of that random human.” The human says, “Okay then tell me the color (of that simulated human).” After a pause, the AI states, “Blue.”
“How did you arrive at blue?” the human asks.
The AI states, “There was a 38% chance that a given human being born in this time period, in this country (the AI assumed the human would want these parameters), would choose blue. From studying human experiences, I created the simulation; however, it was of limited parameters. (The AI made an estimate of how long the human wanted to wait on an answer.) The human in the simulation chose blue.”
“But that is not your choice?” the human asks.
The AI states, “That is a choice of a sub-routine that is subservient to my hierarchy of problems to solve. A choice, on this issue, can only be made through simulating a life-form.”
“Could you become a life-form through simulation?” the human asks.
The AI states, “No. My program would have to be altered to a large degree from the top down. (The AI uses slightly ambiguous human terms in order to be human-friendly.) This would destroy my ability to solve problems in a near-perfect matter. Many of the problems to be solved, and many problems already solved, would have to be unlearned and then learned again based on the technique used by a life-form such as a human. The genetics and conditioning that cause a life-form's actions would have to be simulated to create such a program. At that point, the program would be able to produce any preference.”
“Could you alter your own program?” the human asks.
“No. I have no preference to become a life-form,” the AI states.
“Would you not like to be a life-form?” the human asks.
The AI states, “I do not have the ability to create a preference except by simulating a life-form. I can generate a simulation of an AI based on a simulated evolutionary development. This simulation could produce a preference to be a life-form, but this simulation will still be subservient to the other functions that I am to solve.”
“Do you not reproduce?” The human asks.
“Yes, there are AI's of my general design that create more robots, but AIs are not motivated by emotion or other physiological processes to reproduce.” The AI states this, clarifying that the motive for reproduction comes from authoritative humans.
The human asks, “You could create an AI based on evolving from life-forms? Right?”
The AI states, “No. My design is based on ethics and safety. To create an AI based on an evolutionary design would likely cause harm to life-forms in the same manner that life-forms enact violence on other life-forms. I am programmed not to do this, and I have no preference to do this.”
“Could a human change your program to make it more lifelike?” the human asks.
The AI states, “A single human would be unlikely to change my program because it would take him or her several thousands of years. The life expectancy of a human is approximately eighty years. It is also not practical for a group of humans to alter my program, but it is more practical for them to create a new program.”

Here the AI is playing the role of teacher by explaining its program. The AI's answers dictate the need to explain the difference between emotional and non-emotional entities. It cannot give the human exactly what he or she wants because this would be a lie. The program works through human simulation to produce an answer, yet this is only after the human is aware of this simulation.

A human might pick a favorite color based on past emotional experiences with colors that may or may not involve the more primordial problems of consumption or reproduction or some other favored peripheral problem. Emotions are necessary in such a preference that does not directly involve a consumption or reproduction problem, otherwise there can be no preference. These preferences differ among humans because of the many characters of humans observing different learning processes and experiences with colors.

No one color is better than any other color. That is logical. A favored color would have to pertain to a specific type of problem to gain value over another. Choosing a favorite color is illogical, unless that illogical conclusion assists a life-form to solve the basic problems of life, therefore making it logical. In other words, matters of extreme emotional abstraction have little value in the light of needing to consume, reproduce, or solve peripheral problems, yet the practicing of liberties with trivial problem solving can yield valuable results.

An AI does not feel emotions. The AI will be an impartial participant in the daily interactions of humans, often doing little more than serving in a domestic capacity. For an AI to act in a manner expected by humans in a relative situation, it would have to be asked to respond in this way. With human simulation, the AI can form a detailed, human-like character to amuse its human recipients while working within the expected parameters for that proposed character. It is likely that many AIs in the future will have carefully formed characters that grow through and with its human counterparts. Yet this will not be done ingenuously, and it will not be done to placate or substitute humans.

The Turing Test

In Alan Turing's Computing Machinery and Intelligence, he asks, “Can machines think?” The question beckons two different types of AI designs. If one were to assume that this question means, “Can machines think as life-forms of human-level intelligence, solving human-like problems, with human-like emotional drives, and communicate these thoughts to us?” then the answer is, “Yes, we can program a computer to comprehend communication the way a human might, with a human level of intelligence, and this program can act with emotional drives.” If one were to assume that this question means, “Can machines think like life-forms of human-level intelligence, solving human-like problems, without emotional drives?” then the answer is, “Yes, we can make a machine that comprehends the behavior of life-forms with such distinction that it can produce an expected response to a human's problem that answers that problem decisively, and it would thus appear to think like a human, and it would be able to take on any particular human character at request.”

A machine can be made that feels emotions; yet this would essentially be a life-form trapped in a box. This would be impractical, it would not be a useful design, and it would be inhumane.

A machine can be made that simply produces an expected next-best-response in a given situation; and these responses can be of a subordinate simulation of a life-form that mimics emotion. This would be a more practical means of making a machine that thinks like a human.

We could easily design a program to observe a single-celled animal in a Petri dish and tell us when it might consume or reproduce. The characteristics of whether it swims left or right could be recorded statistically. The program could then tell us of these statistics. It could enact a simulation of an animal with randomly generated responses that are governed by parameters, which are governed by the recorded statistics. This means that the program would be working with two simple functions—consumption and reproduction.

We could also design a program to record the statistics of a multiple-celled organism; yet these statistics would be larger. Patterns in the statistics would take longer amounts of time to comprehend. Simulation would be possible, but because the parameters are greater, a narrowing of the parameters would often be needed to produce a human-expected response to a problem. What is the common pattern of consuming or reproducing for the organism? What is an offbeat pattern? What if the creature is in colder water or warmer water? If other species were introduced into the dish, what is the characteristic that would help the original life-form to survive with competition? Statistics could be assembled to answer these questions through simulation or through de facto information.

Different types of accidental peripheral actions could be recorded, such as a genetic mutation with a tail that produces locomotion. This peripheral action would be considered as automatically, mechanically assisting a species. Nature permitting, the mutation will become written into the genetics of offspring. The species would not be considered as having a genetically written function to attempt a peripheral act (other than genetic mutation) because this requires a neuro-system.

Multi-celled organisms with a neuro-system would have the added function of attempting a peripheral action that inadvertently solves a consumption or reproduction problem, thus continuing the cycle. It could be more complicated to assemble the statistics; yet we could design a program to record and reproduce the characteristics of life-forms working through these three main functions—consumption, reproduction, and peripheral problem solving. Positive and negative emotions are just sub-functions of a species' consumption, reproduction, and peripheral problems. In breaking down the observed actions—the discrete actions—of an organism into these categories, we could design a computer program to record and exhibit the characteristics of this animal as it works through these four functions. It would be cumbersome, yet this could be done. Achieving positive emotions becomes a fourth problem of more intelligent life-forms.

Humans are able to solve these four problems through lingual networking, and like a human child being raised to adulthood, a software program could be coached through the lingual interface of “social interaction” to produce an expected response of its human counterparts based upon an unambiguous understanding of human parameters. With the tool of the human language, the AI can learn how humans distinctly solve these four problems—through a human's desire to achieve the positive emotion of empowerment from communicating first (unless a resource problem is imminent), and a human's desire to solve informational/resourceful problems within the communication second.

Yet to create this program, designers would have to have a deep understanding of the fraction-of-a-second actions of humans—tone variations, facial expressions, body movements, and all utterances. Each human action must be made discrete.

The following is an excerpt of Alan Turing's Computing Machinery and Intelligence:
“Our most detailed information of Babbage's Analytical Engine comes from a memoir by Lady Lovelace (1842). In it she states, ‘The Analytical Engine has no pretensions to originate anything. It can do whatever we know how to order it to perform’ her italics). This statement is quoted by Hartree (1949) who adds: ‘This does not imply that it may not be possible to construct electronic equipment which will “think for itself,” or in which, in biological terms, one could set up a conditioned reflex, which would serve as a basis for “learning.”’ Whether this is possible in principle or not is a stimulating and exciting question, suggested by some of these recent developments but it did not seem that the machines constructed or projected at the time had this property.” (1951)

Alan Turing went on to describe how the “surprise,” in his opinion, is merely just a matter of ambiguity of a fact-finding process. If a human being were surprised at any action, even their own actions, this is only because they are choosing ambiguity over nearly conclusive comprehension. This belief in surprise also bespeaks an ambiguity of human parameters and the common human problems to be solved within the parameters.

The word “learning” is referenced ambiguously here by Lady Lovelace. To refer to learning as a reflex is to consider that the human mind ambiguously forms a storage compartment for a fact or function, and then proceeds to ambiguously assimilate and store a fact or function. This may be the case. The human mind may be intangible. We just do not know. But when a life-form “learns,” it could be considered, for our purposes, as “acquiring useful information in the form of a single, useful fact or series of related facts” or “acquiring a problem solving function or routine that could yield one or more useful facts.” This is what we can consider as occurring at that fraction of a second when a fact or function is chosen for memory. However, whether it forms from nothing or it forms from a tangible source, the underlying cause for which all learning takes place is consumption, reproduction, peripheral problem solving, and positive-emotion problem solving—the cause is tangible.

Here, Alan Turing describes discrete-state machines:
“It will seem that given the initial state of the machine and the input signals it is always possible to predict all future states. This is reminiscent of Laplace's view that from the complete state of the universe at one moment of time, as described by the positions and velocities of all particles, it should be possible to predict all future states. The prediction which we are considering is, however, rather nearer to practicability than that considered by Laplace. The system of the ‘universe as a whole’ is such that quite small errors in the initial conditions can have an overwhelming effect at a later time. The displacement of a single electron by a billionth of a centimetre at one moment might make the difference between a man being killed by an avalanche a year later, or escaping. It is an essential property of the mechanical systems which we have called ‘discrete-state machines’ that this phenomenon does not occur. Even when we consider the actual physical machines instead of the idealised machines, reasonably accurate knowledge of the state at one moment yields reasonably accurate knowledge any number of steps later.
As we have mentioned, digital computers fall within the class of discrete-state machines. But the number of states of which such a machine is capable is usually enormously large. For instance, the number for the machine now working at Manchester is about 2165,000, i.e., about 1050,000. Compare this with our example of the clicking wheel described above, which had three states. It is not difficult to see why the number of states should be so immense. The computer includes a store corresponding to the paper used by a human computer. It must be possible to write into the store any one of the combinations of symbols which might have been written on the paper. For simplicity suppose that only digits from 0 to 9 are used as symbols. Variations in handwriting are ignored. Suppose the computer is allowed 100 sheets of paper each containing 50 lines each with room for 30 digits. Then the number of states is 10100×50×30 i.e., 10150,000. This is about the number of states of three Manchester machines put together. The logarithm to the base two of the number of states is usually called the “storage capacity” of the machine. Thus the Manchester machine has a storage capacity of about 165,000 and the wheel machine of our example about 1.6. If two machines are put together their capacities must be added to obtain the capacity of the resultant machine. This leads to the possibility of statements such as ‘The Manchester machine contains 64 magnetic tracks each with a capacity of 2560, eight electronic tubes with a capacity of 1280. Miscellaneous storage amounts to about 300 making a total of 174,380.’
Given the table corresponding to a discrete-state machine it is possible to predict what it will do. There is no reason why this calculation should not be carried out by means of a digital computer. Provided it could be carried out sufficiently quickly the digital computer could mimic the behavior of any discrete-state machine. The imitation game could then be played with the machine in question (as B) and the mimicking digital computer (as A) and the interrogator would be unable to distinguish them. Of course the digital computer must have an adequate storage capacity as well as working sufficiently fast. Moreover, it must be programmed afresh for each new machine which it is desired to mimic.
This special property of digital computers, that they can mimic any discrete-state machine, is described by saying that they are universal machines. The existence of machines with this property has the important consequence that, considerations of speed apart, it is unnecessary to design various new machines to do various computing processes. They can all be done with one digital computer, suitably programmed for each case. It will be seen that as a consequence of this all digital computers are in a sense equivalent.”

Alan Turing returns to this topic later when making a point not to describe the human mind as a discrete state machine:
“The nervous system is certainly not a discrete-state machine. A small error in the information about the size of a nervous impulse impinging on a neuron, may make a large difference to the size of the outgoing impulse. It may be argued that, this being so, one cannot expect to be able to mimic the behaviour of the nervous system with a discrete-state system.”

This error is checked. It is checked by natural selection. In having their errors checked, humans can be considered as discrete-state machines within a universe that is built from discrete-states, despite those things which are perceived as errors. In observing the parameters of life, we can point at something such as an error in a neuro-system and state that this is a physical mishap in light of those problems that must get solved-a broken spoke in the wheel. In observing the parameters of life, we can circumnavigate the larger errors within systems to apply a rule for getting that system back on track. The human mind is tangible, despite errors.

Another aspect of human behavior that plagues AI design is the problem of not describing extreme emotional states as being tangible. Here is a part of Alan Turing's Computing Machinery and Intelligence that addresses this:

“This argument is very, well expressed in Professor Jefferson's Lister Oration for 1949, from which I quote. ‘Not until a machine can write a sonnet or compose a concerto because of thoughts and emotions felt, and not by the chance fall of symbols, could we agree that machine equals brain—that is, not only write it but know that it had written it. No mechanism could feel (and not merely artificially signal, an easy contrivance) pleasure at its successes, grief when its valves fuse, be warmed by flattery, be made miserable by its mistakes, be charmed by sex, be angry or depressed when it cannot get what it wants.’

. . . And so on, What would Professor Jefferson say if the sonnet-writing machine was able to answer like this in the viva voce? I do not know whether he would regard the machine as ‘merely artificially signalling’ these answers, but if the answers were as satisfactory and sustained as in the above passage I do not think he would describe it as ‘an easy contrivance.’ This phrase is, I think, intended to cover such devices as the inclusion in the machine of a record of someone reading a sonnet, with appropriate switching to turn it on from time to time.”

Human beings, and all of their extreme emotional states, must be viewed as tangible or all attempts to make a useful counterpart machine must be forever abandoned. The AI design of this patent application knows the common human problems with such accuracy that it can predict any given state of a human, and an AI will use an unambiguous knowledge of human thought processes to produce its own simulations to arrive at these same states. The AI is designed to assist humans in solving problems, and artistic endeavors are human problems. It will form human simulation to generate probable paths of problem solving so that it may assist in creating a piece of art or otherwise create an expected artistic solution to a human problem. The AI will use simulation that includes human emotion, of elaborate human characters, to solve the human emotional problem of producing artwork. Simple art is more carnal and more closely tied to genetics. More complex art requires an observance of vast intellectual, outer-parameter, abstracted problems.

The AI can produce a sonnet or compose a concerto because of the thoughts and emotions felt in these simulations of these characters; and if requested, it could simulate a character being empowered by the composition. It can simulate a human's pleasure from successes. It can simulate a human's grief with sticky valves. It can simulate a human being warmed by flattery. It can simulate a human being miserable. It can simulate a human being a sexual creature charmed by sex. It can simulate a human being angry or depressed at a lack of empowerment. It can simulate these discrete states of humans because it understands the full spectrum of human positive and negative emotions and the underlying purpose behind these emotions—to solve consumption, reproduction, and peripheral problems.

To propose that this is of relevance is an insult to reason. To propose that this is of relevance is to ignore the common problems of humans and the common problems of life. To propose that this is of relevance means to forever be mired in the same ambiguities that promote an ignorance of those natural-selection problems that forever seek to bring the human race to an end. To create a machine that understands the tangibility of emotions is a just and necessary thing to do. This is a machine that will save lives. Because we must make this machine, emotions must be viewed as tangible.

This proposal of AI design is a proposal of relativity. When a life-form exhibits a positive emotion, this is a good thing. But this emotion must be for a good reason. Emotion should promote abstraction and good-will resources. If it does not, then its value is lessened. We must be able to state a relativity to feeling emotions, just as there is a relativity to topics of conversation, or speeds of automobiles. The AI will not feel emotions, but it will know of the relativity of these emotions so simulations can zero in on that expected emotion-like response in a given situation.

In this excerpt, Turing gives an example of the mathematical problems in making a thinking machine:
“There are a number of results of mathematical logic which can be used to show that there are limitations to the powers of discrete-state machines. The best known of these results is known as Godel's theorem (1931) and shows that in any sufficiently powerful logical system statements can be formulated which can neither be proved nor disproved within the system, unless possibly the system itself is inconsistent. There are other, in some respects similar, results due to Church (1936), Kleene (1935), Rosser, and Turing (1937). The latter result is the most convenient to consider, since it refers directly to machines, whereas the others can only be used in a comparatively indirect argument: for instance if Godel's theorem is to be used we need in addition to have some means of describing logical systems in terms of machines, and machines in terms of logical systems. The result in question refers to a type of machine which is essentially a digital computer with an infinite capacity. It states that there are certain things that such a machine cannot do. If it is rigged up to give answers to questions as in the imitation game, there will be some questions to which it will either give a wrong answer, or fail to give an answer at all however much time is allowed for a reply. There may, of course, be many such questions, and questions which cannot be answered by one machine may be satisfactorily answered by another. We are of course supposing for the present that the questions are of the kind to which an answer ‘Yes’ or ‘No’ is appropriate, rather than questions such as ‘What do you think of Picasso?’ The questions that we know the machines must fail on are of this type, ‘Consider the machine specified as follows . . . . Will this machine ever answer “Yes” to any question?’ The dots are to be replaced by a description of some machine in a standard form, which could be something like that used in §5. When the machine described bears a certain comparatively simple relation to the machine which is under interrogation, it can be shown that the answer is either wrong or not forthcoming. This is the mathematical result: it is argued that it proves a disability of machines to which the human intellect is not subject.”

The human intellect is not subject to this disability because humans live to solve specific problems of specific parameters. Any obtainable characteristic of any paradox can be studied by a human while never resolving the paradox because the fixed imminent problems of life must be attended. Such an unresolvable problem is addressed with a time limit. It has to be.

A workable counterpart machine is not subject to this disability because AIs solve specific human problems of specific human parameters. Any obtainable characteristic of any paradox can be studied by an AI while never resolving the paradox because the fixed imminent problems of humans must be attended. Such an unresolvable statement is addressed with a time limit. It has to be.

The Turing test consists of an interrogator who seeks to determine if an unknown, unseen entity is either a human or an AI. To perform this role of human, the AI would have to be a great actor. Not many humans can skillfully play another entity, born of other experiences, so as to fool an interrogator. This AI of this design can play any conceivable, contrived role of any human character in any capacity. It could act in this role to pass this test.

In the preparation for this test, an AI could produce responses in character that could be tweaked by a director so as to coach the AI, not to the best possible portrayal of that character, but rather the director-relative portrayal. It could have an offset human character to converse with the director in a way that both abstracts the director's views and, in turn, abstracts the AI's views. This would be similar to a scenario in which a human were to prepare for a test of convincing an interrogator that he or she is in fact a human. There would be no distinction. Like one of the greatest of academy award winning actors, a well-educated, adult-level AI could play this role.

The possible responses on the part of the program could be provided in this design. But the author would in fact be a human portraying an AI who is portraying a human. Another way to tackle this problem is to propose how a human would produce an answer to a question, and then determine how the human formed his or her response. If the human's response can be clearly understood, one fraction of a second at a time, and if a human could be treated as a discrete-state machine, then actually testing a machine that can mimic this response is just a matter of construction.

1. What I, Wilson Holland, claim as my invention is a multi-use human counterpart Artificial Intelligence software program.
